(19) United States
(12) Patent Application Publication
(10) Pub. No.: US 2026/0356453 A1
(43) Pub. Date: Nov. 12, 2026

(54) CHILD CARRIER FOLDABLE FRAME, HANDLEBAR, ARMREST AND FOOTREST

(71) Applicant: WONDERLAND SWITZERLAND AG, Steinhausen (CH)

(72) Inventor: Zhiren ZHONG, Dongguan, Guangdong (CN)

(73) Assignee: WONDERLAND SWITZERLAND AG, Steinhausen (CH)

(21) Appl. No.: 19/130,638

(22) PCT Filed: Nov. 17, 2023
(86) PCT No.: PCT/EP2023/082248

§ 371 Date: May 16, 2025

(30) Foreign Application Priority Data
Nov. 17, 2022 (CN) 202211440728.7
Nov. 17, 2022 (CN) 202211459019.3
Nov. 17, 2022 (CN) 202211460082.9
Nov. 17, 2022 (CN) 202211472636.7
May 19, 2023 (CN) 202310575120.3

(51) Int. Cl. B62K 9/00; B62J 1/28; B62K 15/00; B62K 21/16

(52) U.S. Cl. CPC B62K 9/00; B62J 1/28; B62K 15/008; B62K 21/16

(57) ABSTRACT

The present application discloses a child carrier. The child carrier includes a front wheel, a rear wheel, and a frame having an unfolded state and a folded state. The frame includes a first frame, a second frame, and a linkage mechanism. The first frame is connected to the front wheel. The second frame is connected to the rear wheel. The linkage mechanism is rotatably connected to the first frame and the second frame respectively, so that when the frame is switched from the unfolded state to the folded state, the first frame and the second frame move to approach each other. Synchronized foldable handlebar, armrest fixing structure to backrest and foldable or removable footrest.

### CROSS-REFERENCE TO RELATED APPLICATIONS

This application is a U.S. national phase application under 35 U.S.C § 371 based upon international patent application of PCT/EP2023/082248, filed on Nov. 17, 2023, which itself claims priority of China Patent Applications No. 2022114600829, filed on Nov. 17, 2022, No. 2022114590193, filed on Nov. 17, 2022, No. 2022114407287, filed on Nov. 17, 2022, No. 2022114726367, filed on Nov. 17, 2022, and No. 2023105751203, filed on May 19, 2023, the contents of which are hereby incorporated by reference in its entirety.

### TECHNICAL FIELD

The present application relates to the technical field of children's products, and in particular to a handlebar assembly, a footrest device, a pedal device, and a child carrier.

### BACKGROUND

In recent years, child carriers, such as child tricycles, balance bikes, pedal tricycles, bicycles, etc., have become increasingly popular among consumers. Child carriers currently on the market, such as tricycles, balance bikes, bicycles, etc., are inconvenient to carry when they need to be used outside due to their large overall size. Although some child carriers can be folded, there are problems such as complicated folding operations.

In addition, most of the handlebars of child carriers currently on the market are not adjustable in height and cannot be well adapted to children of different sizes. Alternatively, the handlebars are adjustable in height, but the adjusting process is very inconvenient. In addition, in order to protect the safety of child seated in the child carrier, an armrest can be disposed on a seat of the child carrier. However, before frames of child carriers currently on the market are folded, the armrests usually need to be first removed, which brings great inconvenience to users. In addition, even if the armrest is designed to be folded as the entire frame of the child carrier is folded, the existing folding mechanism is very complicated and difficult to implement.

In addition, child carriers currently on the market, such as pedal tricycles, are usually equipped with pedals for children to ride. However, this configuration may cause certain inconveniences. For example, for younger children, their legs may not be long enough to place their feet on the pedals. The feet hanging in the air for a long time may make the children tired easily, or even if the seated child can place the feet on the pedals, long-term riding may also make the child very tired.

### SUMMARY

According to various embodiments of the present application, a handlebar assembly, a footrest device, a pedal device, and a child carrier are provided.

In an aspect, a child carrier is provided. The child carrier includes a front wheel, a rear wheel, and a frame having an unfolded state and a folded state. The frame includes a first frame, a second frame, and a linkage mechanism. The first frame is connected to the front wheel. The second frame is connected to the rear wheel and includes a first movable connecting portion. The linkage mechanism includes a first connecting frame, a second connecting frame, and a rotating base rotatably connected to the second frame. The first connecting frame is rotatably connected to the first frame through a first rotating shaft. The first connecting frame includes a third rotating shaft. The first movable connecting portion is rotatably connected to the third rotating shaft such that a relative rotation of the first movable connecting portion and the first connecting frame drives the second frame to rotate relative to the rotating base. The second connecting frame is connected to the rotating base, and is rotatably connected to the first frame through a second rotating shaft. When the frame is switched from the unfolded state to the folded state, the linkage mechanism rotates relative to the first frame and the second frame such that the first frame and the second frame move to approach each other.

In an embodiment, the first movable connecting portion is provided with a first through hole. A plane where an opening of the first through hole is located forms an angle with respect to the third rotating shaft. The third rotating shaft extends through the first through hole. The third rotating shaft rotates to drive the first movable connecting portion to move along the third rotating shaft.

In an embodiment, the first movable connecting portion is provided with a universal ball; the universal ball is provided with a second through hole. The third rotating shaft extends through the second through hole. A hole wall of the first through hole forms a ball base configured to receive at least a part of the universal ball. The ball base is capable of rotating along a surface of the universal ball.

In an embodiment, the second frame is rotatably connected to the rotating base through a fourth rotating shaft. An extending direction of the fourth rotating shaft intersects and is not perpendicular to an extending direction of the third rotating shaft.

In an embodiment, the second frame includes a first wedge-shaped end surface. The rotating base includes a second wedge-shaped end surface. When the second frame rotates relative to the rotating base around the fourth rotating shaft, the first wedge-shaped end surface rotates relative to the second wedge-shaped end surface, and is in contact with the second wedge-shaped end surface. The fourth rotating shaft is perpendicular to the first wedge-shaped end surface and the second wedge-shaped end surface.

In an embodiment, two second frames are provided. The two second frames are rotatably disposed on two sides of the rotating base through two fourth rotating shafts respectively. Extending directions of the two fourth rotating shafts intersect and are not perpendicular to an extending direction of the third rotating shaft.

In an embodiment, the linkage mechanism further includes a linking rod. The linking rod includes: a first linking end rotatably connected to the first frame and the second connecting frame through the second rotating shaft; and a second linking end connected to the rotating base.

In an embodiment, the second connecting frame includes a first housing and a second housing. The first housing and the second housing cooperatively enclose a first receiving cavity. The first linking end is disposed in the first receiving cavity. The second linking end extends out of the first receiving cavity and is connected to the rotating base.

In an embodiment, the frame further includes a first locking component. The first locking component includes: a locking pin connected to the first connecting frame; and a locking hook pivotally connected to the second connecting frame and including an engaging hook. The engaging hook is capable of being engaged with the locking pin to limit a relative rotation of the first frame and the second frame.

In an embodiment, the second connecting frame is provided with a first groove. The engaging hook and the first groove cooperatively enclose a third accommodation cavity. The locking pin extends through the third accommodation cavity.

In an embodiment, the first locking component further includes a first reset member. The first reset member biases the locking hook to rotate to be engaged with the locking pin.

In an embodiment, the frame further includes an unlocking component. The unlocking component is configured to drive the locking hook to rotate to be disengaged from the locking pin. The unlocking component includes a first pushing rod movably disposed on the first connecting frame; and the first pushing rod is operable to push the locking hook to rotate, so as to disengage the locking hook from the locking pin.

In an embodiment, the unlocking component further includes a driving handle rotatably connected to the first connecting frame and abutting against the first pushing rod. The driving handle comprises a cam portion. The driving handle rotates to drive drives the first pushing rod to move through the cam portion.

In an embodiment, the first pushing rod includes a pushing rod body and a pushing portion fixed on the pushing rod body. The pushing rod body is operable to move relative to the first connecting frame, so as to drive the pushing portion to push the locking hook to rotate.

In an embodiment, the unlocking component further includes a second reset member disposed between the first connecting frame and the first pushing rod. The second reset member biases the pushing portion to move in a direction away from the locking hook.

In an embodiment, the child carrier further includes a handlebar assembly. The handlebar assembly includes a handlebar and a locking mechanism. The locking mechanism has a locked state and an unlocked state. When the locking mechanism is in the locked state, the handlebar is limited in a predetermined position. When the locking mechanism is in the unlocked state, the handlebar is non-limited in the predetermined position. When the frame is folded, the locking mechanism is capable of being driven to be switched from the locked state to the unlocked state.

In an embodiment, the child carrier further includes a first pulling member. The handlebar assembly is connected to the first frame. One end of the first pulling member is connected to the locking mechanism, and another end of the first pulling member is connected to the linkage mechanism. When the frame is switched from the unfolded state to the folded state, the linkage mechanism is capable of driving the locking mechanism to switch from the locked state to the unlocked state.

In an embodiment, the child carrier further includes a seat assembly fixed to the linkage mechanism and a backrest assembly. The frame further includes a connecting base. The backrest assembly is rotatably connected to the connecting base. The seat assembly is removably connected to the connecting base.

In an embodiment, the child carrier further includes a backrest assembly removably connected to the linkage mechanism. When the frame is switched from the unfolded state to the folded state, the linkage mechanism drives the backrest assembly to be folded.

In an embodiment, the child carrier further includes a sunshade removably or rotatably connected to the backrest assembly.

In an embodiment, the child carrier further includes a pushing assembly and a first fixing mechanism. The pushing assembly is removably connected to the linkage mechanism through the first fixing mechanism.

In an embodiment, the first fixing mechanism includes a first locking member movably connected to the pushing assembly. The first locking member has a first locked position and a first unlocked position. When the first locking member is in the first locked position, the first locking member is engaged with the frame. When the first locking member is in the first unlocked position, the first locking member is disengaged from the frame, and the first locking member is operable to drive the first locking member to be switched between the first locked position and the first unlocked position.

In an embodiment, the first locking member is provided with a first locking protrusion. The frame is provided with a first locking hole. When the first locking member is in the first locked position, the first locking protrusion is engaged in the first locking hole.

In an embodiment, the first fixing mechanism further includes a first operating member connected to the first locking member. The first operating member is movably disposed on the pushing assembly. The first operating member is operable to drive the first locking member to be switched between the first locked position and the first unlocked position.

In an embodiment, the first fixing mechanism further includes a first driving member. One end of the first driving member is provided with a first driving groove. An extending direction of the first driving groove intersects and is not perpendicular to a moving direction of the first operating member. The first locking member includes a first driving pin. The first driving pin is capable of being inserted into the first driving groove and moving along the first driving groove; another end of the first driving member is connected to the first operating member. The first operating member is capable of moving in an extending direction of the pushing assembly.

In an embodiment, the first locking member is provided with a first locking protrusion; the frame is provided with a first locking hole; the pushing assembly is provided with a second receiving cavity extending parallel to an extending direction of the pushing assembly. A sidewall of the second receiving cavity is provided with a first via hole. The first locking member is disposed in the second receiving cavity. When the first locking member is in the first locked position, the first locking protrusion extends through the first via hole and is engaged in the first locking hole, the first driving member is inserted into the second receiving cavity, one end of the first driving member is connected to the first locking member, and another end of the first driving member extends out of the second receiving cavity and is connected to the first operating member.

In an embodiment, the first fixing mechanism further includes a third reset member disposed between the pushing assembly and the first locking member. The third reset member biases first locking member to move toward the first locked position.

In an embodiment, the frame is provided with a pushing rod mounting base. The pushing rod mounting base is provided with a first mounting groove. A portion of the pushing assembly connected to the first locking member is inserted into the first mounting groove. The first driving member is capable of being engaged with a groove wall of the first mounting groove.

In an embodiment, the first locking member is provided with a first locking protrusion. The groove wall of the first mounting groove is provided with a first locking hole. When the first locking member is in the first locked position, the first locking protrusion is engaged in the first locking hole.

In an embodiment, the pushing assembly includes a first connecting rod connected to the frame, a second connecting rod removably connected to the first connecting rod, and a length adjustment mechanism. The length adjustment mechanism has a locked state and an unlocked state. When the length adjustment mechanism is in the unlocked state, the second connecting rod is capable of moving in an extending direction of the first connecting rod to extend or contract the pushing assembly; and when the length adjustment mechanism is in the locked state, the second connecting rod and the first connecting rod are fixed relative to each other.

In an embodiment, the length adjustment mechanism includes a second locking member having a second locked position and a second unlocked position. The second locking member is operable to be switched between the second locked position and the second unlocked position. The first connecting rod is provided with at least two second locking holes. The second locking member is movably disposed on the second connecting rod. When the second locking member is in the second locked position, the second locking member is capable of being engaged in any one of the second locking holes; and when the second locking portion is in the second unlocked position, the second locking member is disengaged from the second locking hole.

In an embodiment, the length adjustment mechanism further includes a second operating member movably disposed on the pushing assembly and connected to the second locking member. The second operating member is operable to drive the second locking member to be switched between the second locked position and the second unlocked position.

In an embodiment, the length adjustment mechanism further includes a second driving member. One of the second driving member and the second operating member is provided with a second driving groove, another of the second driving member and the second operating member is provided with a second driving pin. An extending direction of the second driving groove intersects and is not perpendicular to a moving direction of the second operating member. The second driving pin is capable of being inserted into the second driving groove and moving along the second driving groove. One of the second driving member and the second locking member is provided with a third driving groove, another of the second driving member and the second locking member is provided with a third driving pin. An extending direction of the third driving groove intersects and is not perpendicular to the moving direction of the second operating member. The third driving pin is capable of being inserted into the third driving groove and moving along the third driving groove. The second driving groove is spaced apart from the third driving groove.

In an embodiment, the first connecting rod comprises a hollow end; the second connecting rod is inserted into the hollow end. The second connecting rod is provided with a third receiving cavity extending parallel to an extending direction of the second connecting rod. The second connecting rod is provided with a second via hole. The second via hole extends through a sidewall of the third receiving cavity. The second locking member is at least partially disposed in the third receiving cavity. When the second locking member is in the second locked position, at least a part of the second locking member extends through the second via hole and is engaged in any one of the second locking holes.

In an embodiment, the first connecting rod comprises a hollow end; the second connecting rod is inserted into the hollow end. The second connecting rod is provided with a third receiving cavity extending parallel to an extending direction of the second connecting rod. The length adjustment mechanism further includes a guide base. The guide base is disposed in the third receiving cavity. The guide base includes a first receiving groove, a second receiving groove, and an elongated hole extending through the first receiving groove and the second receiving groove. An extending direction of the first receiving groove and an extending direction of the elongated hole respectively intersect an extending direction of the second receiving groove. The second locking member is movably inserted into the first receiving groove. A driving connecting portion of the second driving member is movably inserted into the second receiving groove. The third driving pin extends through the elongated hole to connect the second locking member to the driving connecting portion of the second driving member

In an embodiment, the length adjustment mechanism further includes a fourth reset member disposed between the second driving member and the pushing assembly. The fourth reset member biases the second driving member to move in a direction driving the second locking member to move to the second locked position.

In another aspect, a handlebar assembly is provided. The handlebar assembly includes: at least two handlebars having multiple use heights; and a first synchronization mechanism located between the at least two handlebars. The at least two handlebars are configured to be synchronously switched between different use heights through the first synchronization mechanism.

In an embodiment, the at least two handlebars include a first handlebar and a second handlebar. The first handlebar includes a first connecting section and a first holding portion. The second handlebar includes a second connecting section and a second holding portion. The first connecting section and the second connecting section are rotatably connected to each other. The first synchronization mechanism is disposed between the first connecting section and the second connecting section. The first synchronization mechanism enables the first connecting section and the second connecting section to rotate in opposite directions synchronously, so as to synchronously adjust the use heights of the first holding portion and the second holding portion.

In an embodiment, the first synchronization mechanism includes a first driving element and a second driving element drivingly connected to the first driving element. The first driving element is drivingly connected to the first handlebar; and the second driving element is drivingly connected to the second handlebar.

In an embodiment, the first handlebar is a L-shaped rod or an arc-shaped rod; the first connecting section and the first holding portion are located at two ends of the first handlebar respectively. The second handlebar is a L-shaped rod or an arc-shaped rod; the second connecting section and the second holding portion are located at two ends of the second handlebar respectively.

In an embodiment, the at least two handlebars each include a first handlebar including a first fitting ring and a second handlebar including a second fitting ring. The first fitting ring is provided with a first internal gear portion in a circumferential direction. The second fitting ring is provided with a second internal gear portion in a circumferential direction. The first synchronization mechanism includes a first external gear and a second external gear. The first external gear is engaged with the first internal gear portion, and the second external gear is engaged with the second internal gear portion.

In an embodiment, the first fitting ring and the second fitting ring are overlapped to form a receiving cavity, and the first external gear and the second external gear are both disposed in the receiving cavity.

In an embodiment, the handlebar assembly further includes a support base connected to the frame. The support base includes a mounting member provided with a first pivot shaft and a second pivot shaft that are spaced apart. The first external gear and the second external gear are pivotally connected to the first pivot shaft and the second pivot shaft respectively; and the first fitting ring and the second fitting ring are rotatable relative to the mounting member.

In an embodiment, the first handlebar is a L-shaped rod or an arc-shaped rod. The first handlebar further includes a first holding portion; the first fitting ring and the first holding portion are located on two ends of the first handlebar respectively. The second handlebar is a L-shaped rod or an arc-shaped rod. The second handlebar further includes a second holding portion. The second fitting ring and the second holding portion are respectively located at two ends of the second handlebar.

In an embodiment, the handlebar assembly further includes a locking mechanism having a locked state and an unlocked state. When the locking mechanism is in the locked state, the at least two handlebars are locked at any of the use heights; and when the locking mechanism is in the unlocked state, the at least two handlebars are operable to be switched to another one of the use heights.

In an embodiment, the at least two handlebars include a first handlebar and a second handlebar. The locking mechanism includes a pushing button. The pushing button is movable between a first position and a second position. One of the first handlebar and the pushing button is provided with a first locking groove, and another of the first handlebar and the pushing button is provided with a first locking portion. One of the second handlebar and the pushing button is provided with a second locking groove, and another of the second handlebar and the pushing button is provided with a second locking portion. When the pushing button is in the first position, the first locking portion and the second locking portion are engaged in the first locking groove and the second locking groove respectively; when the pushing button is in the second position, the first locking portion and the second locking portion are disengaged from the first locking groove and the second locking groove respectively.

In an embodiment, one of the second handlebar and the pushing button is further provided with a third locking groove, and another of the second handlebar and the pushing button is further provided with a third locking portion. When the pushing button is in the first position, the third locking portion is engaged in the third locking groove; when the pushing button is in the second position, the third locking portion is disengaged from the third locking groove.

In an embodiment, the pushing button includes an unlocking operating member. The unlocking operating member is operable to move the pushing button to the second position.

In an embodiment, the locking mechanism further includes a pushing button reset member. The pushing button reset member biases the pushing button to move toward the first position.

In an embodiment, the first handlebar includes a first fitting ring. The first fitting ring is provided with a first internal gear portion in a circumferential direction. The second handlebar includes a second fitting ring. The second fitting ring is provided with a second internal gear portion in a circumferential direction. The first synchronization mechanism includes a first external gear and a second external gear. The first external gear is engaged with the first internal gear portion. The second external gear is engaged with the second internal gear portion. The first locking groove is disposed on the first fitting ring, the second locking groove is disposed on the second fitting ring; and the first locking portion and the second locking portion are disposed on the pushing button.

In an embodiment, one of the second handlebar and the pushing button is further provided with a third locking groove, and another of the second handlebar and the pushing button is further provided with a third locking portion. When the pushing button is in the first position, the third locking portion is engaged in the third locking groove; when the pushing button is in the second position, the third locking portion is disengaged from the third locking groove. The third locking groove is disposed on the first fitting ring, and the third locking groove is provided opposite to the first locking groove; and the third locking portion is disposed on the pushing button.

In an embodiment, the pushing button includes a second pushing rod and a locking rod. An angle is formed between the second pushing rod and the locking rod. The locking rod is a L-shaped rod and includes a first rod and a second rod that are arranged at an angle to each other. One end of the first rod away from the second rod is connected to the second pushing rod. The second pushing rod is provided with an engaging end. The first handlebar includes a first fitting ring, and a second handlebar includes a second fitting ring. When the pushing button is in the first position, the first fitting ring and the second fitting ring are located between the second rod and the engaging end. The second rod forms the first locking portion, and the engaging end forms the second locking portion.

In an embodiment, the handlebar assembly includes a support base connected to the frame. At least a part of the first handlebar and at least a part of the second handlebar are disposed in the support base, and rotatable relative to the support base. The pushing button is movably disposed in the support base.

In an embodiment, the support base is provided with a first operating hole. The pushing button is provided with an unlocking operating member. At least a part of the unlocking operating member extends out of a surface of the support base through the first operating hole to be operated.

In another aspect, a child carrier is provided. The child carrier includes: a frame; and the handlebar assembly according to any one of the above embodiments. The handlebar assembly is mounted on the frame.

In another aspect, a child carrier is provided. The child carrier includes: a backrest assembly; an armrest assembly connected to the backrest assembly and having an unfolded state and a folded state; and a first positioning mechanism disposed between the backrest assembly and the armrest assembly. When the armrest assembly is in the unfolded state, the first positioning mechanism enables the armrest assembly to be fixed in a first position relative to the backrest assembly; when the armrest assembly is in the folded state, the first positioning mechanism enables the armrest assembly to be fixed in a second position relative to the backrest assembly.

In an embodiment, the first positioning mechanism includes: a first positioning portion and a second positioning portion that are disposed on one of the backrest assembly and the armrest assembly; and a third positioning portion disposed on another of the backrest assembly and the armrest assembly. When the armrest assembly is in the unfolded state, the third positioning portion is locked with the first positioning portion to fix the armrest assembly in the first position relative to the backrest assembly; when the assembly is in the folded state, the third positioning portion is locked with the second positioning portion to fix the armrest assembly in the second position relative to the backrest assembly.

In an embodiment, the armrest assembly is operable to switch the third positioning portion from locking with the first positioning portion to locking with the second positioning portion. Or, the armrest assembly is operable to switch the third positioning portion from locking with the second positioning portion to locking with the first positioning portion.

In an embodiment, the first positioning mechanism includes: a first positioning recess and a second positioning recess that are spaced apart on the backrest assembly; and a first positioning protrusion movably disposed on the armrest assembly. When the armrest assembly is in the unfolded state, the first positioning protrusion is inserted into the first positioning recess to fix the armrest assembly in the first position relative to the backrest assembly; when the assembly is in the folded state, the first positioning protrusion is inserted into the second positioning recess to fix the armrest assembly in the second position relative to the backrest assembly.

In an embodiment, the first positioning protrusion is a ball. The first positioning recess and the second positioning recess are partially spherical holes capable of being fitted with the ball.

In an embodiment, the first positioning protrusion has a locked position. When the first positioning protrusion is in the locked position, the first positioning protrusion is inserted into the first positioning recess or the second positioning recess. The first positioning mechanism further includes a fifth reset member disposed between the first positioning protrusion and the armrest assembly. The fifth reset member biases the first positioning protrusion to move toward the locked position.

In an embodiment, the backrest assembly includes a mounting base and a fixed base rotatably connected to the mounting base. The armrest assembly is fixedly connected to the fixed base. The first positioning mechanism includes a first positioning recess, a second positioning recess and a first positioning protrusion. The first positioning recess and the second positioning recess are spaced apart on the mounting base. The first positioning protrusion is movably disposed on the mounting base. When the armrest assembly is in the unfolded state, the first positioning protrusion is inserted into the first positioning recess to fix the armrest assembly in the first position relative to the backrest assembly; when the armrest assembly is in the folded state, the first positioning protrusion is inserted into the second positioning recess to fix the armrest assembly in the second position relative to the backrest assembly.

In an embodiment, the fixed base is provided with an accommodating groove. The accommodating groove extends in a direction parallel to axes of rotation of the fixed base and the mounting base. The first positioning protrusion is movably disposed in the accommodating groove.

In an embodiment, the fixed base is provided with an accommodating groove. The first positioning mechanism further includes a fifth reset member disposed in the accommodating groove; and two ends of the fifth reset member abut against the first positioning protrusion and a bottom of the accommodating groove respectively.

In an embodiment, the backrest assembly further includes a connecting base rotatably connected to the connecting base; and the fixed base is rotatably connected to the mounting base. The connecting base includes a third housing and a fourth housing that are fixedly connected to each other. The mounting base is rotatably connected to the fourth housing. The mounting base, the third housing, and the fourth housing enclose a fourth accommodation cavity; and the first positioning recess and the second positioning recess are both disposed on a side of the mounting base facing the fourth housing. The fourth housing is provided with a mounting opening extending therethrough. The fixed base is provided with a mounting boss. The mounting boss is provided with an accommodating groove. The first positioning protrusion is movably disposed in the accommodating groove and is movable to be partially outside the accommodating groove. The mounting boss extends into the fourth accommodation cavity through the mounting opening.

In an embodiment, when the armrest assembly is in an intermediate state between the unfolded state and the folded state, the first positioning mechanism enables the armrest assembly to be fixed in a third position relative to the backrest assembly.

In an embodiment, the backrest assembly includes a backrest body and a fixed base rotatably connected to the backrest body. The fixed base is connected to the armrest assembly; and an armrest body of the armrest assembly is removably connected to the fixed base.

In an embodiment, the fixed base is provided with an engaging portion; and the armrest body is provided with a positioning groove configured to be being engaged with the engaging portion.

In an embodiment, the child carrier further includes a first locking mechanism. The first locking mechanism includes a third locking member and a third locking hole. The third locking member is movably disposed on one of the armrest body and the fixed base, and the third locking hole is disposed on another of the armrest body and the fixed base; and the third locking member is capable of being locked into the third locking hole.

In an embodiment, the child carrier further includes a first locking mechanism. The first locking mechanism includes: a third locking member; and a third locking hole located on the fixed base. The third locking member is pivotally connected to the armrest body at a first pivot point. The third locking member includes a first operating end and a first locking end. The first pivot point is disposed between the first operating end and the first locking end. The first locking end is capable of being inserted into the third locking hole; the first operating end is operable to separate the first locking end from the third locking hole.

In an embodiment, the first locking mechanism further includes a sixth reset member disposed between the first operating end and the armrest body. The sixth reset member biases the first locking end to rotate in a direction in which the first locking end is inserted into the third locking hole.

In an embodiment, the armrest assembly includes an armrest body, a first armrest rod, and a second armrest rod. The first armrest rod and the second armrest rod are connected to two ends of the armrest body respectively, and connected to two sides of the backrest assembly respectively. The first positioning mechanism is disposed between the first armrest rod and the backrest assembly and between the second armrest rod and the backrest assembly.

In an embodiment, the child carrier includes: a frame; and an adjustment mechanism disposed between the frame and the backrest assembly. The backrest assembly is connected to the frame, and the adjustment mechanism selectively limits or enables a relative rotation of the backrest assembly and the frame.

In an embodiment, the adjustment mechanism includes: a second locking component having a locked state in which the relative rotation of the backrest assembly and the frame is limited and an unlocked state in which the relative rotation of the backrest assembly and the frame is non-limited; and an operating component connected to the second locking component and operable to switch the second locking component between the locked state and the unlocked state.

In an embodiment, the backrest assembly further includes a mounting base fixedly connected to the frame. The second locking component includes a limiting hole disposed on the mounting base, and a limiting pin movably disposed on the backrest assembly. The limiting pin is capable of being inserted into the limiting hole.

In an embodiment, at least two limiting holes are provided. The limiting pins is capable of being inserted into different limiting holes so as to fix the backrest assembly at different relative angles relative to the frame.

In an embodiment, the operating component includes: an unlocking member; and a second pulling member, two ends of the second pulling member being connected to the unlocking member and the second locking component respectively. The unlocking member is operable to drive the second locking component to be switched from the locked state to the unlocked state through the second pulling member.

In an embodiment, the operating component further includes a seventh reset member. The seventh reset member biases the second pulling member to move in a direction of driving the second locking component to be switched to the locked state.

In an embodiment, the child carrier further includes a frame. The backrest assembly is removably connected to the frame. The backrest assembly further includes a connecting base. The backrest assembly is removably connected to the frame through the connecting base.

In an embodiment, the child carrier further includes a second locking mechanism. The second locking mechanism includes: a first locking element disposed on the connecting base; and a second locking element disposed on the frame. The first locking element is capable of being locked with or unlocked from the second locking element.

In an embodiment, the child carrier further includes a second locking mechanism. The second locking mechanism includes: a fourth locking member movably disposed on the connecting base; and a fourth locking hole disposed on the frame. The fourth locking member is capable of being locked with or unlocked from the fourth locking hole.

In an embodiment, the fourth locking member is pivotally connected to the connecting base at a second pivot point. The fourth locking member includes a second operating end and a second locking end. The second pivot point is disposed between the second operating end and the second locking end. The second locking end is capable of being inserted to the fourth locking hole. The second operating end is operable to separate the second locking end from the fourth locking hole.

In an embodiment, the connecting base includes a third housing and a fourth housing. The third housing and the fourth housing cooperatively enclose a fifth accommodation cavity. The fourth locking member is located in the fifth accommodation cavity. The third housing is provided with a through hole. The second locking end is capable of extending through the through hole and being inserted into the fourth locking hole. The fourth housing is provided with a second operating hole. The second operating end at least partially extends out of an outer surface of the fourth housing through the second operating hole.

In an embodiment, the second locking mechanism further includes an eighth reset member disposed between the second operating end and the connecting base. The eighth reset member biases the second operating end to move in a direction of driving the second locking end to be locked into the fourth locking hole.

In an embodiment, one of the frame and the backrest assembly is provided with a guide boss, and another of the frame and the backrest assembly is provided with a guide groove; and the guide boss is capable of being inserted into the guide groove.

In an embodiment, a sidewall of the guide groove is provided with an insertion opening; and the guide boss is capable of being inserted into the guide groove through the insertion opening. The guide boss is provided with a guide hole; a bottom of the guide groove is provided with a guide rib. When the guide boss is inserted into the guide groove, the guide rib is inserted into the guide hole.

In still another aspect, a footrest device is provided. The footrest device includes: a support member configured to be connected to a frame, wherein the support member is switchable between a first rotation position and a second rotation position, when the support member is switched from the first rotation position to the second rotation position, the support member is folded in a direction approaching the frame; and a footrest component configured to be pivotally or removably connected to the support member. When the footrest component is pivotally connected to the support member, the footrest component is switchable between an unfolded state and a folded state. When the footrest component in the unfolded state, the footrest component is configured to carry a child's feet, and when the footrest component is in the folded state, the footrest component is folded approaching the support member. The footrest device has a use state and a non-use state. When the footrest device is in the use state, the support member is in the first rotation position, and the footrest component is in the unfolded state or is mounted on the on the support member; when the footrest device is in the non-use state, the support member is in the second rotation position, and the footrest component is in the folded state or is removed from the support member.

In an embodiment, the footrest component is capable of being connected to a pedal base of a child carrier to serve as a pedal component for children to drive the child carrier to move.

In an embodiment, the footrest component includes: a footrest body configured to carry the child's feet; and a first pin shaft connected to the footrest body, an end of the first pin shaft being provided with a fourth locking groove in a circumferential direction. The footrest device further includes a second fixing mechanism. The second fixing mechanism includes: a fifth locking member movably disposed on the support member, and switchable between a first locked position and a first unlocked position, the fifth locking member being provided with a fifth locking hole, a radial size of the fifth locking hole being greater than a radial size of the first pin shaft; and a locking reset member disposed between the fifth locking member and the support member, the locking reset member biasing the fifth locking member to move to the first locked position. The end of the first pin shaft provided with the fourth locking groove is capable of being inserted into the support member and extending through the fifth locking hole. When the fifth locking member is located in the first locked position, a hole wall of the fifth locking hole is inserted into the fourth locking groove.

In an embodiment, at least a part of the fifth locking member extends out of the support member; and the part of the fifth locking member extending out of the support member is operable to move from the first locked position to the first unlocked position. Or, when the end of the first pin shaft provided with the fourth locking groove is inserted into the support member, the first pin shaft is capable of driving the fifth locking member to move from the first locked position to the first unlocked position.

In an embodiment, the first pin shaft is partially inserted into the footrest component; the end of the first pin shaft provided with the fourth locking groove extends out of the footrest component. An extending direction of the first pin shaft intersects a moving direction of the fifth locking member.

In an embodiment, the footrest device further includes a connecting member fixedly connected to the frame. The support member is pivotally connected to the connecting member.

In an embodiment, the footrest device further includes a second positioning mechanism. The second positioning mechanism includes a fourth positioning portion, a fifth positioning portion, and a sixth positioning portion. The fourth positioning portion and the fifth positioning portion are disposed on one of the support member and the connecting member, the sixth positioning portion is disposed on another of the support member and the connecting member. When the support member is in the first rotation position, the sixth positioning portion and the fourth positioning portion are locked to each other; when the support member is in the second rotation position, the sixth positioning portion and the fifth positioning portion are locked to each other.

In an embodiment, the footrest device further includes a second positioning mechanism. The second positioning mechanism includes a third positioning recess, a fourth positioning recess, and a second positioning protrusion. The third positioning recess and the and the fourth positioning recess are disposed on one of the support member and the connecting member, and the second positioning protrusion is movably disposed on another of the support member and the connecting member. The second positioning protrusion has a first moving position and a second moving position. When the second positioning protrusion is in the first moving position, the second positioning protrusion is engaged in the third positioning recess or the fourth positioning recess; when the second positioning protrusion is in the second moving position, the second positioning protrusion is disengaged from the third positioning recess or the fourth positioning recess.

In an embodiment, the third positioning recess and the fourth positioning recess are a first positioning groove and a second positioning groove respectively, and the second positioning protrusion is a ball.

In an embodiment, the second positioning mechanism further includes a positioning reset member disposed between the second positioning protrusion and the support member. The positioning reset member biases the second positioning protrusion to move toward the first moving position.

In an embodiment, the support member includes: a support body configured to be connected to the footrest component; and a first pivot portion protruding from the support body and including a first side surface, the first side surface being provided with the third positioning recess and the fourth positioning recess. The connecting member includes a second pivot portion pivotally connected to the first pivot portion through a rotating shaft. The second pivot portion includes a second side surface facing the first side surface. The second side surface is provided with a second mounting groove. The second positioning protrusion is movably disposed in the second mounting groove. When the second positioning protrusion is in the first moving position, at least a part of the second positioning protrusion extends out of the second mounting groove to be engaged with the third positioning recess or the fourth positioning recess; and when the second positioning protrusion is in the second moving position, the second positioning protrusion retracts into the second mounting groove to be disengaged from the third positioning recess or the fourth positioning recess.

In an embodiment, the third positioning recess and the fourth positioning recess are disposed around the rotating shaft; an extending direction of the second mounting groove is substantially parallel to a length direction of the rotating shaft.

In an embodiment, the support member includes two first pivot portions disposed opposite to each other. The two first pivot portions are pivotally connected to two sides of the second pivot portion through two rotating shafts respectively. The second mounting groove is disposed on each of two second side surfaces of the second pivot portion opposite to the two first pivot portions. Two second positioning mechanisms are provided, and each of the two second positioning mechanisms is disposed between the second pivot portion and corresponding one of the two first pivot portions.

In an embodiment, the footrest device further includes a second positioning mechanism. The second positioning mechanism includes a fourth positioning portion, a fifth positioning portion, and a sixth positioning portion. The fourth positioning portion and the fifth positioning portion are disposed on one of the support member and the connecting member, the sixth positioning portion is disposed on another of the support member and the connecting member. The fourth positioning portion and the fifth positioning portion are configured to be magnetically locked with the sixth positioning portion.

In an embodiment, the footrest device further includes a second synchronization mechanism. The second synchronization mechanism includes: a third driving member; and a fourth driving member drivingly connected to the third driving member. The footrest component includes: a first footrest connected to the third driving member; and a second footrest connected to the fourth driving member. The first footrest and the second footrest are pivotally connected to opposite sides of the support member respectively.

In an embodiment, the third driving member includes a first gear tooth portion, and the fourth driving member includes a second gear tooth portion; and the first gear tooth portion and the second gear teeth are capable of being engaged with each other.

In an embodiment, the footrest device further includes: a third pivot shaft rotatably connected to the support member; and a fourth pivot shaft rotatably connected to the support member. The third driving member and the first footrest are fixedly connected to the third pivot shaft; the fourth driving member and the second footrest are fixedly connected to the third pivot shaft.

In an embodiment, the footrest component is pivotally connected to the support member. The footrest device further includes a fixing component. The fixing component includes: a first magnetic member disposed on the footrest component; and a second magnetic member disposed on the support member. When the footrest component is in the folded state, the first magnetic member and the second magnetic member are attracted to each other.

In an embodiment, the footrest device further includes a fixing component. The fixing component includes: a permanent magnet disposed on the footrest component; and a rotating shaft, the support member being pivotally connected to the frame through the rotating shaft, and the rotating shaft being made of ferromagnetic material. When the footrest component is in the folded state, the permanent magnet attracts the rotating shaft. The footrest component is pivotally connected to the support member.

In an embodiment, the footrest component and the support member are pivotally connected to each other through a third pivot shaft. The support member and the connecting member are pivotally connected to each other through a rotating shaft. The rotating shaft is spaced apart from the third pivot shaft, and is not parallel to the third pivot shaft.

In still another aspect, a child carrier is provided. The child carrier includes: a frame; and the footrest device according to any one of above embodiments.

In an embodiment, the child carrier further includes a pedal device. The pedal device includes: a pedal component; a pedal base connected to a wheel assembly; and a third fixing mechanism. The pedal component is removably connected to the pedal base through the third fixing mechanism.

In an embodiment, the pedal component is the footrest component.

In an embodiment, the pedal component is provided with a fifth locking groove; the third fixing mechanism comprises a sixth locking member movably disposed on the pedal base. The sixth locking member has a first acting position and a second acting position. When the sixth locking member is in the first acting position, the sixth locking member is inserted into the fifth locking groove to fixedly connect the pedal component to the pedal base; and when the sixth locking member is in the second acting position, the sixth locking member is separated from the fifth locking groove, and the pedal component is capable of being separated from the pedal base.

In an embodiment, the pedal component includes a pedal body and a second pin shaft that are connected to each other. The second pin shaft is provided with a fifth locking groove; the third fixing mechanism includes a sixth locking member movably disposed on the pedal base. The sixth locking member is provided with a sixth locking hole. A radial size of the sixth locking hole is greater than a radial size of the second pin shaft. The second pin shaft extends through the sixth locking hole. A position of the fifth locking groove corresponds to the sixth locking hole. The sixth locking member has a first acting position and a second acting position. When the sixth locking member is in the first acting position, a part of a hole wall of the sixth locking hole is inserted into the fifth locking groove. When the sixth locking member is in the second acting position, the part of the hole wall of the sixth locking hole is separated from the fifth locking groove.

In an embodiment, the third fixing mechanism further includes: a third operating member fixedly connected to the sixth locking member, and the third operating member being operated to enable the sixth locking member to move from the first acting position to the second acting position; and an operating reset member disposed between the third operating member and the pedal base. The operating reset member biases the third operating member to drive the sixth locking member to move to the first acting position.

In an embodiment, the child carrier further includes a wheel assembly rotatably connected to the frame. The pedal base includes: a fifth housing connected to the wheel assembly, the fifth housing being provided with a fourth receiving groove and a receiving boss, the receiving boss being provided with a fourth receiving cavity extending therethrough, a first groove wall of the fourth receiving groove being provided with an insertion hole, the fourth receiving groove being in communication with the fourth receiving cavity through the insertion hole; and a sixth housing provided with a third operating hole and a mounting hole that are spaced apart. The fifth housing and the sixth housing are connected to each other to form a mounting cavity. The fourth receiving groove and the receiving boss are located in the mounting cavity. The receiving boss extends through the mounting hole and extends out of an outer surface of the sixth housing. At least a part of the second pin shaft is inserted into the fourth receiving cavity. The sixth locking member and at least a part of the third operating member are movably disposed in the mounting cavity. At least a part of the sixth locking member is inserted into the fourth receiving cavity through the insertion hole so as to be inserted into or separated from the fifth locking groove of the second pin shaft. At least a part of the third operating member extends out of the mounting cavity through the third operating hole.

In an embodiment, two ends of the operating reset member respectively abut against the third operating member and a second groove wall of the fourth receiving groove; and the second groove wall is disposed opposite to the first groove wall.

In an embodiment, the first groove wall forms a fourth limiting portion, and the third operating member is provided with a fifth limiting portion. When the sixth locking member is in the first acting position, the fourth limiting portion abuts against the fifth limiting portion.

In still another aspect, a footrest device is provided. The footrest device includes: a footrest body configured for being connected to the frame. The footrest body has an unfolded state and a folded state. When the footrest body is in the unfolded state, the footrest body is configured to carry child's feet.

In an embodiment, the footrest device further includes: a support member configured to be connected to the frame. The footrest body at least includes a first footrest and a second footrest. The first footrest and the second footrest are rotatably connected to opposite sides of the support member respectively. The first footrest and the second footrest each have an unfolded state and a folded state relative to the support member. When the first footrest or the second footrest is in the unfolded state, the first footrest or the second footrest is configured to carry the child's feet. When the first footrest or the second footrest is in the folded state, the first footrest or the second footrest is folded approaching the support member.

In an embodiment, the footrest device further includes a second synchronization mechanism. The second synchronization mechanism is disposed between the first footrest and the second footrest. The second synchronization mechanism enables a synchronous rotation of the first footrest and the second footrest.

In an embodiment, the footrest device further includes a second synchronization mechanism. The second synchronization mechanism includes a third driving member and a fourth driving member. The third driving member is connected to the first footrest. The fourth driving member is connected to the second footrest. The third driving member is drivingly connected to the fourth driving member.

In an embodiment, the footrest device further includes a second synchronization mechanism. The second synchronization mechanism includes a third driving member and a fourth driving member, to respectively drive the first footrest and the second footrest to rotate in opposite directions synchronously. The third driving member includes a first gear tooth portion, and the fourth driving member includes a second gear tooth portion. The first gear tooth portion and the second gear tooth portion are engaged with each other.

In an embodiment, the footrest device further includes a second synchronization mechanism, a third pivot shaft, and a fourth pivot shaft. The second synchronization mechanism includes a third driving member and a fourth driving member. The third driving member and the first footrest are rotatably connected to the support member through a third pivot shaft. The fourth driving member and the second footrest are rotatably connected to the support member through a fourth pivot shaft.

In an embodiment, the footrest device further includes: a fixing component disposed between the footrest body and the support member. When the footrest body is in the folded state, the footrest body is capable of being fixed to a side of the support member through the fixing component.

In an embodiment, the fixing component includes a first magnetic member disposed on the footrest body and a second magnetic member disposed on the support member. When the footrest body is in the folded state, the first magnetic member and the second magnetic member attract each other.

In an embodiment, the fixing component includes a permanent magnet disposed on the footrest body and a rotating shaft disposed on the support member. The support member is rotatably connected to the frame through the rotating shaft. The rotating shaft is made of ferromagnetic material. When the footrest body is in the folded state, the permanent magnet is attracted to the rotating shaft.

In an embodiment, the pedal device further includes: a support member configured to be connected to the frame, the footrest body being rotatably connected to the support member; and a connecting member configured to be connected to the frame. The support member is rotatably connected to the connecting member. The support member has a first rotation position and a second rotation position relative to the connecting member. When the support member is in the first rotation position and the footrest body is in the unfolded state, the footrest body is configured to carry child's feet. When the support member is in the second rotation position, the support member is folded approaching the frame.

In an embodiment, the footrest body and the support member are pivotally connected to each other through a third pivot shaft. The support member and the connecting member are pivotally connected to each other through a rotating shaft. The rotating shaft is spaced apart from the third pivot shaft, and is not parallel to the third pivot shaft.

In an embodiment, the rotating shaft is perpendicular to the third pivot shaft.

In an embodiment, the footrest device further includes a second positioning mechanism. The second positioning mechanism is disposed between the support member and the connecting member. The second positioning mechanism is configured to enable the support member to be fixed in the first rotation position or the second rotation position relative to the connecting member.

In an embodiment, the footrest device further includes a second positioning mechanism. The second positioning mechanism includes a fourth positioning portion, a fifth positioning portion, and a sixth positioning portion. The fourth positioning portion and the fifth positioning portion is disposed on one of the support member and the connecting member, and the sixth positioning portion is disposed on another of the support member and the connecting member. The fourth positioning portion and the fifth positioning portion are configured to be magnetically locked with the sixth positioning portion

In an embodiment, the footrest device further includes: a support member configured to be connected to the frame, the footrest body being rotatably connected to the support member. The support member has a first rotation position and a second rotation position. When the support member is in the first rotation position and the footrest body is in the unfolded state, the footrest body is configured to carry the child's feet. When the support member is in the second rotation position, the support member is folded approaching the frame.

In another aspect, a child carrier is provided. The child carrier includes; a frame; and a pedal device according to any one of the above embodiments.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The above and other objects and features of the present invention will become apparent and more readily appreciated from the following description of the embodiments with reference to the following figures, wherein like reference numerals refer to like parts throughout the various figures unless otherwise specified.

FIG. 1 is a schematic perspective view of a child carrier according to an embodiment of the present application, with a frame in an unfolded state.

FIG. 2 is a schematic perspective view of a child carrier shown in FIG. 1 in a semi-folded state.

FIG. 3 is a schematic perspective view of the child carrier shown in FIG. 1 in a folded state.

FIG. 4 is an exploded view of the child carrier shown in FIG. 1.

FIG. 5 is a cross-sectional view of the child carrier shown in FIG. 1.

FIG. 6 is an enlarged view of portion A in FIG. 5.

FIG. 7 is a cross-sectional view of the child carrier shown in FIG. 2.

FIG. 8 is an enlarged view of portion B in FIG. 7.

FIG. 9 is a schematic perspective view of a locking hook and a linkage mechanism of the child carrier shown in FIG. 1 with a first connecting frame removed.

FIG. 10 is an exploded view of the locking hook and the linkage mechanism shown in FIG. 9 with the first connecting frame removed.

FIG. 11 is a schematic perspective view of the child carrier shown in FIG. 1 from another perspective, with the frame in the unfolded state.

FIG. 12 is a schematic perspective view of the child carrier shown in FIG. 11 in the semi-folded state.

FIG. 13 is a cross-sectional view of the child carrier shown in FIG. 1 taken along a line A-A.

FIG. 14 is an enlarged view of portion C in FIG. 13.

FIG. 15 is a cross-sectional view of the child carrier shown in FIG. 3 taken along a line B-B.

FIG. 16 is an enlarged view of portion D in FIG. 15.

FIG. 17 is a schematic perspective view of the child carrier shown in FIG. 3, viewed from another perspective.

FIG. 18 is a schematic perspective view of a second frame and rear wheels of the child carrier shown in FIG. 1.

FIG. 19 is an exploded view of the second frame shown in FIG. 18.

FIG. 20 is a half-sectional view of the child carrier shown in FIG. 2.

FIG. 21 is an enlarged view of portion E in FIG. 20.

FIG. 22 is a schematic perspective view of a handlebar assembly of the child carrier shown in FIG. 1, with the handlebar assembly in an unfolded state.

FIG. 23 is a schematic perspective view of the handlebar assembly shown in FIG. 22 in a folded state.

FIG. 24 is an exploded view of the handlebar assembly shown in FIG. 22.

FIG. 25 is a schematic perspective view of a child carrier according to another embodiment of the present application, with a handlebar assembly in an unfolded state.

FIG. 26 is a schematic perspective view of the handlebar assembly of the child carrier shown in FIG. 25.

FIG. 27 is a schematic perspective view of the handlebar assembly shown in FIG. 26, viewed from another perspective.

FIG. 28 is an exploded view of the handlebar assembly shown in FIG. 26.

FIG. 29 is a schematic perspective view of a first handlebar of the handlebar assembly shown in FIG. 28.

FIG. 30 is a schematic perspective view of a second handlebar of the handlebar assembly shown in FIG. 28.

FIG. 31 is a front view of the handlebar assembly of the child carrier shown in FIG. 25.

FIG. 32 is a schematic perspective view of the child carrier shown in FIG. 25 after adjusting the use height of the handlebar assembly.

FIG. 33 is a front view of the handlebar assembly of the child carrier shown in FIG. 32.

FIG. 34 is a schematic perspective view of the child carrier shown in FIG. 25 in a folded state.

FIG. 35 is a front view of the handlebar assembly of the child carrier shown in FIG. 34.

FIG. 36 is a partial enlarged view of the handlebar assembly shown in FIG. 26 with a fourth cover removed.

FIG. 37 is a partial enlarged view of the handlebar assembly shown in FIG. 26, viewed from another perspective with the fourth cover removed.

FIG. 38 is a partial enlarged view of the handlebar assembly shown in FIG. 26 with the fourth cover, a mounting member and a pushing button removed.

FIG. 39 is a partial enlarged view of the handlebar assembly shown in FIG. 26, viewed from another perspective with the fourth cover, the mounting member, and the pushing button removed.

FIG. 40 is a cross-sectional view of the handlebar assembly shown in FIG. 26 with the fourth cover, the mounting member and the pushing button removed.

FIG. 41 is a schematic perspective view of the handlebar assembly shown in FIG. 26 with a first housing and a part of a support body removed.

FIG. 42 is an enlarged view of portion F in FIG. 41.

FIG. 43 is a schematic perspective view of the pushing button of the handlebar assembly shown in FIG. 28.

FIG. 44 is a partial enlarged view of the handlebar assembly shown in FIG. 26 with a support base and a linkage assembly removed, and with a first locking component in a locked state.

FIG. 45 is a partial enlarged view of the handlebar assembly shown in FIG. 44, viewed from another perspective.

FIG. 46 is a side cross-sectional view of the handlebar assembly shown in FIG. 26, with a locking mechanism in a locked state.

FIG. 47 is a side cross-sectional view of the handlebar assembly shown in FIG. 26, with the locking mechanism in an unlocked state.

FIG. 48 is a schematic perspective view of a child carrier according to yet another embodiment of the present application, with a frame in an unfolded state.

FIG. 49 is a schematic perspective view of the child carrier shown in FIG. 48 in a semi-folded state.

FIG. 50 is a schematic perspective view of the child carrier shown in FIG. 48 in a folded state.

FIG. 51 is a schematic perspective view of a child carrier in yet another embodiment of the present application, with a frame in an unfolded state.

FIG. 52 is another schematic perspective view of the child carrier shown in FIG. 48, with the child carrier in an unfolded state.

FIG. 53 is a schematic perspective view of the child carrier shown in FIG. 52, viewed from another perspective, with a pushing assembly removed.

FIG. 54 is an exploded view of the child carrier shown in FIG. 53.

FIG. 55 is another exploded view of the child carrier shown in FIG. 53.

FIG. 56 is an enlarged view of portion G in FIG. 55.

FIG. 57 is an enlarged view of portion H in FIG. 54.

FIG. 58 is a side view of the child carrier shown in FIG. 53.

FIG. 59 is a schematic perspective view of the child carrier shown in FIG. 58 in a semi-folded state.

FIG. 60 is a schematic perspective view of the child carrier shown in FIG. 58 in a folded state.

FIG. 61 is an exploded view of a backrest assembly, an armrest assembly, and a sunshade of the child carrier shown in FIG. 52.

FIG. 62 is a cross-sectional view of the armrest assembly shown in FIG. 61.

FIG. 63 is an enlarged view of portion I in FIG. 62.

FIG. 64 is a schematic perspective view of the backrest assembly, the armrest assembly, and the sunshade of the child carrier shown in FIG. 52, with the armrest assembly in a first position.

FIG. 65 is a partial exploded view of FIG. 64.

FIG. 66 is a partial cross-sectional view of FIG. 64.

FIG. 67 is a schematic perspective view of the backrest assembly, the armrest assembly, and the sunshade of the child carrier shown in FIG. 52, with the armrest assembly in a second position.

FIG. 68 is a partial exploded view of FIG. 67.

FIG. 69 is a schematic structural view of the child carrier shown in FIG. 52 with the backrest assembly, the armrest assembly, and the sunshade removed.

FIG. 70 is a schematic perspective view of the child carrier shown in FIG. 69 with the pushing assembly further removed.

FIG. 71 is an enlarged view of portion J in FIG. 70.

FIG. 72 is an enlarged view of portion K in FIG. 61.

FIG. 73 is a partial exploded view of the structure shown in FIG. 61.

FIG. 74 is a partial cross-sectional view of the child carrier shown in FIG. 52.

FIG. 75 is an enlarged view of portion L in FIG. 74.

FIG. 76 is another partial cross-sectional view of the child carrier shown in FIG. 52.

FIG. 77 is an enlarged view of portion M in FIG. 76.

FIG. 78 is a schematic perspective view of a child carrier according to yet further another embodiment of the present application, with a frame in an unfolded state.

FIG. 79 is a schematic perspective view of a pushing assembly and a first fixing mechanism of the child carrier shown in FIG. 78, with the pushing assembly is in an extended state.

FIG. 80 is a schematic structural view of the pushing assembly and the first fixing mechanism of the child carrier shown in FIG. 79 when connected to a pushing mounting base, viewed from another perspective, with the pushing assembly in a retracted state.

FIG. 81 is a cross-sectional view of the pushing assembly shown in FIG. 80, viewed from another perspective, with the pushing assembly in an extended state.

FIG. 82 is an enlarged view of portion N shown in FIG. 81.

FIG. 83 is a schematic perspective view of the first fixing mechanism and a locking mounting base shown in FIG. 79.

FIG. 84 is an enlarged view of portion O in FIG. 81.

FIG. 85 is an enlarged view of portion P in FIG. 81.

FIG. 86 is a schematic perspective view of the pushing assembly and the first fixing mechanism shown in FIG. 80 when connected to the pushing mounting base, with a first connecting rod and a second connecting rod removed.

FIG. 87 is an enlarged view of portion Q in FIG. 86.

FIG. 88 is a schematic perspective view of a guide base of the pushing assembly shown in FIG. 79.

FIG. 89 is a cross-sectional view of the guide base shown in FIG. 88.

FIG. 90 is a schematic perspective view of a child carrier including a footrest device of a first example according to still another embodiment of the present application, with the footrest device in use.

FIG. 91 is a schematic perspective view of the footrest device of the child carrier shown in FIG. 90 when being in a non-use state.

FIG. 92 is a schematic perspective view of the child carrier shown in FIG. 90, viewed from another perspective.

FIG. 93 is an enlarged view of portion R in FIG. 92.

FIG. 94 is a schematic perspective view of the footrest device of the child carrier shown in FIG. 90.

FIG. 95 is a schematic perspective view of the footrest device shown in FIG. 94 when being in a semi-folded state.

FIG. 96 is a schematic perspective view of the footrest device shown in FIG. 94 when being is in a folded state.

FIG. 97 is a cross-sectional view of the footrest device shown in FIG. 94 taken along a line C-C.

FIG. 98 is a cross-sectional view of the footrest device shown in FIG. 95 along line D-D.

FIG. 99 is a schematic perspective view of a support member of the footrest device shown in FIG. 94.

FIG. 100 is a schematic perspective view of a child carrier including a footrest device of a second example according to still another embodiment of the present application, with the footrest device in use.

FIG. 101 is a schematic perspective view of the footrest device of the child carrier shown in FIG. 100 when being in a non-use state, with a support member in a second rotation position.

FIG. 102 is a partial perspective view of the footrest device of the child carrier shown in FIG. 100.

FIG. 103 is a cross-sectional view of a footrest device shown in FIG. 102 taken along a line E-E, with a fifth locking member in a first locked position.

FIG. 104 is a cross-sectional view of the footrest device shown in FIG. 102 taken along a line E-E, with the fifth locking member in a first unlocked position.

FIG. 105 is a schematic perspective view of a footrest component and the support member of the footrest device shown in FIG. 103 in a disassembled state.

FIG. 106 is another schematic perspective view of the child carrier shown in FIG. 101, with the support member in a first rotation position.

FIG. 107 is another schematic perspective view of the child carrier shown in FIG. 101, with the support member between the first rotation position and the second rotation position.

FIG. 108 is a schematic perspective view of the child carrier shown in FIG. 101, viewed from another perspective, with the support member in the second rotation position.

FIG. 109 is an enlarged view of portion S in FIG. 108.

FIG. 110 is a schematic perspective view of a front wheel and a pedal device shown in FIG. 90 or FIG. 101.

FIG. 111 is a schematic perspective view of the front wheel and the pedal device shown in FIG. 110, with a pedal component and a pedal base in a disassembled and separated state.

FIG. 112 is a schematic perspective view of the pedal device shown in FIG. 110.

FIG. 113 is an exploded view of the pedal device shown in FIG. 112.

FIG. 114 is a cross-sectional view of the pedal device shown in FIG. 112 taken along a line F-F, with a sixth locking member in a first acting position.

FIG. 115 is another cross-sectional view of the pedal device shown in FIG. 112 taken along a line F-F, with the sixth locking member in a second acting position.

### ILLUSTRATION FOR REFERENCE NUMERALS

100, Frame; 110, First Frame; 111, Connecting Rod Member; 112, First Connecting Portion; 120, Second Frame; 121, First Movable Connecting Portion; 1211, First Through Hole; 1212, Ball Base; 1213, First Cover; 1214, Second Cover; 122, Rear Wheel Connecting Portion; 123, Universal Ball; 1231, Second Through Hole; 124, First Wedge-Shaped End Surface; 130, Linkage Mechanism; 131, First Connecting Frame; 1311, Side Plate; 1312, Connecting Plate; 1313, First Accommodation Cavity; 1314, Seat Connecting Portion; 1315, Engaging Groove; 1317, First Limiting Portion; 1318, Second Limiting Portion; 1319, Second Accommodation Cavity; 1319a, Contact Opening; 1319b; Third Limiting Portion; 132, Second Connecting Frame; 1321, First Housing; 1322, Second Housing; 1323, First Receiving Cavity; 1324, First End; 1325, Second End; 1326, First Groove; 1327, Opening; 133, Linking Rod; 1331, First Linking End; 1332, Second Linking End; 134, Rotating Base; 1341, Second Wedge-Shaped End Surface; 140, First Locking Component; 141, Locking Pin; 142, Locking Hook; 1421, Engaging Hook; 1422, Second Connecting Portion; 1423, Third Accommodation Cavity; 1424, Guide Slope; 143, First Reset Member; 150, Unlocking Component; 151, First Pushing Rod; 1511, Pushing rod Body; 1512, Pushing Portion; 152, Driving Handle; 1521, Cam Portion; 1522, Handle Portion; 153, Second Reset Member; 170, Pushing rod Mounting Base; 171, First Mounting Groove; 172, First Locking Hole; 180, Seat Assembly; 181, Guide boss; 1811, Guide Hole; R1, First Rotating Shaft R2, Second Rotating Shaft R3, Third Rotating Shaft R4, Fourth Rotating Shaft,
20, Wheel Assembly; 200, Backrest Assembly; 210, Backrest Body; 211, Mounting Member; 2111, First Pivot Shaft; 2112, Second Pivot Shaft; 2113, First Annular Mounting Groove; 212, First Pushing Member; 2121, Unlocking Opening; 213, First Backrest Housing; 214, Second Backrest Housing; 215a, Pivot Hole; 215b, First Side Surface; 217a, Sixth Accommodation Cavity; 217b, Seventh Accommodation Cavity; 217c, Insertion Opening; 218a, Third Via Hole; 218b, Fourth Via Hole; 219a, First Cavity Wall; 219b, Second Cavity Wall; 220, Mounting Base; 221, First Locking Groove; 222, Second Pivot Portion; 222a, Second Mounting Groove; 222b, Second Side Surface; 230, Handlebar Assembly 231, Support Base; 232, First Handlebar; 2000, Footrest Device; 2100, Support Member; 2110, First End Surface; 2120, Second End Surface; 2130, Third Connecting Portion; 2140, Fourth Connecting Portion; 2150, First Pivot Portion; 2160, Support Body; 2200, Connecting Member; 2210, Fixing Portion; 2300, Footrest Component; 2310, First Footrest; 2320, Second Footrest; 2321, First Holding Portion; 2322, First Fitting Ring; 2323, First Internal Gear Portion; 233, Second Handlebar; 2330, Footrest Body; 2330a, First Insertion Groove; 2331, Second Holding Portion; 2332, Second Fitting Ring; 2333, Second Internal Gear Portion; 234, First Synchronization Mechanism; 2340, First Pin Shaft; 2340a, Fourth Locking Groove; 2341, First External Gear; 2342, Second External Gear; 235, Locking Mechanism; 2351, Pushing button; 2352, Pushing button Reset Member; 2353, First Pulling Member; 236, Support Body; 237, Third Cover; 2371, First Operating Hole; 238, Fourth Cover; 240, Fixed Base; 241, Engagement Portion; 2410, Third Pivot Shaft; 242, Mounting Boss; 2420, Fourth Pivot Shaft; 2421, Accommodating Groove, 243, Rotating Shaft; 250, Connecting Base; 2500, Fixing Component; 251, Third Housing; 2510, First Magnetic Member; 2511, Through Hole; 2512, First Pivot Base; 2513, Second Pivot Base; 252, Fourth Housing; 2520, Second Magnetic Member; 2521, First Housing Portion; 2522, Second Housing Portion; 2523, Second Operating Hole; 2524, Mounting Opening; 2525, First Edge; 2526, Second Edge; 2527, Guide Groove; 2528, Guide Rib; 2529, Insertion Opening; 2600, Second Synchronization Mechanism; 261, Fourth Accommodation Cavity; 2610, Third Driving Member; 2610a, First Gear Tooth Portion; 262, Fifth Accommodation Cavity; 2620, Fourth Driving Member; 2620a, Second Gear Tooth Portion; 270, Second Positioning Mechanism; 271, Third Positioning Recess; 272, Fourth Positioning Recess; 273, Second Positioning Protrusion; 274, Positioning Reset Member; 280, Fastener; 290, Second Fixing Mechanism; 291, Fifth Locking Member; 291a, Fifth Locking Hole; 292, Locking Reset Member,
30, Front Wheel; 300, Armrest Assembly; 3000, Pedal Device; 310, Armrest Body; 3100, Pedal Component; 3110, Pedal Body; 3110a, Second Insertion Groove; 3120, Second Pin Shaft; 3120a, Five Locking Groove; 320, First Armrest Rod; 3200, Pedal Base; 321, Second Locking Groove; 3210, Fifth Housing; 3210a, Fourth Receiving Groove; 3210b, Receiving Boss; 3210c, Fourth Receiving Cavity; 3210d, Insertion Hole; 3210e, Fourth Limiting Portion; 3210f, First Groove Wall; 3210g, Second Groove Wall; 322, Third Locking Groove; 3220, Sixth Housing; 3220a, Third Operating Hole; 3220b, Mounting Hole; 323, Positioning Groove; 330, Second Armrest Rod; 3300, Third Fixing Mechanism; 331, Third Operating Member; 331a, Operating Portion; 331b, Fifth Limiting Portion; 332, Operating Reset Member; 334, Sixth Locking Member; 334a, The Sixth Locking Hole,
40, Rear Wheel,
510, Sunshade; 511, Second Pushing rod; 5111, Engagement End; 5112, Moving Groove; 5113, Second Pushing Member; 512, Locking Rod; 5121, First Rod; 5122, Second Rod; 513, Unlocking Operating Member; 5131, Connecting Rod; 5132, Blocking Plate; 5133, Pressing Block; 514, First Locking Portion; 515, Second Locking Portion; 516, Third Locking Portion,
600, Lighting Assembly; 610, Reflector; 620, LED Component; 630, Lamp Holder,
700, Adjustment Mechanism; 710, Second Locking Component; 711, Limiting Hole; 712, Limiting Pin; 720, Operating Component; 721, Unlocking Member; 722, Second Pulling Member; 723, Seventh Reset Member; 724, Third Pushing Member;
800, First Fixing Mechanism; 810, First Locking Member; 811, First Locking Protrusion; 812, First Driving Pin; 813, Second Groove; 820, First Driving Member; 821, First Driving Groove; 830, First Operating Member; 840, Third Reset Member; 8100, First Locking Mechanism; 8110, Third Locking Member; 8111, First Operating End; 8112, First Locking End; 8120, Third Locking Hole; 8130, Sixth Reset Member; 8200, Second Locking Mechanism; 8210, Fourth Locking Member; 8211, Second Operating End; 8212, Second Locking End; 8220, Fourth Locking Hole; 8230, Pivot Pin; 8240, Eighth Reset Member,
900, Pushing Assembly; 910, First Connecting Rod; 911, Second Receiving Cavity; 912, Second Locking Hole; 913, First Via Hole; 920, Second Connecting Rod; 921, Third Receiving Cavity; 922, Second Via Hole; 930, Length Adjustment Mechanism; 931, Second Locking Member; 9311, Second Movable Connecting Portion; 9312, Second Locking Portion; 9313, Third Driving Pin; 932, Second Driving Member; 9321, Operating Connecting Portion; 9322, Driving Connecting Portion; 9323, Second Driving Groove; 9324, Third Driving Groove; 9325, Abutting Portion; 933, Second Operating Member; 9331, Second Driving Pin; 934, Fourth Reset Member; 935, Guide Base; 9351, First Receiving Groove; 9352, Second Receiving Groove; 9353, Elongated hole; 9354, Third Receiving Groove; 940, Locking Mounting Base; 950, Push Handle; 960, Abutting Member; D1, Moving Direction Of The Second Operating Member; D2, Extending Direction Of The Second Driving Groove; D3, Moving Direction Of The Second Driving Member; D4, Extending Direction Of The Third Driving Groove; D5, Moving Direction Of The Second Locking Member; 9000, First Positioning Mechanism; 9100, First Positioning Recess; 9200, Second Positioning Recess; 9300, First Positioning Protrusion; 9400, Fifth Reset Member; M1, First Pivot Point; N1, Second Pivot Point.

### DETAILED DESCRIPTION OF EMBODIMENTS

In order to facilitate understanding of the present application, the present application will be described more fully below with reference to the relevant drawings. Preferred embodiments of the present application are shown in the drawings. However, the present application may be embodied in many different forms and is not limited to the embodiments described herein. Rather, these embodiments are provided so that the disclosure of the present application will be thorough and complete.

It should be noted that when an element is referred to as “connected to” another element, it can be directly connected to and integrated with the other element, or intermediate elements may also be present. The terms “mounting”, “one end”, “another end”, and similar expressions used herein are for illustrative purposes only.

Unless otherwise defined, all technical and scientific terms used herein have the same meaning as commonly understood by one of ordinary skill in the technical field to which the present application belongs. The terminology used herein in the description of the present application is for the purpose of describing specific embodiments only and is not intended to limit the present application. As used herein, the term “and/or” includes any and all combinations of one or more of the associated listed items.

In order to make the purpose, technical solutions and advantages of the present application clearer, the present application will be further described in detail below with reference to the drawings and embodiments. It should be understood that the specific embodiments described herein are only used to explain the present application and are not used to limit the present application.

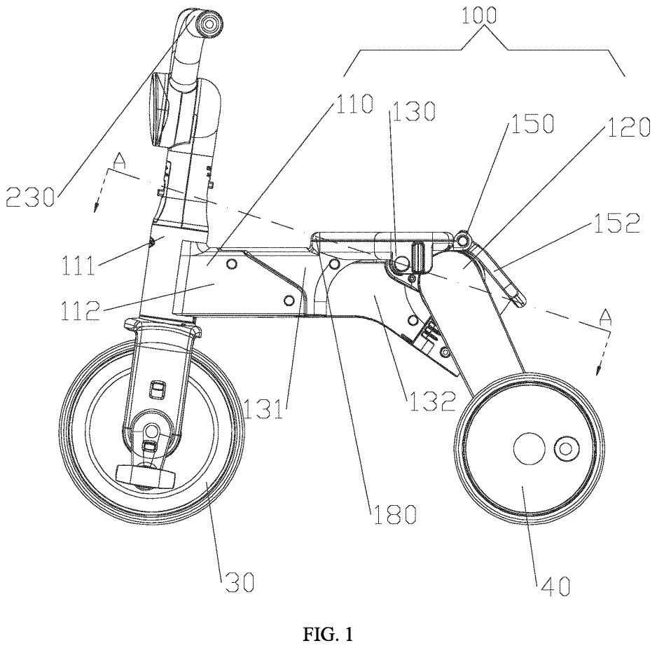

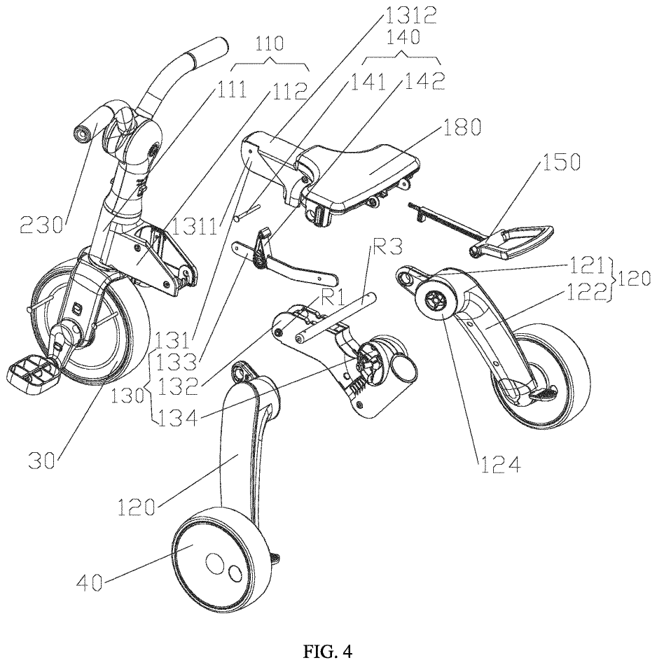

An embodiment of the present application provides a child carrier, which may be, for example, a child tricycle, a child balance car, a child bike, or a child bicycle. As shown in FIGS. 1 to 3, the child carrier includes a frame 100, a front wheel 30, two rear wheels 40, a handlebar assembly 230, and a seat assembly 180. The handlebar assembly 230 is generally disposed on the front and upper side of the frame 100 or the seat assembly 180. The front wheel 30 is generally disposed on the front and lower side of the frame 100 or the seat assembly 180. The two rear wheels 40 are generally disposed on the rear and lower side of the frame 100 or the seat assembly 180. The handlebar assembly 230 is adjustable in height, and the adjustment process is convenient. The frame 100 has an unfolded state and a folded state. The frame 100 includes a first frame 110, a second frame 120, a linkage mechanism 130, a first locking component 140 (see FIG. 4) and an unlocking component 150.

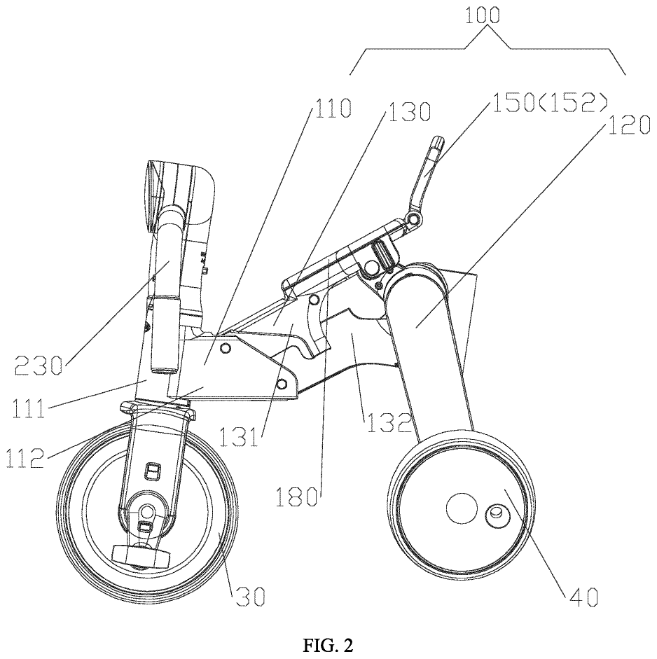

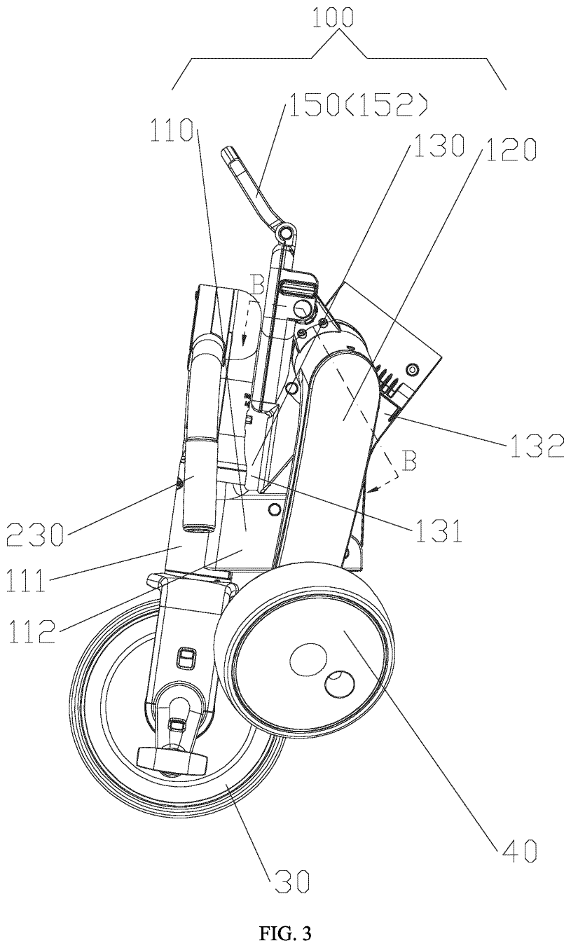

As shown in FIG. 4, the first frame 110 includes a connecting rod member 111 and a first connecting portion 112 connected to the connecting rod member 111. Both ends of the connecting rod member 111 are connected to the front wheel 30 and the handlebar assembly 230, respectively. The first connecting portion 112 is rotatably connected to the linkage mechanism 130. The second frame 120 is connected to the rear wheels 40 and is rotatably connected to the linkage mechanism 130. When the frame 100 is switched from the unfolded state shown in FIG. 1 to a semi-folded state shown in FIG. 2, and then to the folded state shown in FIG. 3, the first frame 110 and the second frame 120 approach each other. The rear wheels 40 and the front wheel 30 approach each other.

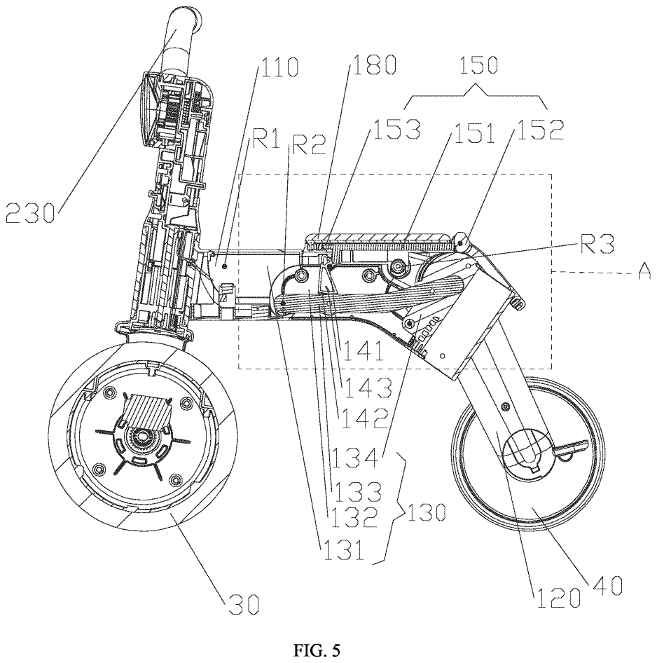

As shown in FIG. 4, the linkage mechanism 130 includes a first connecting frame 131, a second connecting frame 132, a linking rod 133, and a rotating base 134. Referring to FIG. 5, the first connecting frame 131 is rotatably connected to the first frame 110 through a first rotating shaft R1, the second connecting frame 132 is rotatably connected to the first frame 110 through a second rotating shaft R2, and the first connecting frame 131 is rotatably connected to the second frame 120 through a third rotating shaft R3. In this embodiment, the first rotating shaft R1, the second rotating shaft R2, and the third rotating shaft R3 are all arranged substantially horizontally in a left-right directions of the frame 100. The first rotating shaft R1 is adjacent to the front of the frame 100, that is, adjacent to the handlebar assembly 230. The third rotating shaft R3 is adjacent to the rear of the frame 100, that is, away from the handlebar assembly 230. The second rotating shaft R2 is located between the first rotating shaft R1 and the third rotating shaft R3.

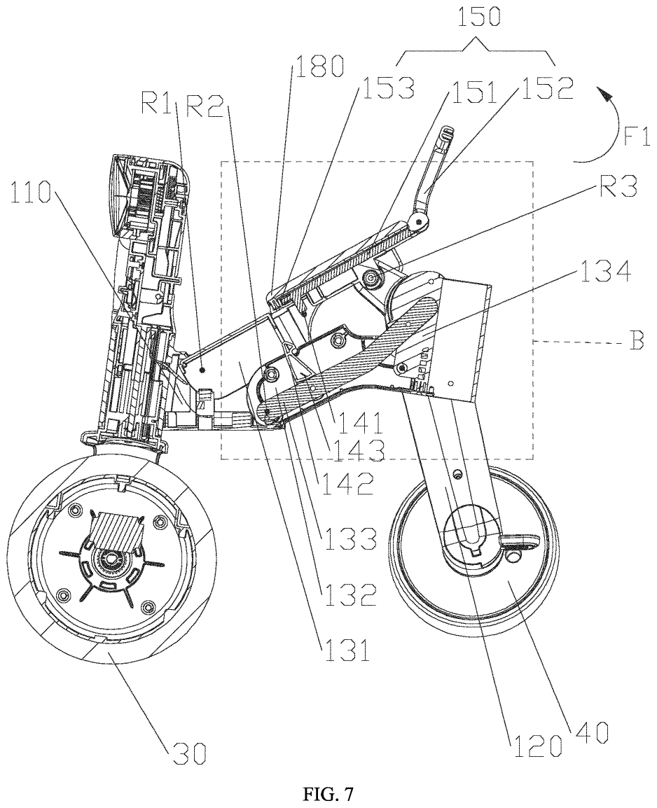

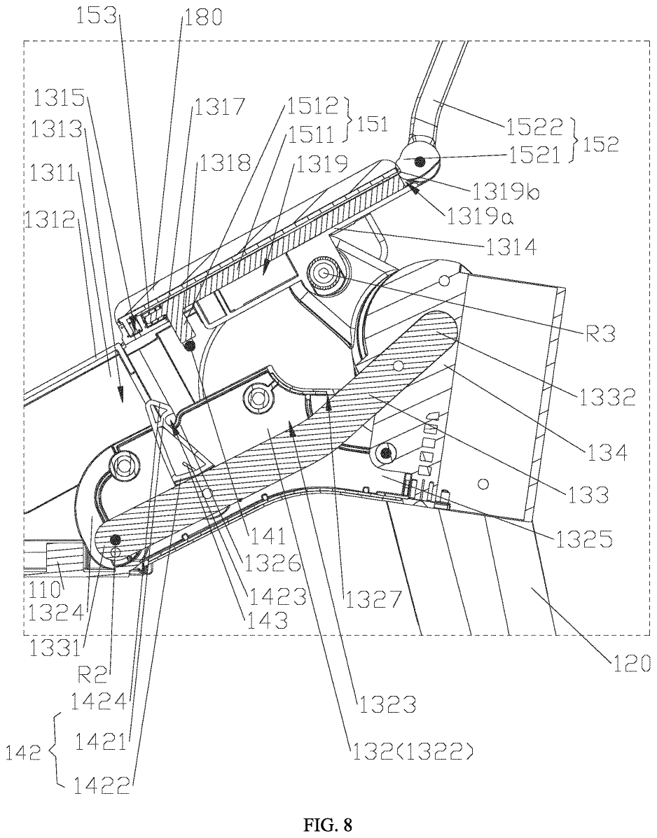

As shown in FIGS. 4 to 6, the first connecting frame 131 includes two opposite side plates 1311, and a connecting plate 1312 connected between the side plates 1311. The two side plates 1311 and the connecting plate 1312 enclose a first accommodation cavity 1313. In this embodiment, the first connecting frame 131 is integrally formed, so that the first connecting frame 131 has higher strength and can bear greater weight. In other embodiments, the first connecting frame 131 can also be formed by connecting the two side plates 1311 and the connecting plate 1312 that are independent of each other by welding, riveting, etc. In order to enhance the strength of the first connecting frame 131, a reinforcing rib (not shown in figures) may be disposed between the two side plates 1311. The first connecting frame 131 may be provided with a seat connecting portion 1314. The seat connecting portion 1314 is provided with an engaging groove 1315. A part of the seat assembly 180 is inserted into the engaging groove 1315 and is fixedly connected to the seat connecting portion 1314. The seat assembly 180 and the seat connecting portion 1314 encloses a second accommodation cavity 1319. The second accommodation cavity 1319 is in communication with the first accommodation cavity 1313. Alternatively, the second accommodation cavity 1319 may also be merely disposed on the seat connecting portion 1314. As shown in FIGS. 7 and 8, the first frame 110 is rotatably connected to the two side plates 1311 of the first connecting frame 131 through the first rotating shaft R1.

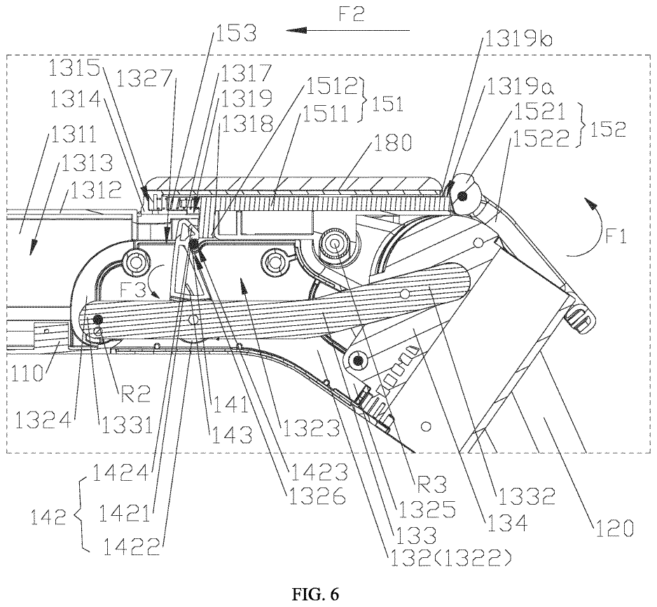

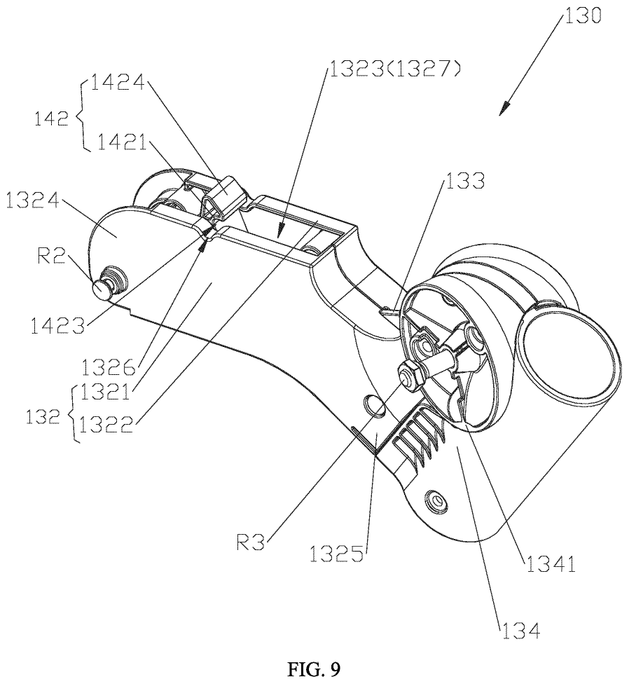

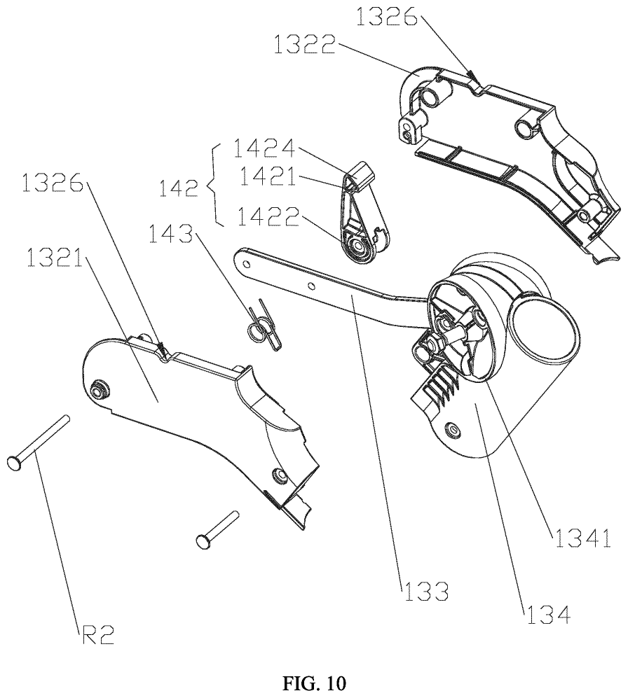

As shown in FIGS. 9 and 10, the second connecting frame 132 includes a first housing 1321 and a second housing 1322. The first housing 1321 and the second housing 1322 enclose a first receiving cavity 1323. Referring to FIGS. 6 and 8, at least a part of the second connecting frame 132 extends into the first accommodation cavity 1313. The second connecting frame 132 has a first end 1324 and a second end 1325. The first end 1324 of the second connecting frame 132 is rotatably connected to the first frame 110 through the second rotating shaft R2, and the second end 1325 of the second connecting frame 132 is connected to the rotating base 134.

As shown in FIGS. 5 and 6, when the frame 100 is in the unfolded state, the second connecting frame 132 is located below the connecting plate 1312 on the top of the first connecting frame 131. The second connecting frame 132, the first connecting frame 131, and the first frame 110 form a relatively smooth outer peripheral surface, making the overall appearance of the frame 100 more concise and aesthetic. It should be noted that the descriptions related to directions such as up, down, left, right, front, and rear mentioned in this application are all made relative to the unfolded state of the frame 100 (see FIG. 1).

As shown in FIGS. 5 and 6, the linking rod 133 includes a first linking end 1331 and a second linking end 1332. The first linking end 1331 is disposed in the first receiving cavity 1323. The second rotating shaft R2 extends through the first frame 110, the second connecting frame 132, and the first linking end 1331 to pivotally connect the second connecting frame 132, the linking rod 133, and the first frame 1331 coaxially. The second linking end 1332 is located outside the first receiving cavity 1323 and is rotatably connected to the rotating base 134. In this embodiment, connection points between the second linking end 1332 and the rotating base 134 are offset from connection points between the second connecting frame 132 and the rotating base 134, so that the second connecting frame 132, the linking rod 133, and the rotating base 134 are connected to one another to substantially form a relatively fixed triangular. In other embodiments, the linking rod 133 may be omitted. For example, the second connecting frame 132 and the rotating base 134 are fixedly connected through a plurality of pin shafts to limit the rotation therebetween.

As shown in FIGS. 4 and 5, the first locking component 140 includes a locking pin 141, a locking hook 142, and a first reset member 143. In an embodiment, the locking pin 141 is connected to the first connecting frame 131. Specifically, referring to FIG. 6, the locking pin 141 is at least connected to the side plate 1311 on one of the sides of the first connecting frame 131, and at least a part of the locking pin 141 is located in the first accommodation cavity 1313. In this embodiment, two ends of the locking pin 141 are connected to the two side plates 1311 of the first connecting frame 131, respectively. Referring to FIGS. 6 and 8, the locking hook 142 includes an engaging hook 1421, a second connecting portion 1422, and a guide slope 1424. The second connecting portion 1422 is located in the first receiving cavity 1323 and is pivotally connected to the linking rod 133.

As shown in FIGS. 6 and 9, the second connecting frame 132 is further provided with an opening 1327 in communication with the first receiving cavity 1323. The engaging hook 1421 can pass through the opening 1327 and extend out of the first receiving cavity 1323. The engaging hook 1421 can rotate relative to the second connecting frame 132 and can be engaged with the locking pin 141 to limit the relative rotation of the first frame 110 and the second frame 120. When the engaging hook 1421 rotates to abut against a sidewall of the opening 1327, the locking hook 142 cannot continue to rotate in the current rotation direction. Therefore, a rotation range of the locking hook 142 is limited by adjusting a size and a position of the opening 1327.

As shown in FIGS. 6 and 9, the second connecting frame 132 is provided with a first groove 1326. The first groove 1326 is disposed at the edge of the opening 1327. The engaging hook 1421 and the first groove 1326 can enclose a third accommodation cavity 1423. The locking pin 141 can extend through the third accommodation cavity 1423. The guide slope 1424 is provided adjacent to the engaging hook 1421. As shown in FIGS. 7 and 8, when the second frame 120 is switched from the folded state to the unfolded state, the locking pin 141 moves toward the engaging hook 1421 along with the first connecting frame 131, and the locking pin 141 pushes the guide slope 1424 and drive the locking hook 142 to rotate, so that the locking pin 141 enters the third accommodation cavity 1423 and locks the second frame 120 in the unfolded state, as shown in FIGS. 5 and 6. The first reset member 143 is disposed between the locking hook 142 and the linking rod 133. The first reset member 143 biases the locking hook 142 to rotate to be engaged with the locking pin 141. The first reset member 143 may be an elastic member such as a torsion spring, an elastic piece, a tension spring, or a compression spring. In this embodiment, the first reset member 143 is a torsion spring.

As shown in FIGS. 6 and 8, the unlocking component 150 includes a first pushing rod 151, a driving handle 152, and a second reset member 153. The first pushing rod 151 is movably disposed on the first connecting frame 131. The first pushing rod 151 includes a pushing rod body 1511 and a pushing portion 1512 fixed on the pushing rod body 1511. The pushing rod body 1511 is rod-shaped. The pushing rod body 1511 is at least partially movably disposed in the second accommodation cavity 1319. A first end of the pushing rod body 1511 abuts against the second reset member 153, and a second end extends out of the second accommodation cavity 1319 and can abut against the driving handle 152. The pushing portion 1512 is connected to a surface of the pushing rod body 1511 facing the locking hook 142 and the locking pin 141. That is, when the child carrier is in the unfolded state, the pushing portion 1512 is located below the pushing rod body 1511 and located above the locking pin 141. The seat connecting portion 1314 is further provided with a first limiting portion 1317 and a second limiting portion 1318. The pushing portion 1512 is located between the first limiting portion 1317 and the second limiting portion 1318, and can move between the first limiting portion 1317 and the second limiting portion 1318. The pushing portion 1512 at least partially extends into the second accommodation cavity 1319. The pushing portion 1512 can move with the pushing rod body 1511 and push the locking hook 142 to rotate to unlock the engagement between the locking hook 142 and the locking pin 141, so that the first frame 110 and the second frame 120 can approach each other. In this embodiment, the first pushing rod 151 is integrally formed. In other embodiments, the first pushing rod 151 can also be formed by connecting the pushing rod body 1511 and the pushing portion 1512 that are independent of each other by soldering, welding, etc.

Continuing to refer to FIGS. 6 and 8, the driving handle 152 is rotatably connected to the first connecting frame 131 and abuts against the first pushing rod 151. Specifically, the driving handle 152 includes a cam portion 1521 and a handle portion 1522 connected to the cam portion 1521. The cam portion 1521 is rotatably connected to the first connecting frame 131 and can abut against the first pushing rod 151. Specifically, one end of the second accommodation cavity 1319 has a contact opening 1319a, and an end of the first pushing rod 151 away from the second reset member 153 can abut against the cam portion 1521 through the contact opening 1319a. A third limiting portion 1319b is formed by a wall of the contact opening 1319a. The third limiting portion 1319b can abut against the cam portion 1521 to limit the rotation angle of the cam portion 1521. When the driving handle 152 rotates, the cam portion 1521 drives the pushing rod body 1511 to move, so that the pushing portion 1512 pushes the locking hook 142 to rotate, so as to release the engagement between the locking hook 142 and the locking pin 141. Then, the driving handle 152 continues to push the third limiting portion 1319b to rotate and drive the first connecting frame 131 to rotate and fold relative to the first frame 110. The handle portion 1522 can not only facilitate the user to rotate the driving handle 152, but also can be used to lift the folded frame 100 (see FIG. 3). In other embodiments, the driving handle 152 may be omitted. For example, the first pushing rod 151 may be directly manually pushed to drive the locking hook 142 to rotate. The second reset member 153 may be an elastic member such as a spring, or an elastic piece. In this embodiment, the second reset member 153 is a spring. The second reset member 153 is disposed between the first connecting frame 131 and the first pushing rod 151. Specifically, the second reset member 153 is disposed in the first accommodation cavity 1313. One end of the second reset member 153 abuts against a wall of the first accommodation cavity 1313, and another end of the second reset member 153 abuts against the first pushing rod 151. The second reset member 153 biases the pushing portion 1512 to move in a direction away from the locking hook 142.

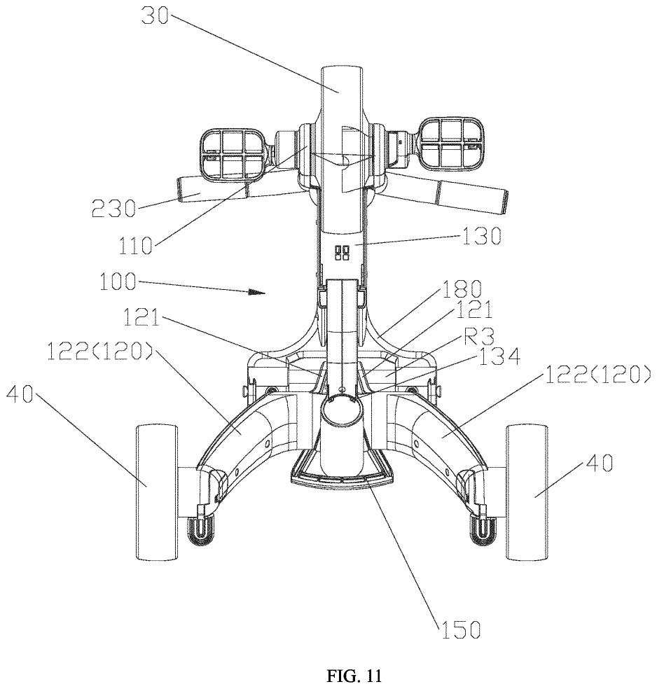

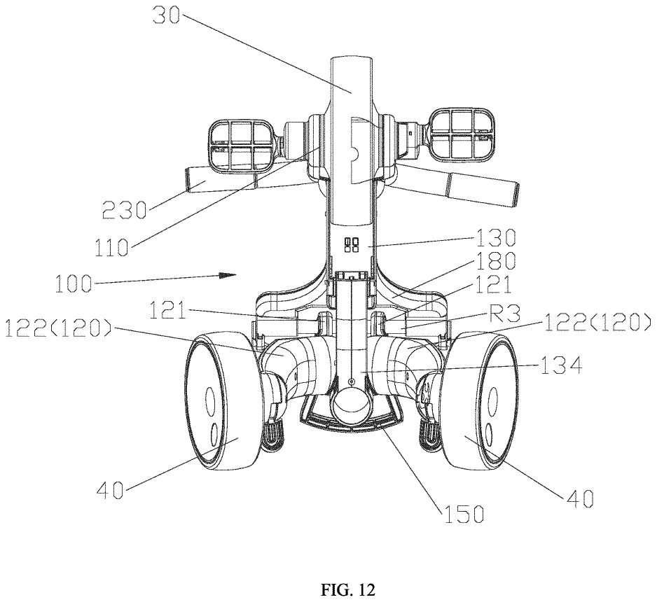

As shown in FIGS. 11 and 12, in this embodiment, two second frames 120 are provided. The two second frames 120 are respectively disposed on both sides of the linkage mechanism 130, and are rotatably connected to the linkage mechanism 130, respectively. When the frame 100 is switched from the unfolded state to the folded state, the two rear wheels 40 move to approach each other. In other embodiments, one or more than two second frames 120 may be provided. The number of the second frames 120 is not limited in this application, as long as the second frames 120 can be folded through the linkage mechanism 130.

Specifically, the second frame 120 on one of the sides will be described for illustration.

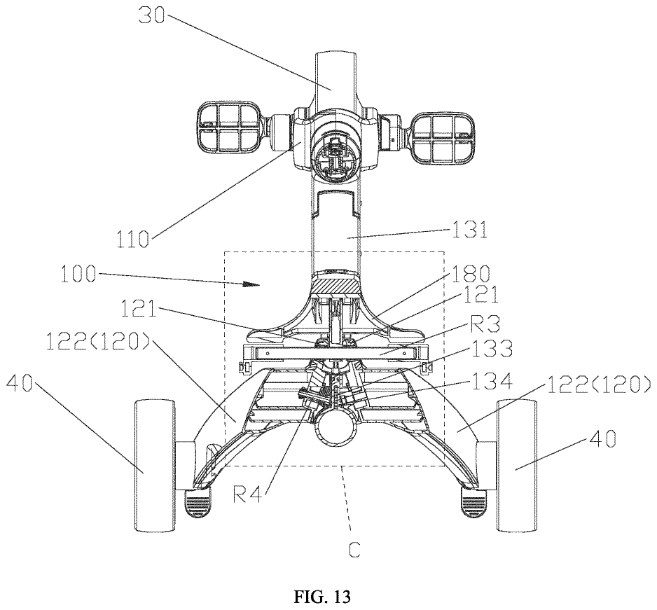

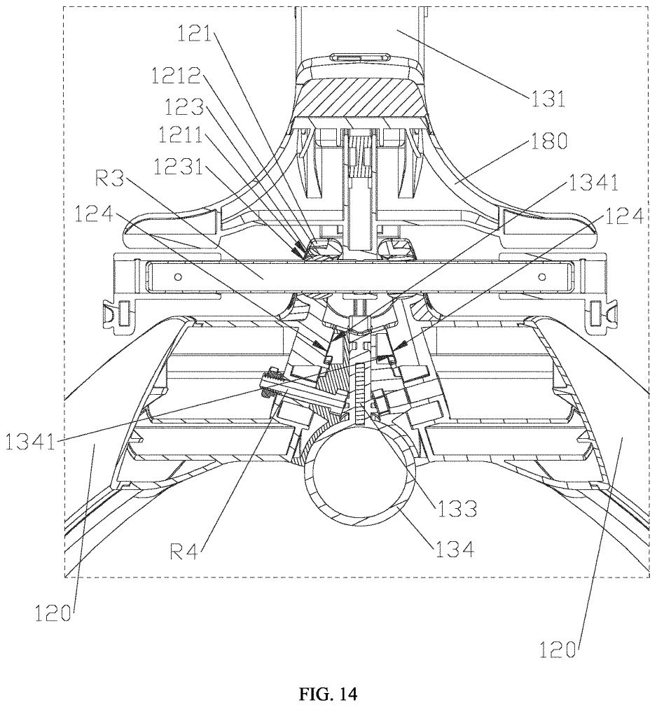

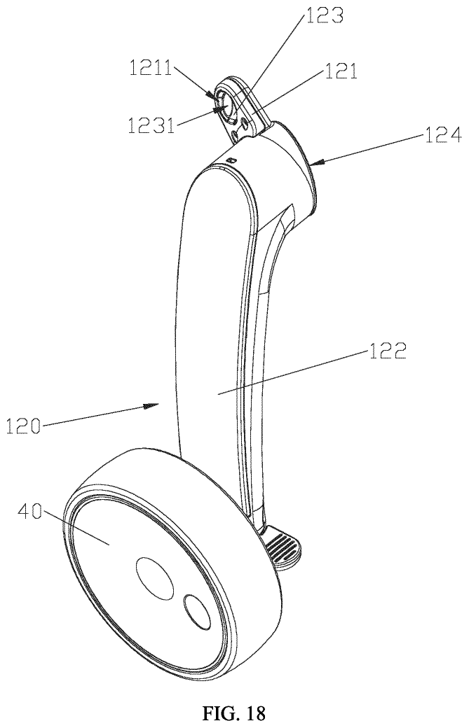

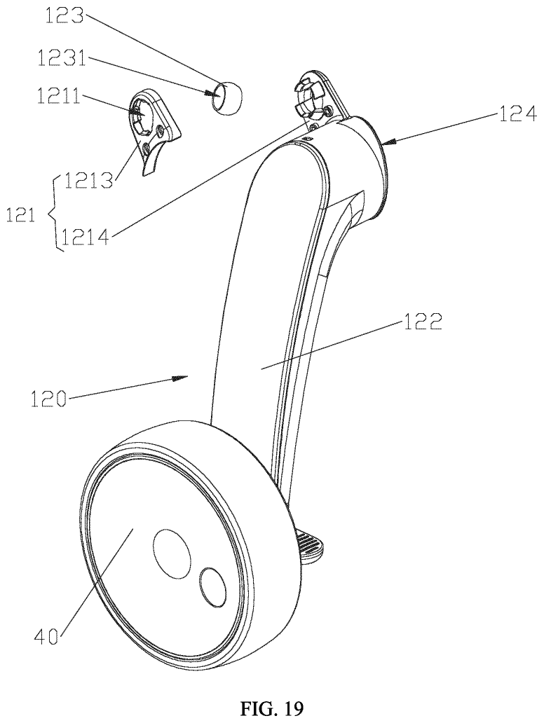

As shown in FIGS. 13 and 14, the second frame 120 includes a first movable connecting portion 121 and a rear wheel connecting portion 122. One end of the rear wheel connecting portion 122 is connected to the first movable connecting portion 121, and another end of the rear wheel connecting portion 122 is connected to the rear wheel 40. The first movable connecting portion 121 is rotatably connected to the first connecting frame 131 through the third rotating shaft R3. The third rotating shaft R3 is fixedly connected to the first connecting frame 131, and is located below the seat assembly 180. Referring to FIGS. 18 and 19, the first movable connecting portion 121 is provided with a first through hole 1211. A plane where an opening of the first through hole 1211 is located is arranged at an angle to the third rotating shaft R3, and is not perpendicular to the third rotating shaft R3. The third rotating shaft R3 extends through the first through hole 1211. When the third rotating shaft R3 rotates, the first movable connecting portion 121 can be driven to rotate relative to the third rotating shaft R3 and move along the third rotating shaft R3.

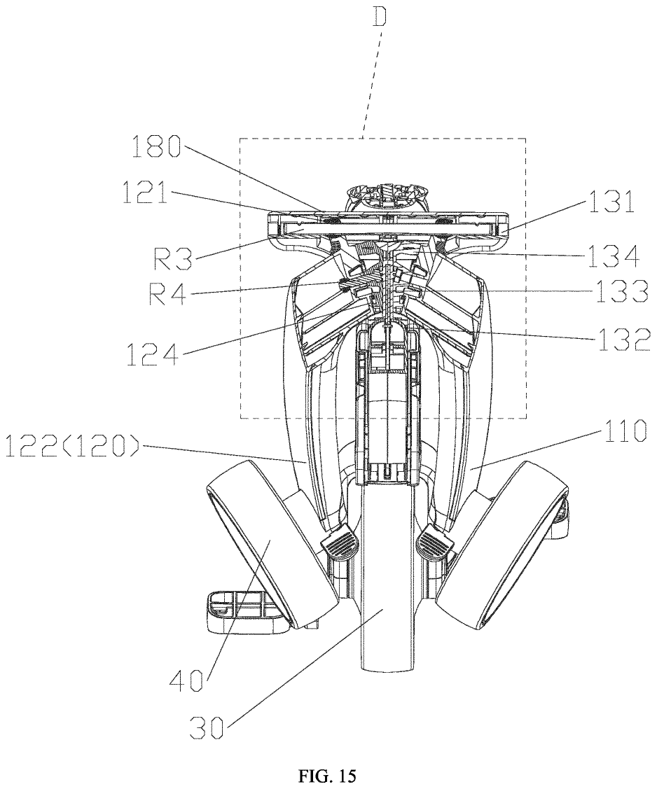

As shown in FIGS. 13 and 14, the second frame 120 is rotatably connected to the rotating base 134 through a fourth rotating shaft R4. An extending direction of the fourth rotating shaft R4 intersects and is not perpendicular to an extending direction of the third rotating shaft R3. When the first connecting frame 131 rotates and folds relative to the first frame 110, since the third rotating shaft R3 is fixed on the first connecting frame 131, the first movable connecting portion 121 and the third rotating shaft R3 can rotate relative to each other, so that the first movable connecting portion 121 is driven to move along the third rotating shaft R3, and at the same time the second frame 120 is driven to rotate around the fourth rotating shaft R4, thereby causing the rear wheels 40 connected to the second frame 120 to move toward each other, as shown in FIG. 13 and FIG. 15. That is, when the frame 100 is switched from the unfolded state to the folded state, the first movable connecting portion 121 of the second frame 120 rotates relative to the third rotating shaft R3, the first movable connecting portion 121 is driven to move along the third rotating shaft R3. Since the first movable connecting portion 121 is a part of the second frame 120 and is connected to the rear wheel connecting portion 122, the rear wheel connecting portion 122 of the second frame 120 is further driven to rotate around the fourth rotating shaft R4, so that the rear wheels 40 respectively connected to the two second frames 120 can move to approach each other. When the frame 100 is switched from the folded state to the unfolded state, a moving process of the second frame 120 is just the opposite of the switching process of the frame 100 from the unfolded state to the folded state as described above, and thus which will not be described again herein.

Further, referring to FIGS. 18 and 19, the first movable connecting portion 121 is provided with a universal ball 123. The universal ball 123 is provided with a second through hole 1231. Referring to FIG. 14, the third rotating shaft R3 extends through the second through hole 1231. A hole wall of the first through hole 1211 forms a ball base 1212 configured to receive at least a part of the universal ball 123. The ball base 1212 can rotate along a surface of the universal ball 123. Specifically, the first movable connecting portion 121 is enclosed by a first cover 1213 and a second cover 1214. The first cover 1213 and the second cover 1214 are removably connected. In the case when the universal ball 123 is omitted and the second frame 120 tilts and rotates around the fourth rotating shaft R4, due to a gap formed between the first through hole 1211 and the third rotating shaft R3, the first movable connecting portion 121 can swing in a radial direction of the third rotating shaft R3. Through the rotation of the universal ball 123 in the ball base 1212 with multiple degrees of freedom, when the first movable connecting portion 121 tilts and rotates around the third axis R3, the universal ball 123 can always fill the gap between the first through hole 1211 and the third rotating shaft R3, which can prevent the first movable connecting portion 121 from swinging in the radial direction of the third rotating shaft R3 when rotating around the third rotating shaft R3. With the above configuration, the second frame 120 can rotate and fold around the first connecting frame 131 more smoothly.

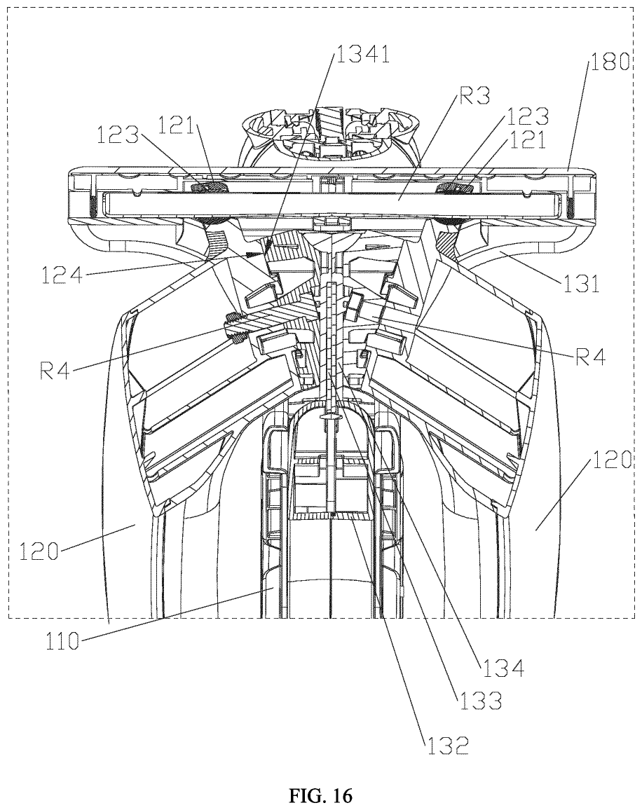

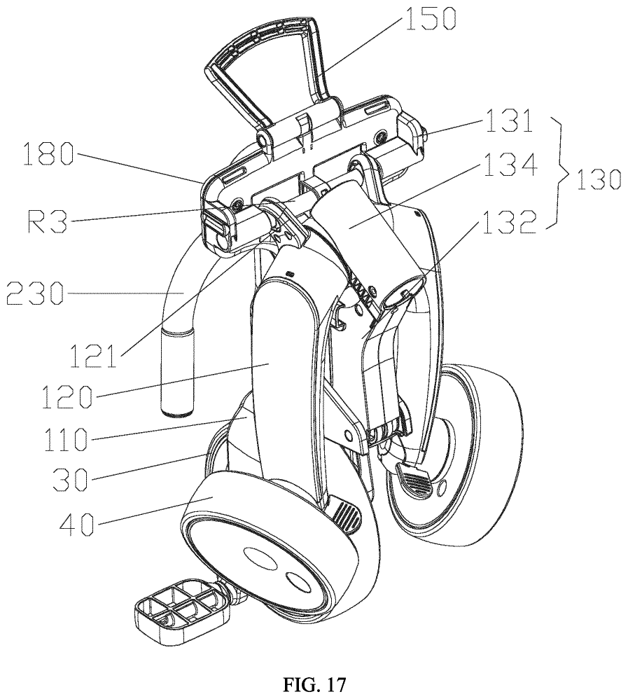

Continuing to refer to FIGS. 16 and 18, the second frame 120 includes a first wedge-shaped end surface 124. The first wedge-shaped end surface 124 is specifically disposed at a portion of the rear wheel connecting portion 122 adjacent to the rotating base 134. The rotating base 134 includes a second wedge-shaped end surface 1341. When the second frame 120 rotates relative to the rotating base 134 around the fourth rotating shaft R4, the first wedge-shaped end surface 124 movably abuts against the second wedge-shaped end surface 1341, so that the first wedge-shaped end surface 124 is kept in contact with the second wedge-shaped end surface 1341 when rotating relative to the second wedge-shaped end surface 1341. With the above configuration, the formation of a gap between the second frame 120 and the rotating base 134 can be avoided, thereby ensuring the smooth rotation of the second frame 120 relative to the rotating base 134, preventing foreign objects from being drawn into the gap, and preventing the user from being accidentally pinched. The fourth rotating shaft R4 is perpendicular to the first wedge-shaped end surface 124 (or the second wedge-shaped end surface 1341). In other embodiments, the first wedge-shaped end surface 124 and the second wedge-shaped end surface 1341 may be omitted.

The specific folding process of the above-mentioned frame 100 is as follows.

When the frame 100 is in the unfolded state as shown in FIGS. 5 and 6, the driving handle 152 is rotated in the direction F1 shown in FIG. 6, so that the cam portion 1521 pushes the first pushing rod 151 to move in the direction F2. In this way, the pushing portion 1512 of the first pushing rod 151 pushes the locking hook 142, causing the locking hook 142 to rotate in the direction F3 to release the engagement between the locking hook 142 and the locking pin 141, and the first locking component 140 is unlocked. As shown in FIGS. 7 and 8, the driving handle 152 then continues to rotate in the direction F1 to drive the first connecting frame 131 to rotate relative to the first frame 110, thereby driving the second connecting frame 132 to rotate relative to the first connecting frame 131, so that the second frame 120 rotates relative to the first connecting frame 131 and the second connecting frame 132, thereby causing the second frame 120 to move to approach the first frame 110.

Through the cooperation of the third rotating shaft R3 and the fourth rotating shaft R4, the first movable connecting portion 121 of the second frame 120 can rotate with the third rotating shaft R3 and move along the third rotating shaft R3, and enable the second frames 120 on the two sides of the rotating base 134 and the rear wheels 40 to approach to each other respectively, and finally be folded to the folded state as shown in FIG. 3.

The frame 100 of the child carrier of the present application is easy to be folded. When the frame 100 is in a fully folded state, the overall size of the child carrier can be minimized to facilitate carrying, storage, and transportation.

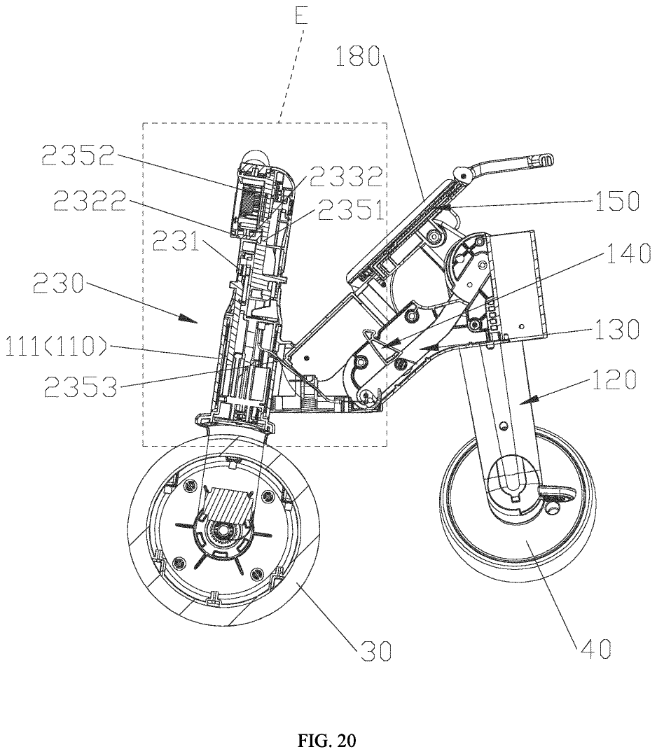

Further, as shown in FIGS. 20, 22 and 23, when the frame 100 is switched from the unfolded state to the folded state, the rotation of the second connecting frame 132 can also drive the handlebar assembly 230 to be switched from a locked state to an unlocked state through a first pulling member 2353, so that the handlebar assembly 230 can be folded together with the frame 100. The folding of the handlebar assembly 230 further reduces the size of the child carrier, making it easy to carry, store and transport.

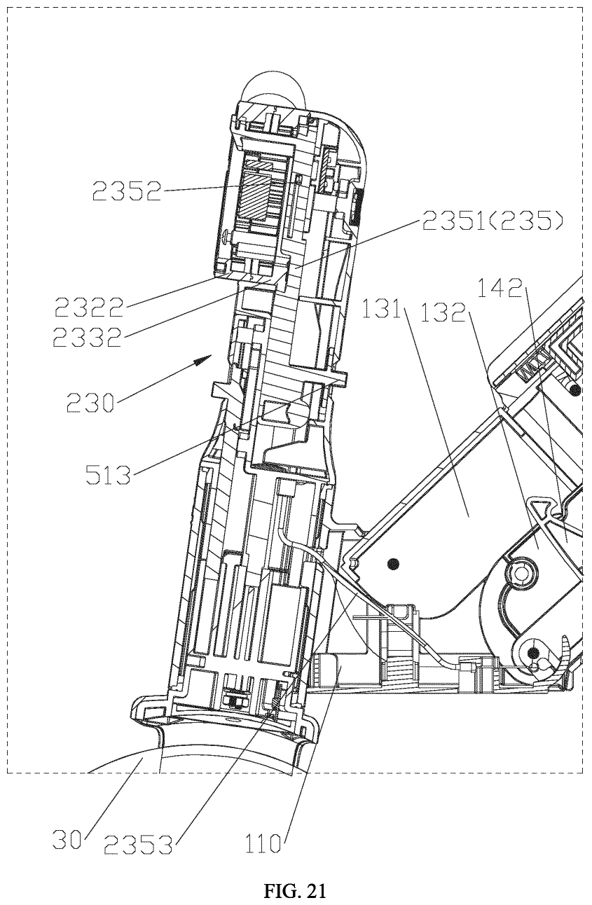

Specifically, as shown in FIGS. 20 to 22, the handlebar assembly 230 includes a support base 231, a first handlebar 232, a second handlebar 233, a first synchronization mechanism 234, and a locking mechanism 235. The locking mechanism 235 has a locked state and an unlocked state. The bottom of the support base 231 is fixed to the connecting rod member 111 of the first frame 110. The first handlebar 232 and the second handlebar 233 are disposed on the top of the support base 231. The first handlebar 232 and the second handlebar 233 are rotatable relative to the support base 231. The first handlebar 232 is an arc-shaped rod. Each of two ends of the arc-shaped rod have a first connecting section and a first holding portion 2321. In this embodiment, the first connecting section is a first fitting ring 2322. Similar to the first handlebar 232, the second handlebar 233 is also an arc-shaped rod and includes a second connecting section and a second holding portion 2331 at each of two ends of the arc-shaped rod. In this embodiment, the second connecting section is a second fitting ring 2332. The first synchronization mechanism 234 and the locking mechanism 235 are both disposed in the support base 231. In other embodiments, the handlebar assembly 230 may also include two or more handlebars of the first handlebar 232 and the second handlebar 233. For example, the handlebar assembly 230 may include three or more handlebars, or there may be only one handlebar, and which is not limited in this application.

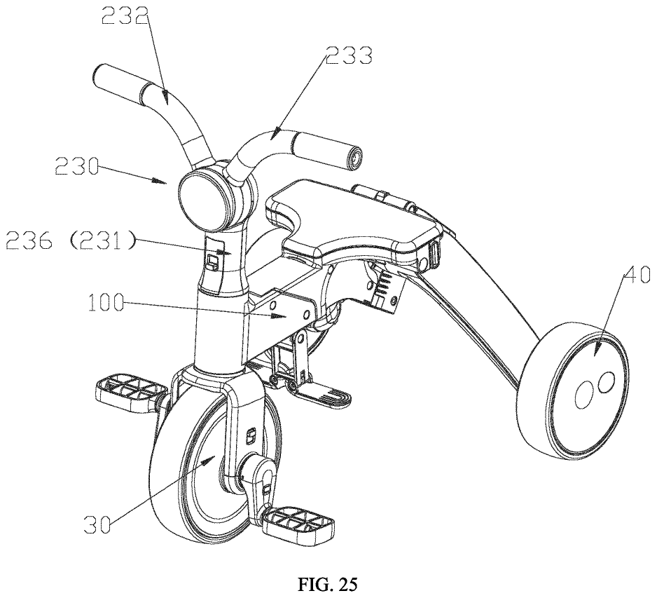

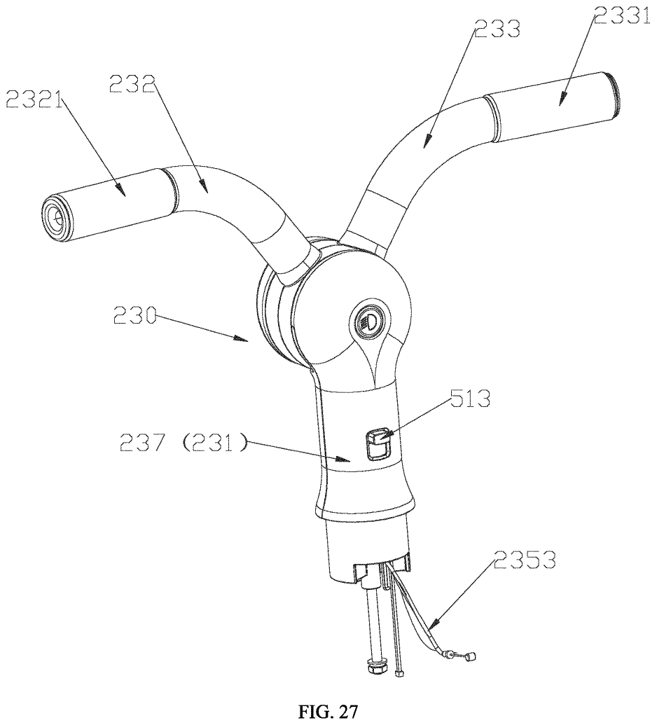

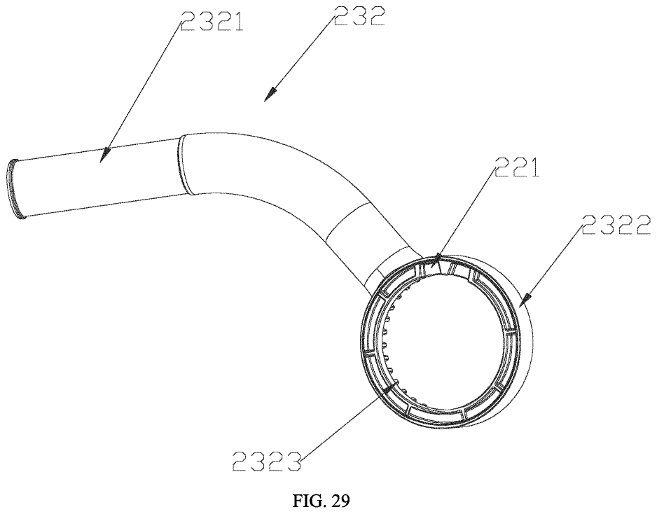

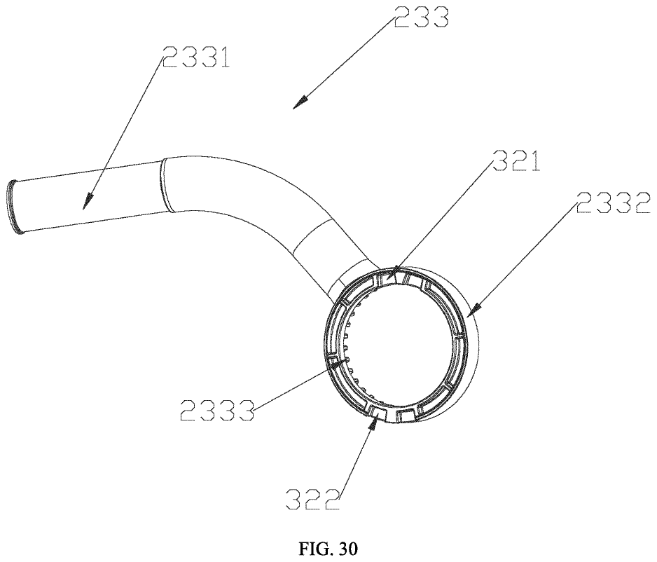

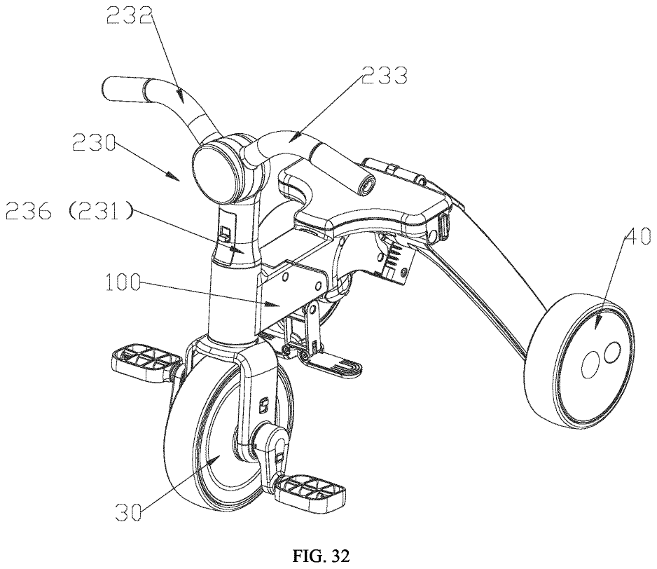

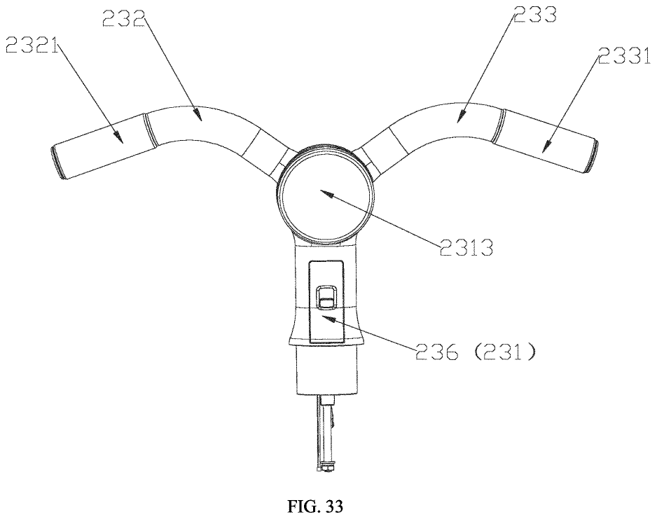

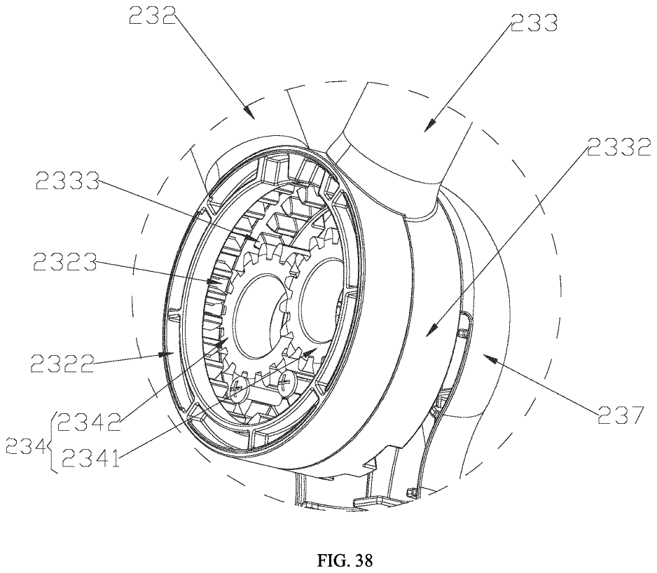

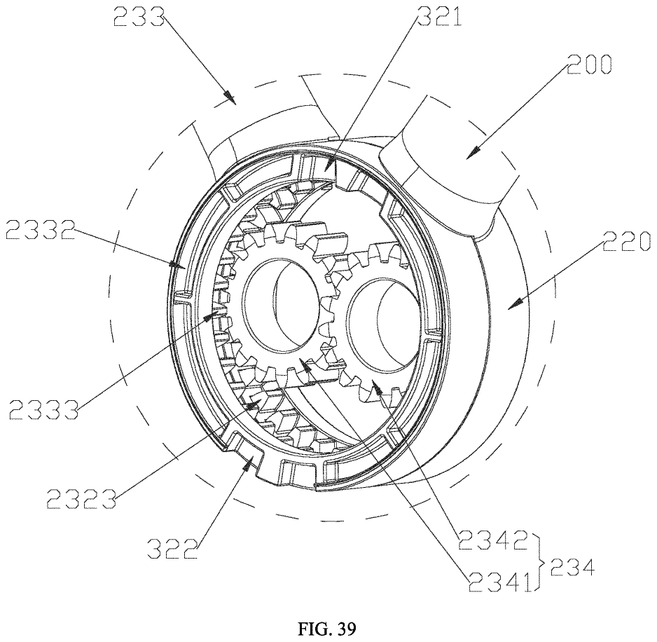

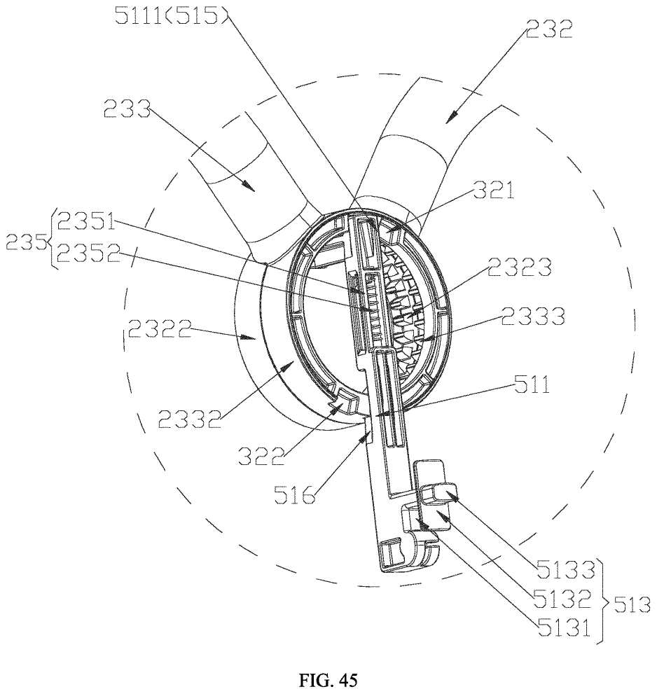

The specific configuration of the handlebar assembly 230 according to the present application will be described below with reference to FIGS. 25 to 47. Those skilled in the art will understand that although the child carrier shown in FIG. 25 is slightly different from the child carrier shown in FIG. 1 in configuration, the handlebar assembly 230 can be commonly used in the child carrier shown in FIG. 25 and the child carrier shown in FIG. 1. That is, the handlebar assembly 230 may be a detachable, independent assembly. As long as there is no technical contradiction, the handlebar assembly 230 may be applied to any child carrier other than those shown in FIGS. 1 and 25.

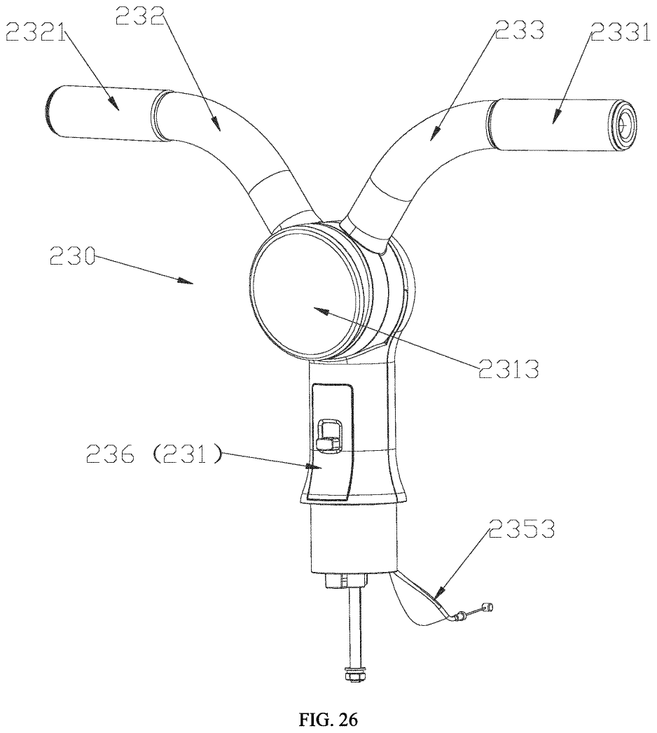

Specifically, as shown in FIGS. 26 to 28, the support base 231 has a generally columnar structure and is configured to be connected to the frame 100. Specifically, the support base 231 includes a support body 236, a third cover 237, and a fourth cover 238. The support body 236 and the third cover 237 are engaged with each other to form a first mounting cavity (not shown in figures). The bottom of the support body 236 is configured to be connected to the frame 100. A disk-shaped mounting member 211 is disposed on the top of the support body 236. The mounting member 211 has a generally annular structure. A first pivot shaft 2111 and a second pivot shaft 2112 are provided at an interval in a substantially middle portion of the mounting member 211. A surface of the mounting member 211 facing the third cover 237 is provided with a first annular mounting groove 2113, into which the first handlebar 232 is mounted. A surface of the mounting member 211 away from the third cover 237 is provided with a second annular mounting groove (not shown in figures), into which the second handlebar 233 is mounted. The second fitting ring 2332 of the second handlebar 233 and the first fitting ring 2322 of the first handlebar 232 are fastened to two surfaces of the mounting member 211, respectively. The fourth cover 238 is fastened to the first fitting ring 2322. In other embodiments, the handlebar assembly 230 may not include the first handlebar 232 and the second handlebar 233. The handlebar assembly 230 may include more than two handlebars as needed, or may include less than two handlebars.

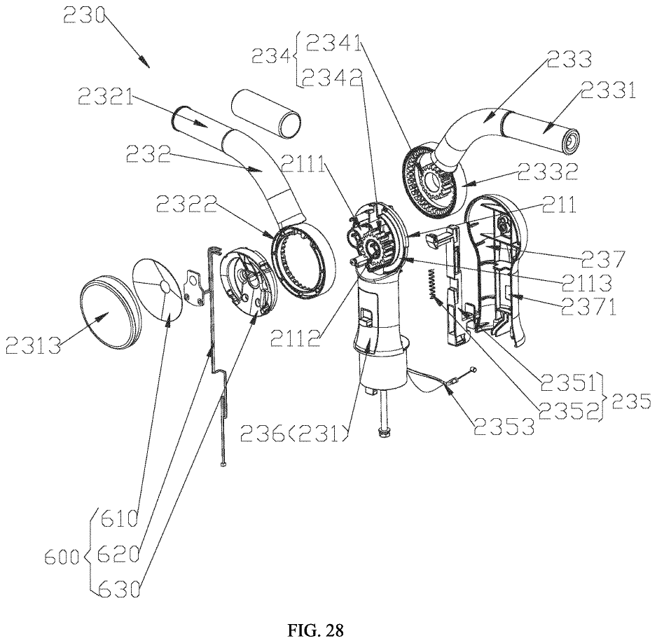

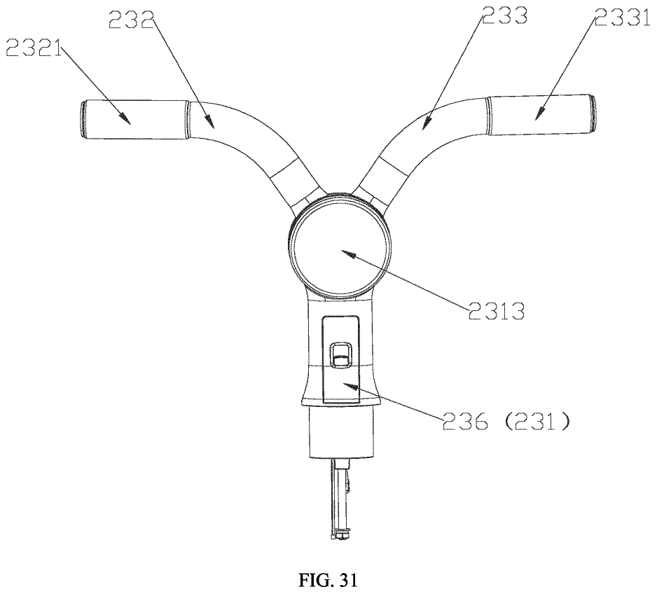

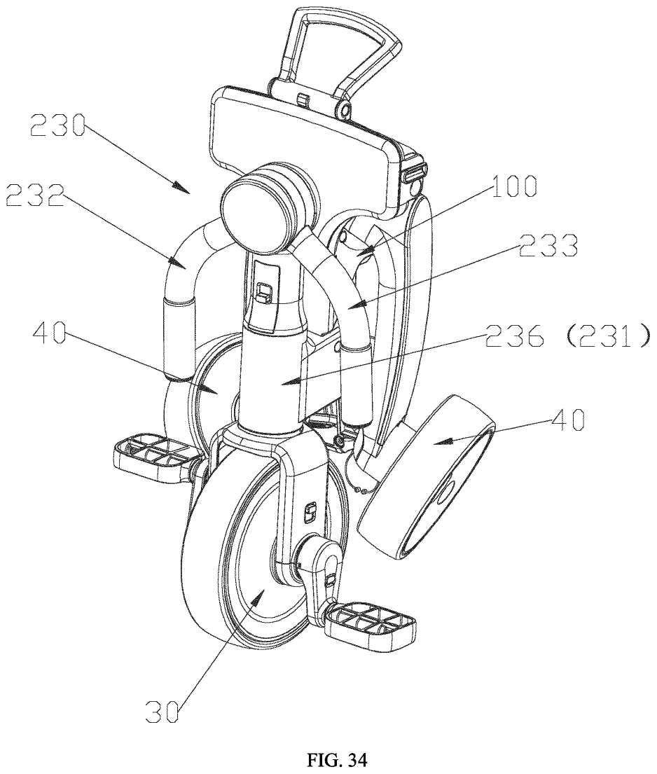

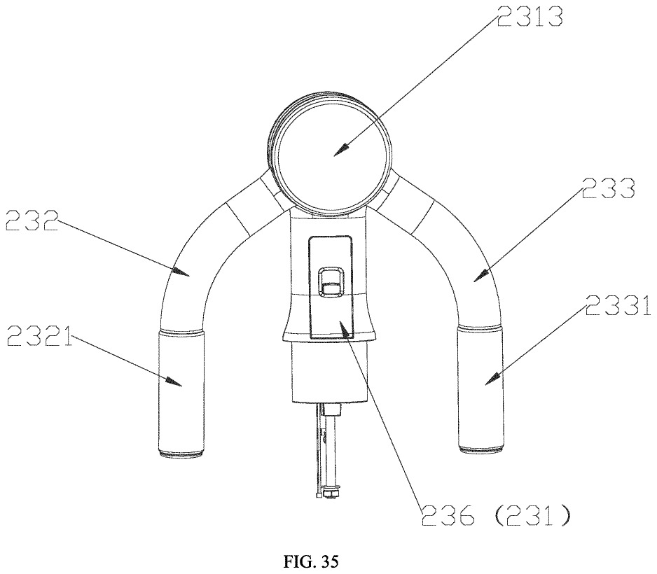

Specifically, as shown in FIGS. 28 to 30, the first handlebar 232 is an arc-shaped rod. Each of two ends of the arc-shaped rod includes the first connecting section and the first holding portion 232. In this embodiment, the first connecting section is the first fitting ring 2322. Similar to the first handlebar 232, the second handlebar 233 is also an arc-shaped rod and includes the second connecting section and the second holding portion 2331 at each of two ends of the arc-shaped rod. In this embodiment, the second connecting section is the second fitting ring 2332. The first fitting ring 2322 and the second fitting ring 2332 are rotatably mounted on the left and right sides of the mounting member 211. In this way, as shown in FIGS. 31 to 33, when the first fitting ring 2322 and the second fitting ring 2332 rotate relative to each other, the first holding portion 2321 and the second holding portion 2331 can be driven to rotate relative to each other, thereby adjusting the use height of the first holding portion 2321 and the second holding portion 2331. In addition, as shown in FIGS. 34 and 35, when the frame 100 is folded, the first handlebar 232 and the second handlebar 233 can also be rotated to the folded state, thereby reducing the overall folded volume of the child carrier.

In other embodiments, the first handlebar 232 and the second handlebar 233 can also be L-shaped rods, etc., as long as the use height of the first holding portion 2321 and the second holding portion 2331 can be adjusted through the rotations of the first fitting ring 2322 and the second fitting ring 2332. In addition, the first connecting section and the second connecting section may also be other components other than the fitting ring, such as fitting plate, which is not limited herein.

Further, as shown in FIGS. 28 to 30, the surface of the first fitting ring 2322 is fastened to the first annular mounting groove 2113, and a first locking groove 221 is disposed at the edge of another surface of the first fitting ring 2322. A first internal gear portion 2323 is disposed on an inner wall of the first fitting ring 2322 in a circumferential direction. One surface of the second fitting ring 2332 is fastened to the second annular mounting groove. A second locking groove 321 and a third locking groove 322 are disposed at the edge of another surface of the second fitting ring 2332. The first locking groove 221 faces the second locking groove 321. A second internal gear portion 2333 is disposed on an inner wall of the second fitting ring 2332 in a circumferential direction.

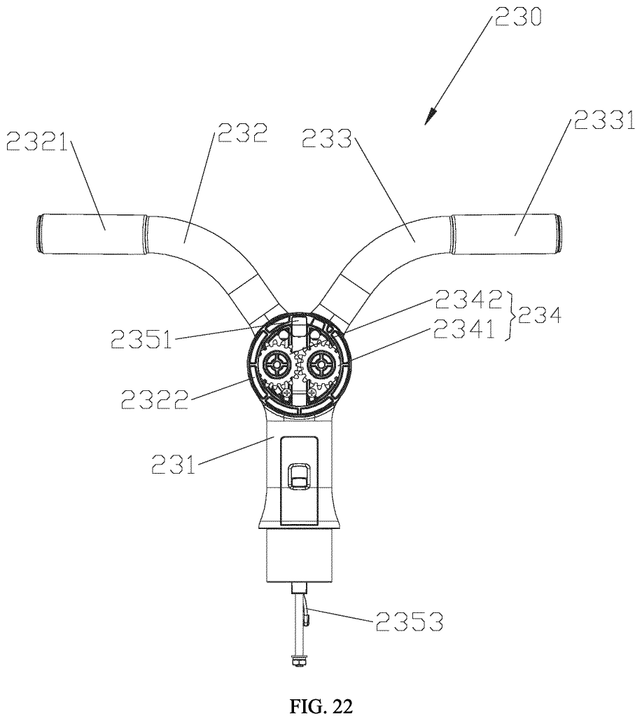

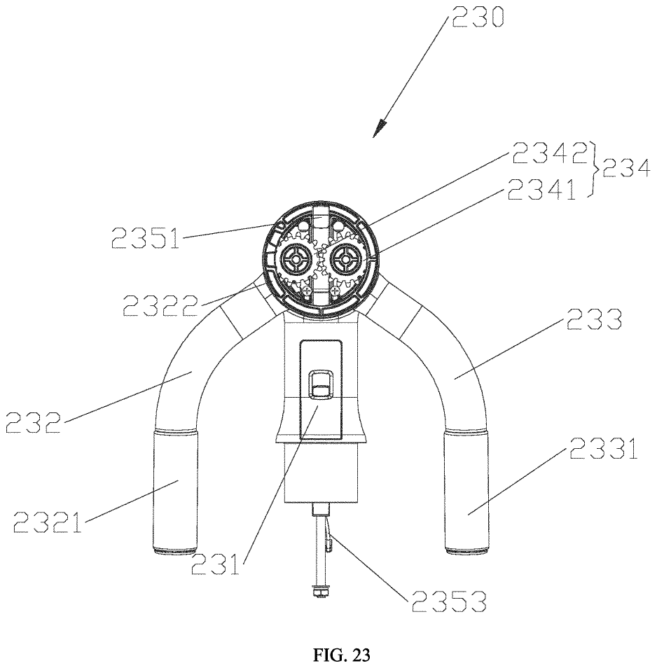

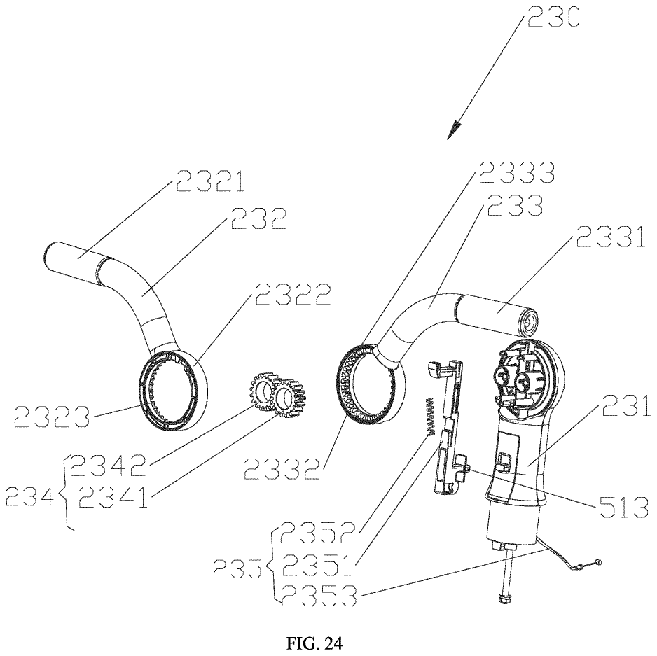

As shown in FIGS. 22 and 23, the first synchronization mechanism 234 includes a first driving element and a second driving element. The first driving element is drivingly connected to the first handlebar 232, the second driving element is drivingly connected to the second handlebar 233, and the first driving element and the second driving element are drivingly connected. Synchronous adjustment of the use heights of the first handlebar 232 and the second handlebar 233 can be achieved through the first driving element and the second driving element. In this embodiment, the first driving element is a first external gear 2341, and the second driving element is a second external gear 2342. The first external gear 2341 and the second external gear 2342 are engaged with each other. Referring to FIG. 24, the first fitting ring 2322 is provided with the first internal gear portion 2323 that can be engaged with the first external gear 2341, and the second fitting ring 2332 is provided with the second internal gear portion 2333 that can be engaged with the second external gear 2342. In this way, when one of the first handlebar 232 and the second handlebar 233 is rotated, another of the first handlebar 232 and the second handlebar 233 can be driven synchronously through the first external gear 2341 and the second external gear 2342, so that the heights of the first holding portion 2321 and the second holding portion 2331 can be adjusted synchronously.

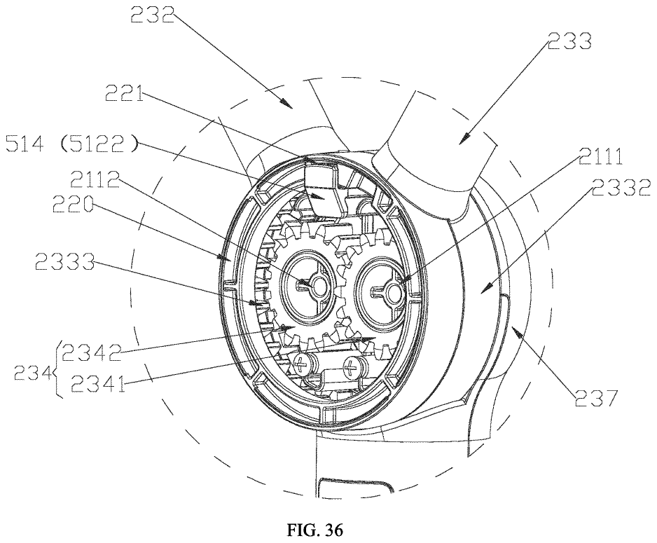

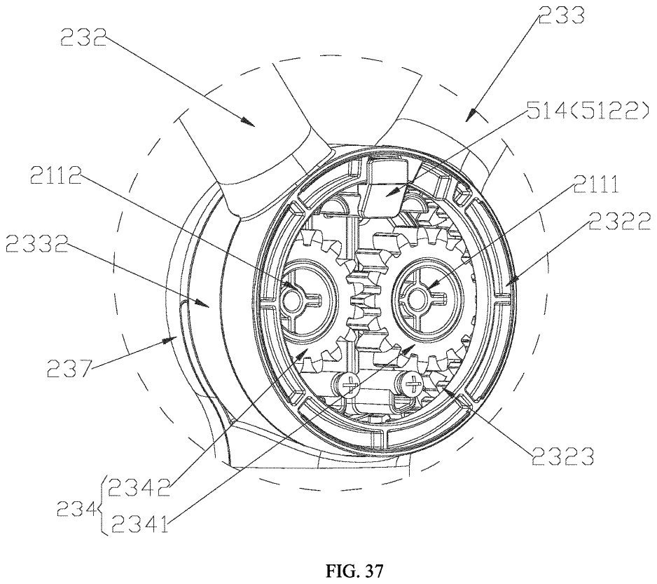

Specifically, as shown in FIG. 36, the first synchronization mechanism 234 includes the first driving element and the second driving element. The first driving element is drivingly connected to the first handlebar 232, the second driving element is drivingly connected to the second handlebar 233, and the first driving element and the second driving element are drivingly connected in a teeth configuration. Synchronous adjustment of the use heights of the first handlebar 232 and the second handlebar 233 can be achieved through the first driving element and the second driving element. In this embodiment, the first driving element is the first external gear 2341, and the second driving element is the second external gear 2342. The first external gear 2341 is sleeved on the first pivot shaft 2111 and can rotate around the first pivot shaft 2111. The second external gear 2342 is sleeved on the second pivot shaft 2112 and can rotate around the second pivot shaft 2112. The first external gear 2341 and the second external gear 2342 are engaged with each other. As shown in FIGS. 37 to 39, in the axial direction, the first external gear 2341 is more adjacent to the fourth cover 238 than the second external gear 2342, and thus the first external gear 2341 and the second external gear 2342 only partially are engaged with each other in the axial direction. That is, a portion of the first external gear 2341 away from the fourth cover 238 is engaged with a portion of the second external gear 2342 adjacent to the fourth cover 238. In addition, a portion of the first external gear 2341 close to the fourth cover 238 is engaged with the first internal gear portion 2323 of the first fitting ring 2322, and a portion of the second external gear 2342 away from the fourth cover 238 is engaged with the second internal gear portion 2333 of the second fitting ring 2332.

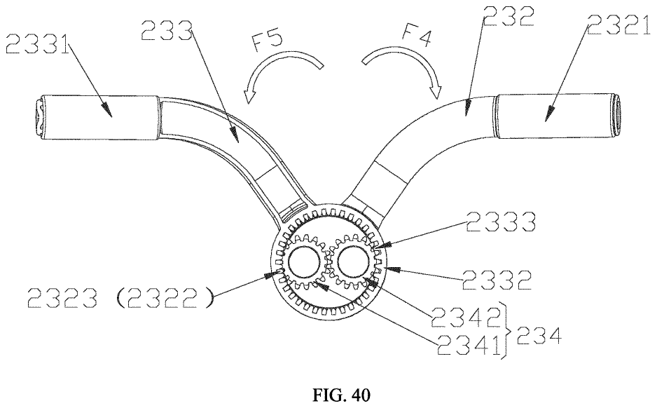

In this way, when one of the first handlebar 232 and the second handlebar 233 is rotated, another of the first handlebar 232 and the second handlebar 233 can be driven synchronously through the first external gear 2341 and the second external gear 2342, so that the heights of the first holding portion 2321 and the second holding portion 2331 can be adjusted synchronously. Specifically, as shown in FIG. 40, for example, if the first handlebar 232 (or the first holding portion 2321) is rotated clockwise (that is, in the direction F4), the first fitting ring 2322 rotates in the direction F4, and at the same time, the first internal gear portion 2323 drives the first external gear 2341 to rotate in the counterclockwise direction (that is, in the direction F5). The first external gear 2341 then drives the second external gear 2342 to rotate in the direction F4 at the same time. When the second external gear 2342 rotates, the second internal gear portion 2333 also drives the second fitting ring 2332 to rotate in the direction F5. In this way, the first holding portion 2321 and the second holding portion 2331 either rotate closer to each other or rotate away from each other, thereby realizing the synchronization adjustment of the use heights of the first handlebar 232 (or the first holding portion 2321) and the second handlebar 233 (or the second holding portion 2331).

In other embodiments, the first driving element and the second driving element may also be other driving components, such as linking rods, in short, as long as the synchronous adjustment of the first handlebar 232 and the second handlebar 233 can be achieved. Moreover, only a part of the inner wall of the first fitting ring 2322 can also be provided with the first internal gear portion, and only a part of the inner wall of the second fitting ring 2332 can also be provided with the second internal gear portion. As such, the height adjustment range of the first handlebar 232 and the second handlebar 233 can be limited. Similarly, only a part of the outer walls of the first external gear 2341 and the second external gear 2342 may be provided with gear teeth.

Further, as shown in FIGS. 22 to 24, when the locking mechanism 235 is in the locked state, the first handlebar 232 and the second handlebar 233 are relatively fixed at a certain use height. When the locking mechanism 235 is in the unlocked state, the first handlebar 232 and the second handlebar 233 can rotate relative to each other to be adjusted to other use heights. Specifically, the locking mechanism 235 includes a pushing button 2351, a pushing button reset member 2352, and/or the first pulling member 2353. The pushing button 2351 is movably disposed in the support base 231. The pushing button 2351 has a first position and a second position. When the pushing button 2351 is in the first position, the pushing button 2351 locks the first handlebar 232 and the second handlebar 233 relative to each other. When the pushing button 2351 is in the second position, the pushing button 2351 unlocks the first handlebar 232 and the second handlebar 233. In this embodiment, the first position is located above the second position. Two ends of the pushing button reset member 2352 respectively abut against the support base 231 and the pushing button 2351. The pushing button reset member 2352 biases the pushing button 2351 to move to the first position. A first end of the first pulling member 2353 is connected to the pushing button 2351, and a second end of the first pulling member 2353 is connected to the linkage mechanism 130. Specifically, the first end of the first pulling member 2353 extends into the support base 231 and is connected to the pushing button 2351, and the second end of the first pulling member 2353 is connected to the second connecting frame 132. When the frame 100 is switched from the unfolded state to the folded state, the second connecting frame 132 rotates and drives the pushing button 2351 to move from the first position to the second position through the first pulling member 2353, and the locking mechanism 235 is switched from the locked state to the unlocked state, so that the first handlebar 232 and the second handlebar 233 can be folded together with the frame.

With the above configuration, the above-mentioned child carrier has at least the following technical effects.

When the frame 100 is switched from the unfolded state to the folded state, the linkage mechanism 130 rotates relative to the first frame 110, and then drives the second frame 120 to rotate, so that the second frame 120 moves toward the first frame 110. This child carrier has high structural stability, and the frame 100 can be folded or unfolded very conveniently through the linkage mechanism 130. When the frame 100 is in a fully folded state, the overall size of the child carrier can be minimized to facilitate carrying, storage and transportation.

The frame of the child carrier according to the present application can be folded through the linkage mechanism to reduce the overall size of the child carrier, making it easy to carry, store and transport, and the folding operation is simple.

In other embodiments, the first pulling member 2353 may be omitted. For example, an unlocking operating member 513 may be disposed on the pushing button 2351. The unlocking operating member 513 at least partially extends out of an outer surface of the support base 231 for a direct pressing operation of the user, which can also enable the pushing button 2351 to move from the first position to the second position, and enable the locking mechanism 235 to be switched from the locked state to the unlocked state.

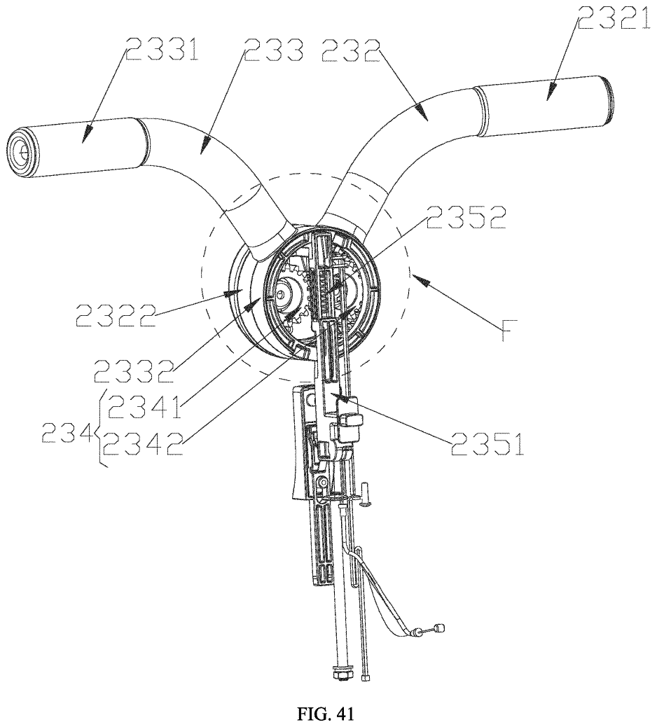

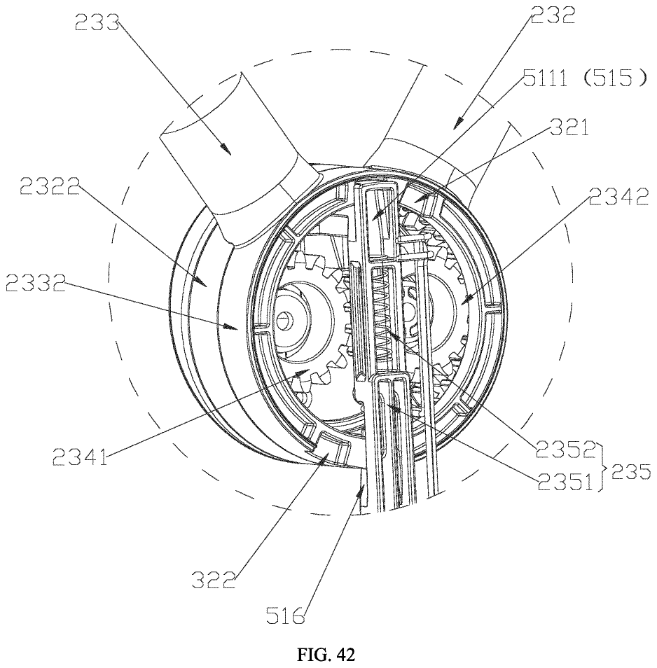

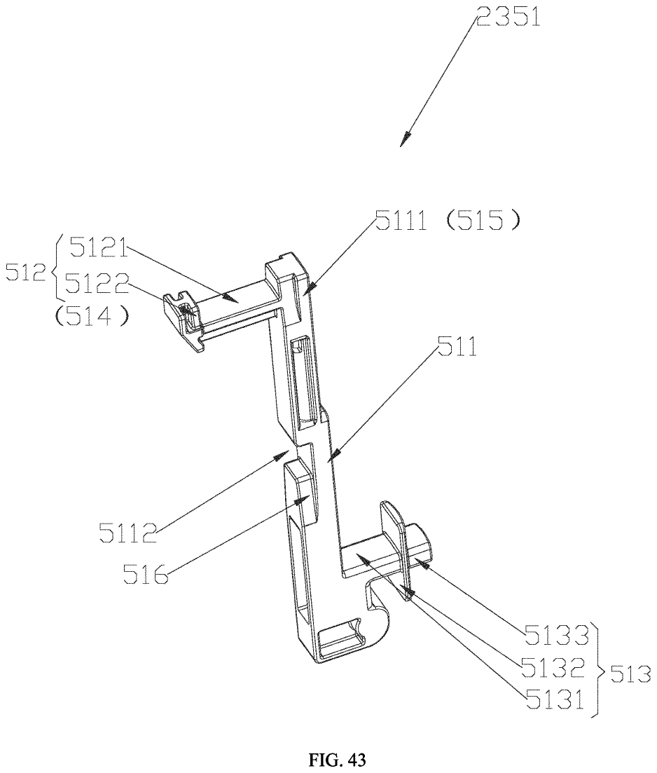

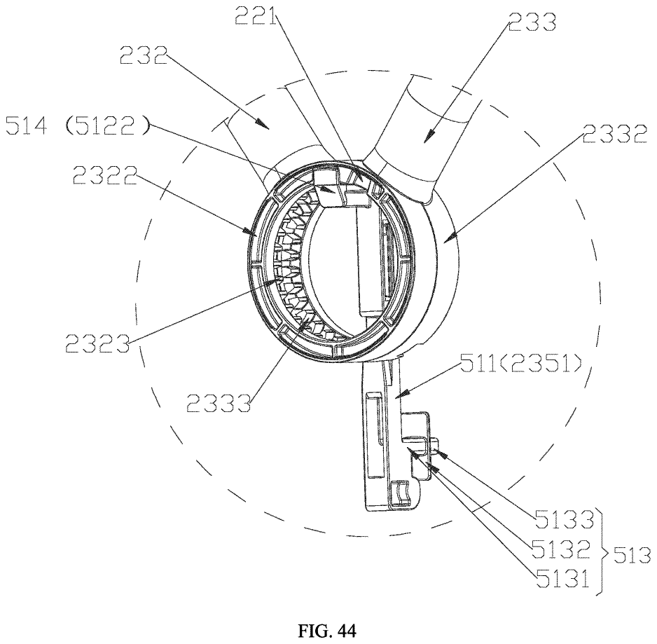

Specifically, as shown in FIGS. 41 and 42, the locking mechanism 235 includes the pushing button 2351 and a pushing button reset member 2352. The pushing button 2351 is movably disposed in the first mounting cavity of the support base 231. Specifically, as shown in FIG. 43, the pushing button 2351 includes a second pushing rod 511, a locking rod 512, and the unlocking operating member 513. In this embodiment, the pushing button 2351 is integrally formed. In other embodiments, the pushing button 2351 can also be formed by connecting the second pushing rods 511, the locking rod 512, and the unlocking operating member 513 that are independent of each other by soldering, welding, or other methods. The second pushing rod 511 has an engaging end 5111. The locking rod 512 is generally L-shaped, and includes a first rod 5121 and a second rod 5122 arranged at an angle with respect to each other. One end of the first rod 5121 away from the second rod 5122 is vertically fixed on the second pushing rod 511 and adjacent to the engaging end 5111. That is, an angle between the first rod 5121 and the second pushing rod 511 is 90 degrees. In other embodiments, the angle between the first rod 5121 and the second pushing rod 511 may also be greater than 90 degrees or less than 90 degrees. The second rod 5122 is provide with a first locking portion 514, and the engaging end 5111 is provide with a second locking portion 515. The unlocking operating member 513 is fixed on the second pushing rod 511, and is away from the engaging end 5111. The unlocking operating member 513 and the locking rod 512 are respectively located on both sides of the second pushing rod 511. A moving groove 5112 is formed on a side surface of approximately the middle portion of the second pushing rod 511. A third locking portion 516 is formed on a sidewall of the moving groove 5112, specifically, a sidewall adjacent to the unlocking operating member 513. Specifically, as shown in FIGS. 42 and 44, the second pushing rod 511 is movably disposed on the side of the second fitting ring 2332 facing the third cover 237. The locking rod 512 extends through the second fitting ring 2332, the mounting member 211, and the first fitting ring 2322 in sequence. The second rod 5122 of the locking rod 512 is located on the side of the first fitting ring 2322 away from the mounting member 211, that is, the first fitting ring 2322 and the second fitting ring 2332 are located between the second rod 5122 and the engaging end 5111.

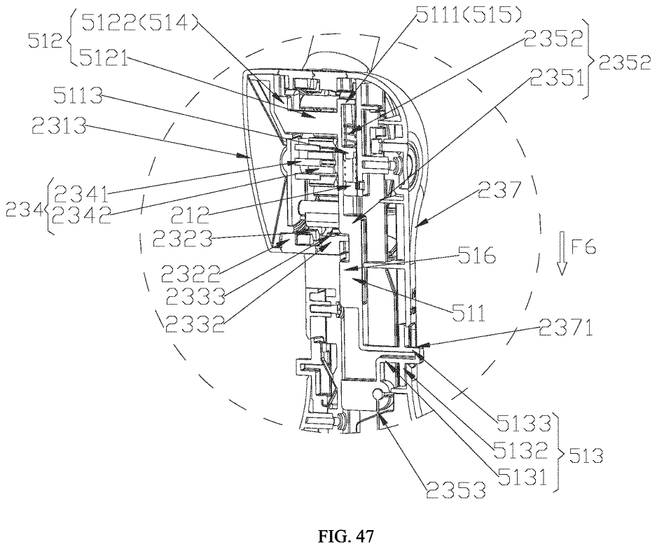

As described above, the pushing button 2351 has the first position and the second position. As shown in FIGS. 44 to 46, when the pushing button 2351 is in the first position, the first locking portion 514, the second locking portion 515, and the third locking portion 516 are engaged with the first locking groove 221, the second locking groove 321, and the third locking groove 322, respectively. In this way, the first fitting ring 2322 and the second fitting ring 2332 cannot rotate relative to each other, the first holding portion 2321 and the second holding portion 2331 are fixed at a certain use height, and the pushing button 2351 enables the first handlebar 232 and the second handlebar 233 to be locked relative to each other. As shown in FIG. 47, when the pushing button 2351 is in the second position, the first locking portion 514, the second locking portion 515, and the third locking portion 516 are disengaged from the first locking groove 221, the second locking groove 321, and the third locking groove 322, respectively. The first fitting ring 2322 and the second fitting ring 2332 can rotate relative to each other, and the pushing button 2351 unlocks the first handlebar 232 and the second handlebar 233. In this case, the use heights of the first holding portion 2321 and the second holding portion 2331 can be adjusted simultaneously by pushing the first handlebar 232 or the second handlebar 233. In this embodiment, two first locking grooves 221, two second locking grooves 321, and two third locking grooves 322 are provided respectively, which can facilitate fixing the first holding portion 2321 and the second holding portion 2331 at two different heights. In other embodiments, more than two or less than two first locking groove 221, more than two or less than two second locking groove 321, and more than two or less than two third locking groove 322 may also be provided respectively.

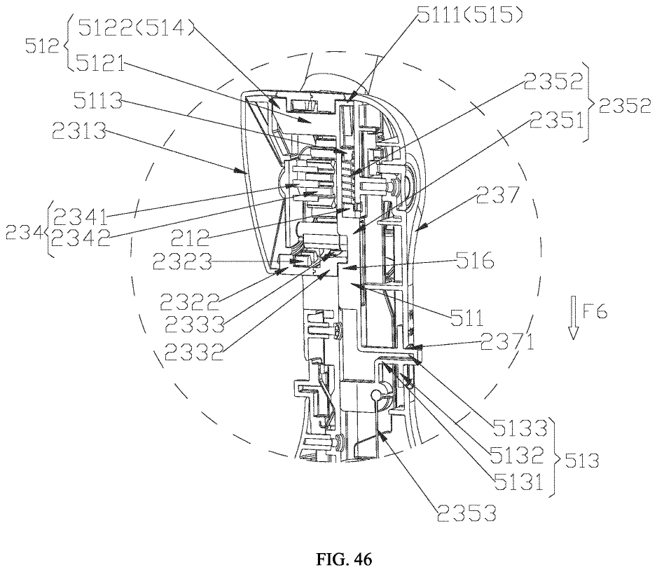

In this embodiment, referring to FIGS. 28 and 43, the third cover 237 is provided with a first operating hole 2371, and at least a part of the unlocking operating member 513 can extend out of the surface of the support base 231 through the first operating hole 2371, so as to be operated. Specifically, the unlocking operating member 513 includes a connection rod 5131, a blocking plate 5132, and a pressing block 5133. Both ends of the connection rod 5131 are connected to the second pushing rod 511 and the blocking plate 5132, respectively. The pressing block 5133 is connected to the blocking plate 5132. The connection rod 5131 and the blocking plate 5132 are located in the first mounting cavity, and the blocking plate 5132 always blocks the first operating hole 2371. The pressing block 5133 extends out of the first mounting cavity through the first operating hole 2371, and the pressing block 5133 can move along the first operating hole 2371. In this way, the movement of the pressing block 5133 can drive the entire pushing button 2351 to move, and at the same time, the blocking plate 5132 can block the first operating hole 2371 to prevent entrapment. As shown in FIGS. 46 and 47, the second position is located below the first position. That is, by pressing the unlocking operating member 513 downward, the first locking portion 514, the second locking portion 515, and the third locking portion 516 can be unlocked from the first locking groove 221, the second locking groove 321, and the third locking groove 322 respectively, so that the use heights of the first holding portion 2321 and the second holding portion 2331 can be adjusted synchronously by pushing the first handlebar 232 or the second handlebar 233.

Further, as shown in FIGS. 46 and 47, the mounting member 211 includes a first pushing member 212, and a second pushing member 5113 is disposed on the second pushing rod 511. The second pushing member 5113 is located above the first pushing member 212. Two ends of the pushing button reset member 2352 abut against the first pushing member 212 and the second pushing member 5113, respectively. The pushing button reset member 2352 biases the pushing button 2351 to move to the first position. In this way, when the external force applying to the unlocking operating member 513 is removed, the pushing button 2351 moves to the first position under the action of the pushing button reset member 2352, so that the first locking portion 514, the second locking portion 515, and the third locking portions 516 are re-engaged with the first locking groove 221, the second locking groove 321, and the third locking groove 322 respectively, so that the first handlebar 232 and the second handlebar 233 are relatively fixed, and the first holding portion 2321 and the second holding portion 2331 are fixed at a certain use height.

In other embodiments, the second locking groove 321 and the third locking groove 322 are not necessarily to be arranged to be opposite to each other. The second locking groove 321 and the third locking groove 322 are only required to be spaced apart in the circumferential direction of the second fitting ring 2332. In other embodiments, the third locking portion 516 and the third locking groove 322 can also be omitted, that is, the pushing button 2351 can enable the first fitting ring 2322 and the second fitting ring 2332 to be locked only through the cooperation of the first locking portion 514 and the first locking groove 221, the cooperation of the second locking portion 515 and the second locking groove 322. In addition, in other embodiments, the first locking portion 512, the second locking portion 515, and the third locking portion 516 may also be disposed on the pushing button 2351, and the first locking groove 221, the second locking groove 321, and the third locking groove 322 are disposed on the first fitting ring 2322 and the second fitting ring 2332. The arrangements of the locking groove and the locking portion are not limited in this application, as long as the pushing button 2351 can selectively enable the first fitting ring 2322 and the second fitting ring 2332 to be locked.

In further embodiments, the locking mechanism 235 may also include the first pulling member 2353. Both ends of the first pulling member 2353 are connected to the pushing button 2351 and the frame 100, respectively. In this way, when the frame 100 is folded, the pushing button 2351 can be driven by the first pulling member 2353 to move in the direction F6 shown in FIG. 46, so that the locking mechanism 235 is unlocked, and the first handlebar 232 and the second handlebar 233 can also be folded with the frame 100, that is, switched to the state as shown in FIG. 35, thereby reducing the overall volume of the child carrier.

In addition, the handlebar assembly 230 may further include a lighting assembly 600. As shown in FIG. 28, the lighting assembly 600 is disposed between the fourth cover 238 and the second fitting ring 2332. Specifically, the lighting assembly 600 includes a reflector 610, a light emitting diode (LED) component 620, and a lamp holder 630. The lighting assembly 600 is convenient for child carrier to be used at night, and can also serve as a warning to other pedestrians and vehicles, thereby improving the safety factor.

The handlebar assembly 230 and the child carrier as described above have at least the following technical effects. In the above-mentioned child carrier, at least two handlebars can be adjusted to different use heights according to the body shape of the seated child. In the child carrier, the use heights of at least two handlebars can be synchronously adjusted by the first synchronization mechanism 234 disposed between the at least two handlebars. The adjustment process is very convenient, the child carrier is easy to use, thus resulting in a great user experience.

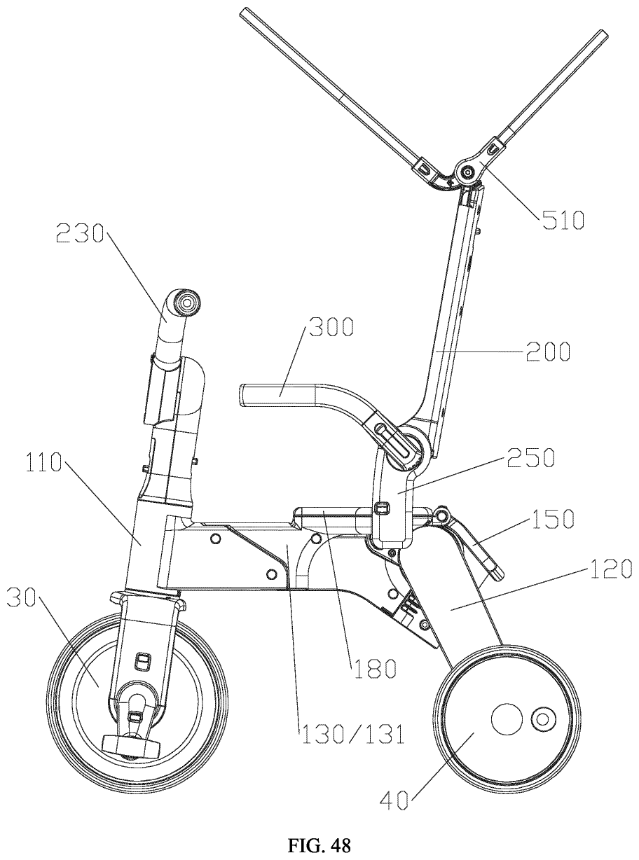

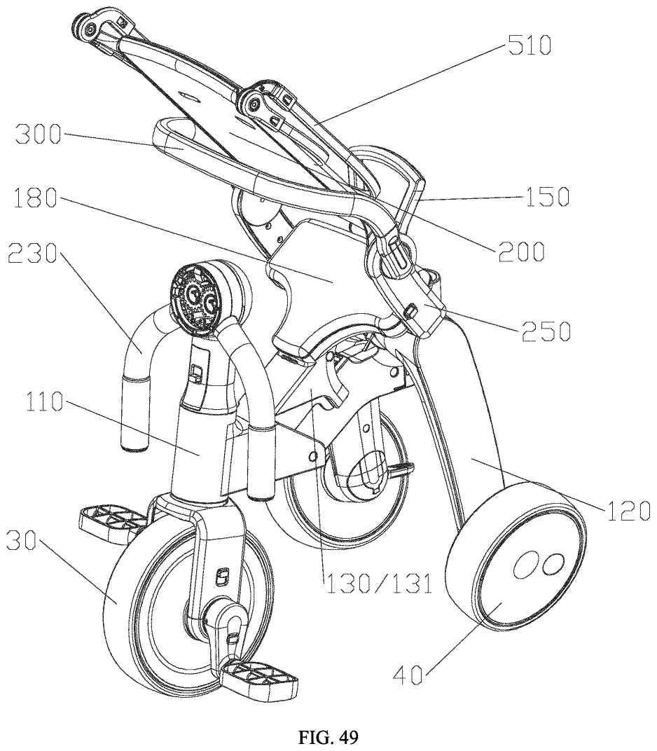

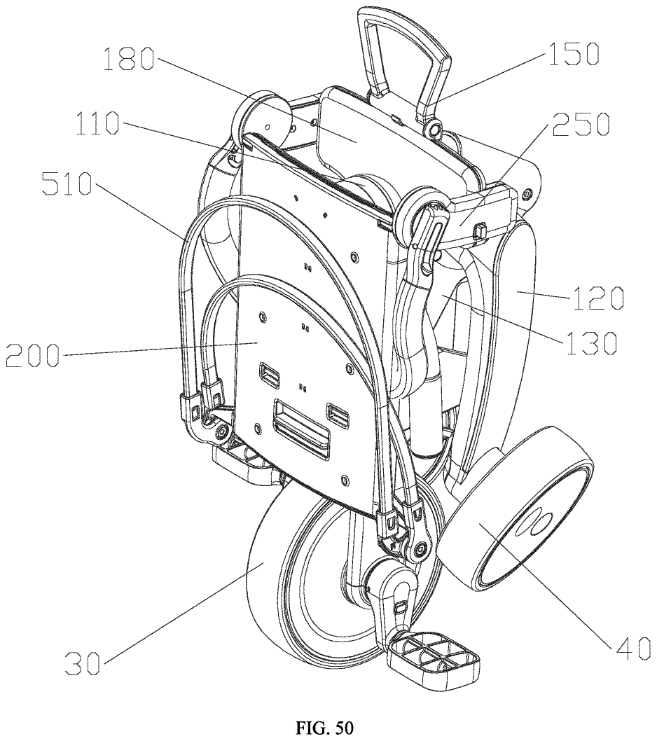

In an embodiment, as shown in FIG. 48, the child carrier further includes a backrest assembly 200. Specifically, the frame 100 further includes a connecting base 250. The connecting base 250 is removably connected to the seat assembly 180 or the first connecting frame 131. The backrest assembly 200 is rotatably connected to the connecting base 250. In this embodiment, two connecting bases 250 are provided. The two connecting bases 250 are disposed on both sides of the seat assembly 180, respectively. In other embodiments, only one connecting base 250 or more than two connecting bases 250 may be provided, as long as the backrest assembly 200 can be fixed, and which is not limited in this application. In other embodiments, the connecting base 250 may be omitted. For example, the backrest assembly 200 may be directly removably connected to the seat assembly 180 or the first connecting frame 131. As shown in FIGS. 49 and 50, when the frame 100 is switched from the unfolded state to the folded state, the backrest assembly 200 can be folded accordingly, so as to reduce the overall volume of the child carrier when folded, making it easier for the user to carry, store, transport, etc.

In addition, as shown in FIGS. 48 and 49, the child carrier further includes an armrest assembly 300. The armrest assembly 300 is removably connected to the backrest assembly 200.

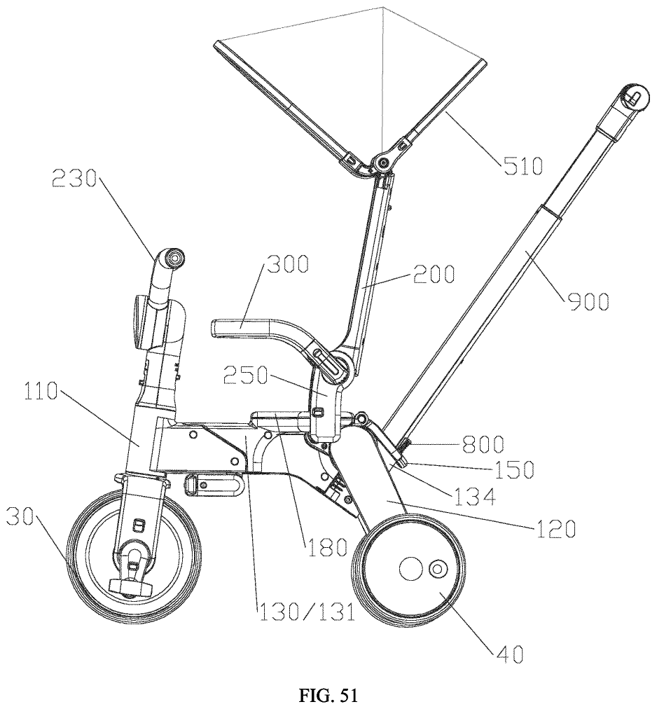

As shown in FIGS. 48 and 49, the child carrier may further include a sunshade 510. In this embodiment, the sunshade 510 is rotatably connected to the backrest assembly 200, so that the sunshade 510 can also be folded together with the backrest assembly 200, so as to reduce the overall volume of the child carrier when folded, and facilitate the user to carry, store, transport, etc. The sunshade 510 is removably connected to the backrest assembly 200. Specifically, the sunshade 510 is removably disposed on the top of the backrest assembly 200, so that the user can decide whether to arrange the sunshade 510 according to actual needs. In other embodiments, the sunshade 510 can also be provided without the backrest assembly 200, and in this case, the sunshade 510 is rotatably connected to the first connecting frame 131 or the seat assembly 180. FIGS. 48 to 50 show an implementation of the sunshade 510, and FIG. 51 shows another implementation of the sunshade 510, but which is not limited thereto. As long as sun shading can be provided, the sunshade 510 can have any other proper configuration.

It should be understood that the terms “front” and “rear” referred to herein, unless otherwise specifically defined, are based on a forward direction of the child carrier, that is, a direction same as the forward direction of the child carrier is referred to as the front, and a direction opposite to the forward direction of the child carrier is referred to as the rear. The term “detachable connection” between the components described herein can also be arranged as a non-detachable connection according to actual needs in other embodiments. In addition, the number and mounting position of the front wheels 30 and the rear wheels 40 can also be adjusted appropriately as needed.

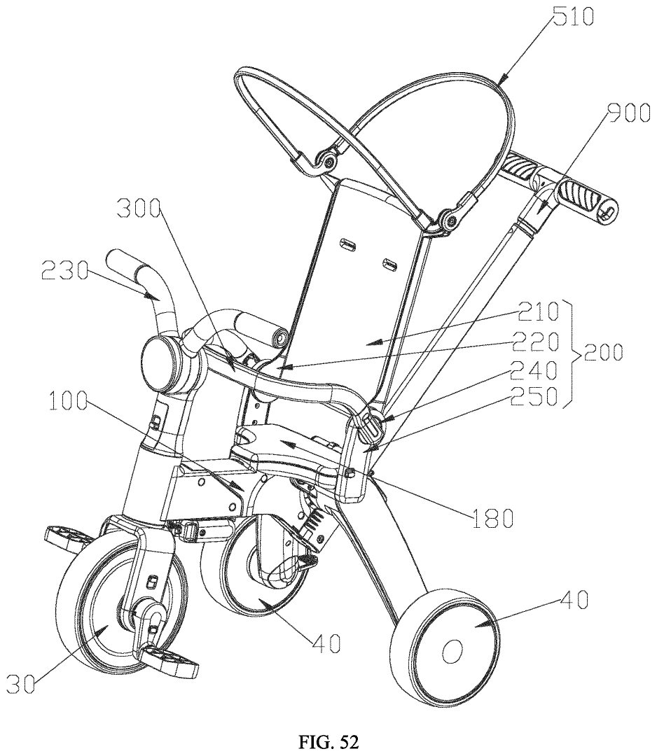

The specific configurations of the backrest assembly 200 and the armrest assembly 300 will be described in detail below with reference to FIGS. 52 to 77.

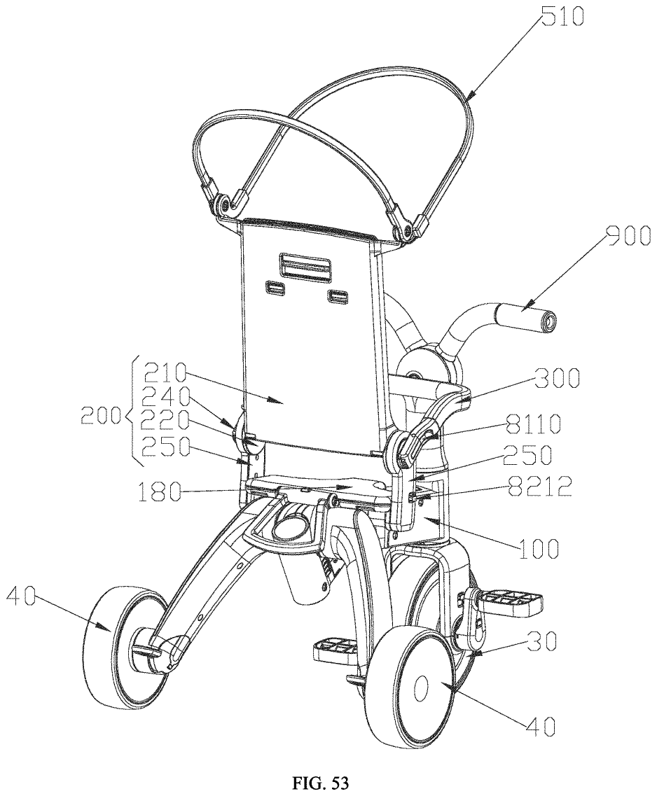

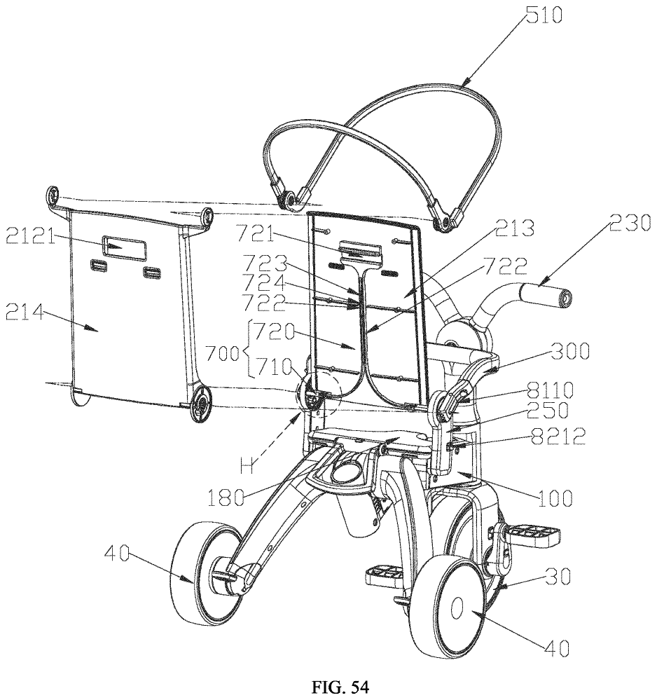

Specifically, as shown in FIGS. 52 and 53, the backrest assembly 200 includes a backrest body 210, and a mounting bases 220, a connecting bases 250 and a fixed bases 240 located on the left and right sides of the backrest body 210. That is, the mounting base 220, the connecting base 250, and the fixed base 240 are sequentially disposed on each side of the backrest body 210. The backrest body 210 is in the shape of a general rectangular plate, which can support the child's back. In this embodiment, as shown in FIG. 54, the backrest body 210 includes a first backrest housing 213 and a second backrest housing 214 that can be fastened to each other. The first backrest housing 213 is located in front of the second backrest housing 214. The first backrest housing 213 and the second backrest housing 214 enclose a second mounting cavity (not shown in figures). The second backrest housing 214 is provided with an unlocking opening 2121 in communication with the second mounting cavity.

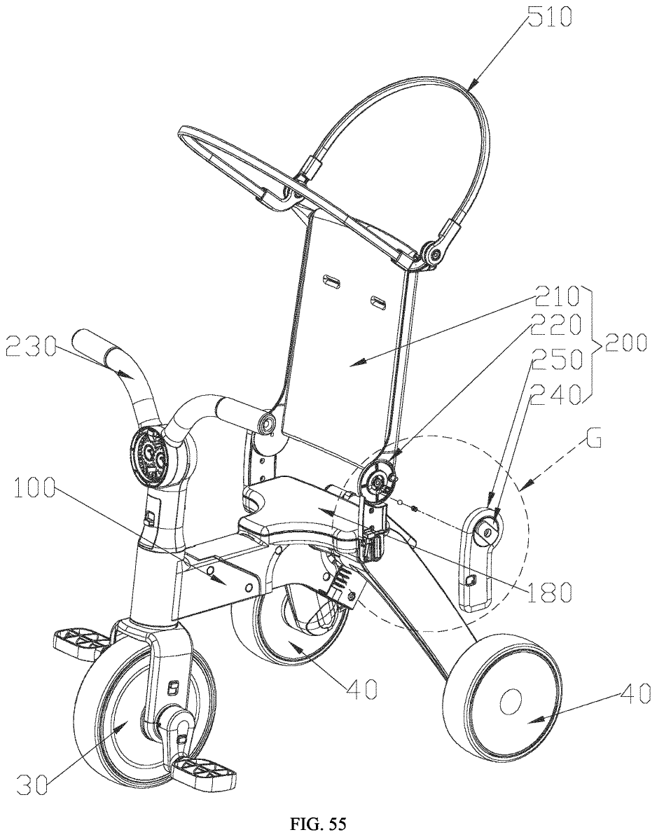

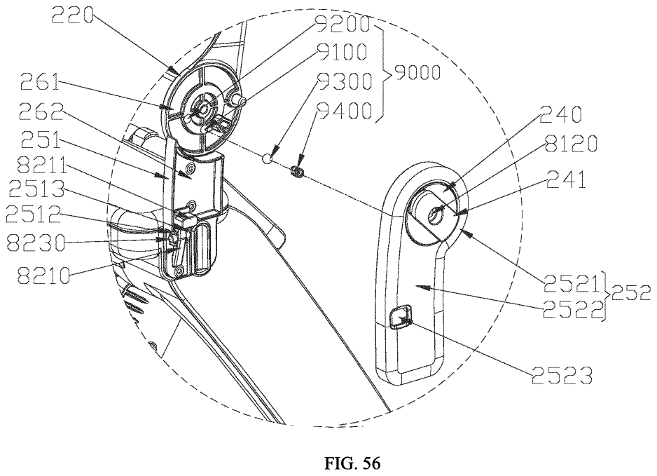

Further, as shown in FIGS. 55 and 56, the mounting base 220 is shaped as a substantially circular plate. Taking one of the sides of the backrest body 210 as an example, the connecting base 250 includes a third housing 251 and a fourth housing 252 that can be fastened and fixed to each other. The third housing 251 is disposed below the mounting base 220 on the same side. The mounting base 220 is pivotally connected to the fourth housing 252 through a first central shaft (not shown in figures), that is, the mounting base 220 is rotatable relative to the connecting base 250. The fourth housing 252 has a first housing portion 2521 whose shape is generally mated with the mounting base 220, and a second housing portion 2522 whose shape is generally mated with the third housing 251. In this embodiment, the fourth housing 252 is integrally formed. As shown in FIG. 56, the mounting base 220 and the first housing portion 2521 enclose a fourth accommodation cavity 261. The third housing 251 and the second housing portion 2522 enclose a fifth accommodation cavity 262. The fourth accommodation cavity 261 and the fifth accommodation cavity 262 may or may not be in communication with each other. The fixed base 240, the fourth housing 252, and the mounting base 220 are all pivotally connected to one another through the first central shaft.

Further, as shown in FIG. 54, the child carrier in this embodiment further includes an adjustment mechanism 700. The adjustment mechanism 700 can adjust an inclination angle of the backrest body 210 relative to the connecting base 250, that is, the inclination angle of the backrest assembly 200 relative to the seat assembly 180. The adjustment mechanism 700 can facilitate the folding of the backrest assembly 200 as the frame 100 is folded. Specifically, the adjustment mechanism 700 includes a second locking component 710 and an operating component 720.

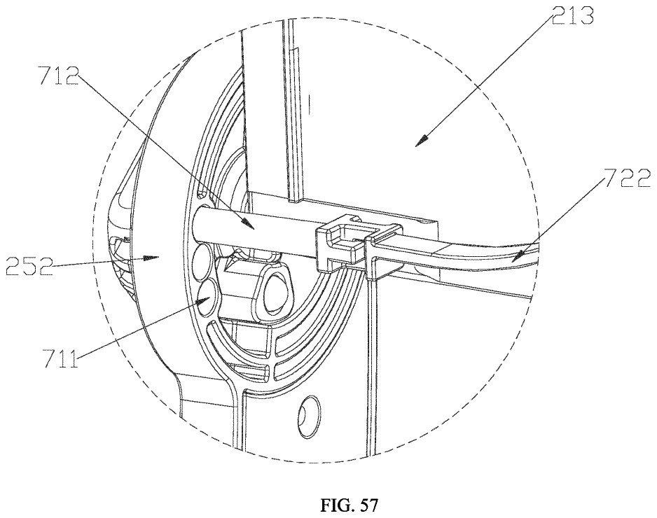

As shown in FIGS. 54 and 57, the second locking component 710 has a locked state in which the relative rotation of the backrest assembly 200 and the seat assembly 180 is limited, and an unlocked state in which the relative rotation of the backrest assembly 200 and the seat assembly 180 is non-limited. For example, in this embodiment, the second locking component 710 includes a plurality of limiting holes 711, and a limiting pin 712 that can be inserted into any one of the limiting holes 711. The plurality of limiting holes 711 are disposed at the edge of the first housing portion 2521 of the fourth housing 252 and are arranged at intervals along an arc line. Openings of the plurality of limiting holes 711 all face the backrest body 210 to receive the limiting pin 712 disposed on the backrest body 210.

Specifically, the limiting pin 712 is movably disposed on the backrest body 210. The limiting pin 712 can move generally in a horizontal direction to approach the first housing portion 2521 of the fourth housing 252 and be inserted into any one of the limiting holes 711, or move away from the first housing portion 2521 to be separated from any one of the limiting holes 711. In this embodiment, the second locking components 710 are disposed on both sides of the backrest body 210, so that the inclination angle of the backrest body 210 can be adjusted more smoothly.

As shown in FIG. 54, the operating component 720 may specifically include an unlocking member 721, a second pulling member 722, and a seventh reset member 723. In this embodiment, the second pulling member 722, the seventh reset member 723, and at least a part of the unlocking member 721 are mounted in the second mounting cavity. The other part of the unlocking member 721 extends out of the second mounting cavity through the unlocking opening 2121 for operation. In this embodiment, the unlocking member 721 is an unlocking handle, and the second pulling member 722 is a pulling steel rope. In other embodiments, the unlocking member 721 may also be an unlocking button, and the second pulling member 722 may also be a pulling rope or a flexible strip-shape member. In this embodiment, two second pulling members 722 are provided. Both ends of each of the second pulling members 722 are respectively connected to the unlocking member 721 and the limiting pin 712 at one side of the second locking component 710. In this way, by lifting the unlocking member 721 upward, the two second pulling members 722 can respectively pull the limiting pins 712 on both sides of the backrest body 210 to move the limiting pins 712 away from the first housing portion 2521 (that is, away from the limiting hole 711), thereby realizing the unlocking of the second locking component 710. After the second locking component 710 is unlocked, the backrest assembly 200 is rotatable relative to the seat assembly 180, so that the inclination angle of the backrest assembly 200 relative to the seat assembly 180 can be adjusted, and the backrest assembly 200 can be folded as the frame 100 is folded.

Further, as shown in FIG. 54, the seventh reset member 723 biases the second pulling member 722 to move in the direction of driving the second locking component 710 to be switched to the locked state. Specifically, a third pushing member 724 is connected between the two second pulling members 722, and a fourth pushing member (not shown in figures) is disposed on the surface of the first backrest housing 213 facing the second mounting cavity. The fourth pushing member is located above the third pushing member 724. Two ends of the seventh reset member 723 respectively abut against the third pushing member 724 and the fourth pushing member. In this way, when the external force to lift the unlocking member 721 is removed, the second pulling member 722 and the unlocking member 721 can be reset under the elastic force of the seventh reset member 723, and the limiting pins 712 on both sides of the backrest body 210 move in a direction approaching the first housing portion 2521 (that is, approaching the limiting holes 711) under the action of the second pulling member 722. The limiting pins 712 are inserted into the limiting holes 711 again, thereby realizing the re-locking of the second locking component 710. In this embodiment, the seventh reset member 723 is a spring.

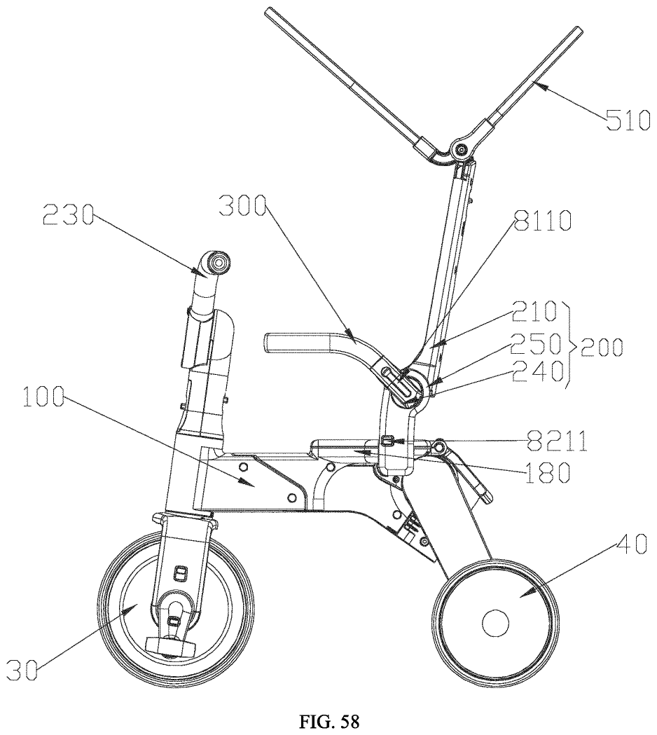

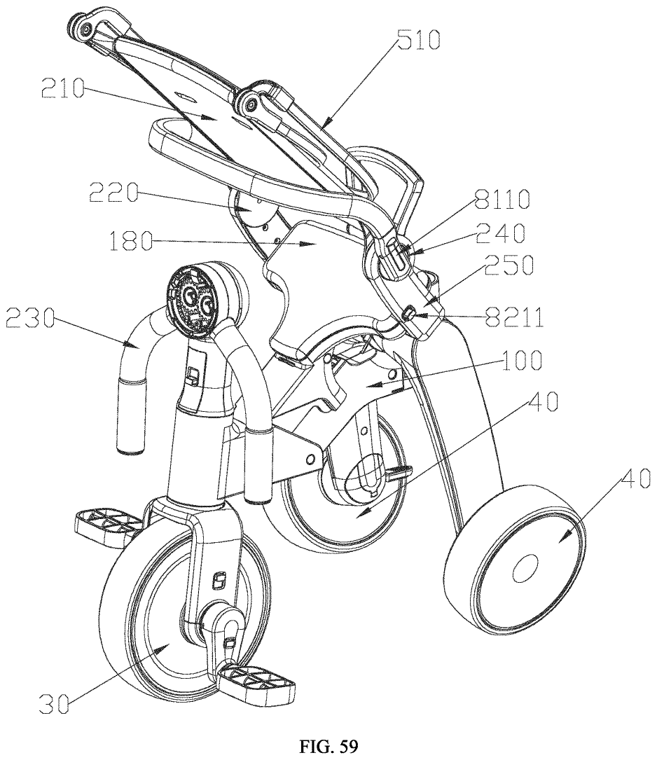

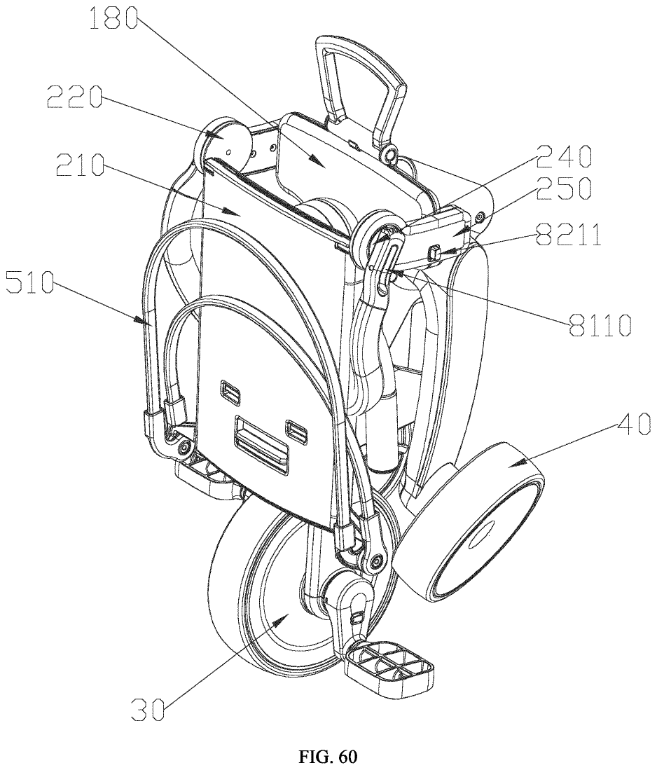

It can be understood that in this embodiment, two limiting holes 711 can be provided, so that when the frame 100 is in the unfolded state, the limiting pin 712 is engaged with one of the limiting holes 711 to allow the backrest assembly 200 to be fixed in the unfolded position as shown in FIG. 58 relative to the seat assembly 180. When the frame 100 is switched from the unfolded state to the folded state (as shown in FIGS. 59 and 60), the limiting pin 712 is engaged with another limiting hole 711 to allow the backrest assembly 200 to be fixed in the folded position as shown in FIG. 60 relative to the seat assembly 180. In other embodiments, more than two limiting holes 711 can also be provided, so that when the frame 100 is in the unfolded state or semi-folded state, the limiting pin 712 is engaged with any limiting hole 711 other than the two limiting holes 711 to allow the backrest assembly 200 to be fixed at different inclination angles relative to the seat assembly 180.

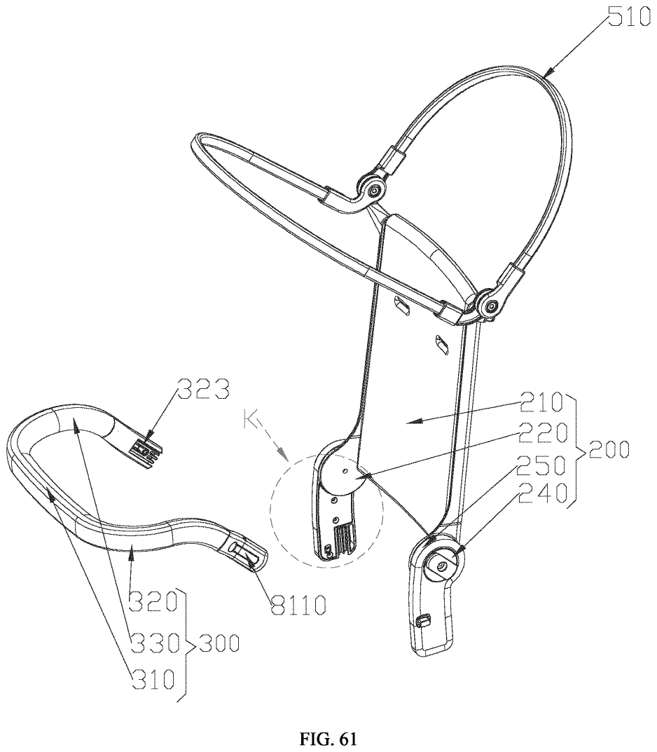

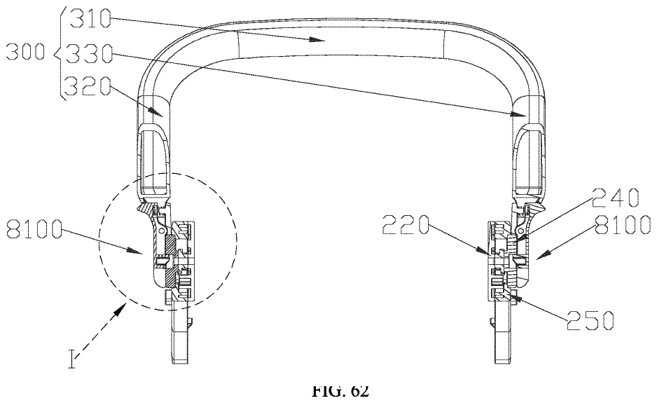

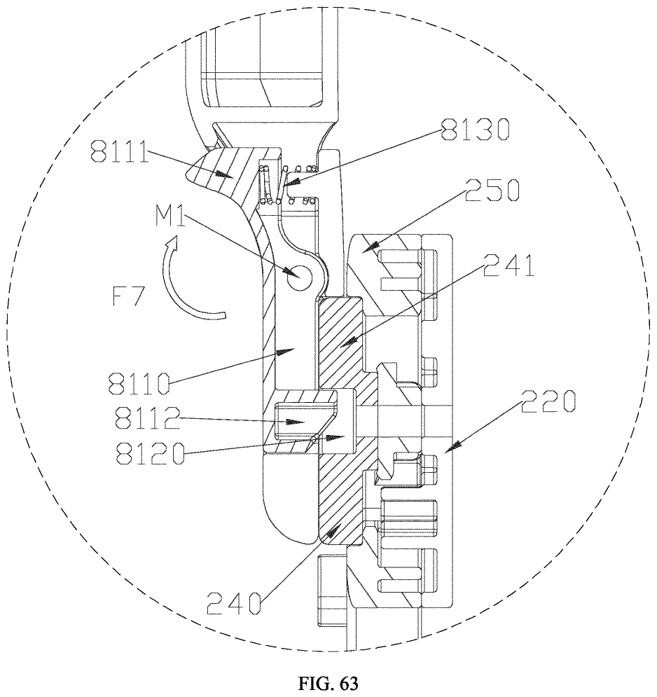

Specifically, as shown in FIGS. 61 and 62, the armrest assembly 300 includes an armrest body 310, a first armrest rod 320, and a second armrest rod 330. The first armrest rod 320 and the second armrest rod 330 are respectively connected to both sides of the armrest body 310 to form a U-shaped structure. In this embodiment, the armrest body 310, the first armrest rod 320, and the second armrest rod 330 are integrally formed. Further, as shown in FIGS. 62 and 63, the child carrier according to this embodiment further includes a first locking mechanism 8100. The first locking mechanism 8100 is configured to enable a detachable connection between the armrest assembly 300 and the backrest assembly 200. In this embodiment, two first locking mechanisms 8100 are provided to enable the detachable connections between the first armrest rod 320 and the backrest assembly 200 on one of both sides of the backrest body 210, and between the second armrest rod 330 and the backrest assembly 200 on the other of both sides of the backrest body 210, respectively.

The structure and connection relationship of the first locking mechanisms 8100 will be described below in detail, by taking one of the first locking mechanisms 8100 as an example.

As shown in FIG. 63, the first locking mechanism 8100 includes a third locking member 8110, a third locking hole 8120, and a sixth reset member 8130. In this embodiment, the third locking member 8110 is a locking button. The third locking member 8110 and the first armrest rod 320 (or the second armrest rod 330) are pivotally connected to each other at a first pivot point M1. The third locking hole 8120 is disposed on the fixed base 240 of the backrest assembly 200. The third locking member 8110 has a first operating end 8111 and a first locking end 8112. The first pivot point M1 is disposed between the first operating end 8111 and the first locking end 8112. The first locking end 8112 can be inserted into the third locking hole 8120. The first operating end 8111 is operable to separate the first locking end 8112 from the third locking hole 8120. Two ends of the sixth reset member 8130 respectively abut against the first armrest rod 320 (or the second armrest rod 330) and the first operating end 8111. The sixth reset member 8130 biases the first locking end 8112 to rotate in a direction of engaging with the third locking hole 8120. In this embodiment, the sixth reset member 8130 is a spring. In this way, when it is necessary to remove the armrest assembly 300, it only needs to press the first operating end 8111 to cause the third locking member 8110 to rotate in a direction F7 shown in FIG. 63, so that the first locking end 8112 is separated from the third locking hole 8120, and the first armrest rod 320 (or the second armrest rod 330) is unlocked from the fixed base 240.

As such, when the first operating ends 8111 of the third locking members 8110 on the first armrest rod 320 and the second armrest rod 330 are pressed simultaneously, the first armrest rod 320 and the second armrest rod 330 can both be unlocked from the fixed base 240, so that the armrest assembly 300 can be removed from backrest assembly 200.

In a further embodiment, as shown in FIG. 63, an engaging portion 241 may also be disposed on a surface of the fixed base 240 facing away from the fourth housing 252. A positioning groove 323 is provided at one end of the first armrest rod 320 away from the armrest body 310 (as shown in FIG. 61). The engaging portion 241 can be engaged into the positioning groove 323 to position the armrest assembly 300 on the connecting base 250, so that the armrest assembly 300 can be connected to the connecting base 250 more accurately. In this embodiment, the third locking hole 8120 is disposed on the engaging portion 241. In other embodiments, the third locking hole 8120 may not be disposed on the engaging portion 241.

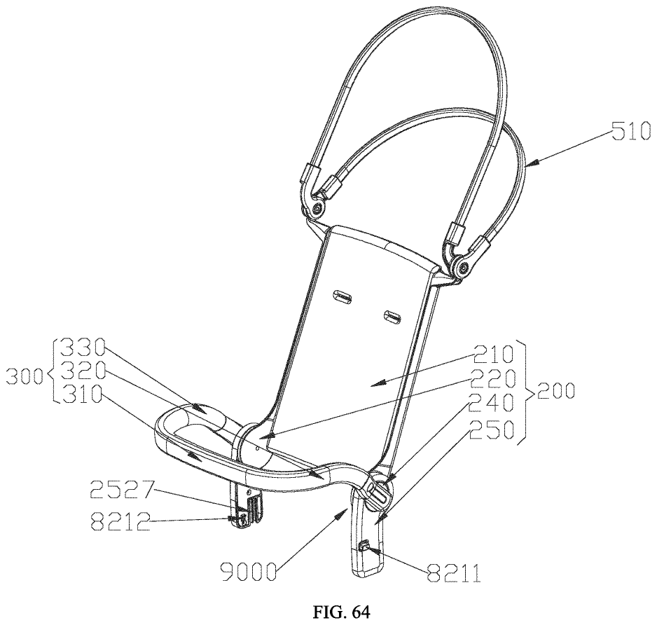

Further, as shown in FIGS. 64 to 66, the child carrier according to this embodiment may further include a first positioning mechanism 9000. When the armrest assembly 300 is in an unfolded state, the first positioning mechanism 9000 can enable the armrest assembly 300 to be fixed in a first position relative to the backrest assembly 200. When the armrest assembly 300 is in a folded state, the first positioning mechanism 9000 can enable the armrest assembly 300 to be fixed in a second position relative to the backrest assembly 200. It should be understood that, unless otherwise stated, the unfolded state described herein refers to the fully unfolded state of the armrest assembly 300, and the folded state described herein refers to the fully folded state of the armrest assembly 300. The armrest assembly 300 also has an intermediate state between the unfolded state and the folded state. When the armrest assembly 300 is in the intermediate state, the armrest assembly 300 may be fixed in a third position relative to the backrest assembly 200.

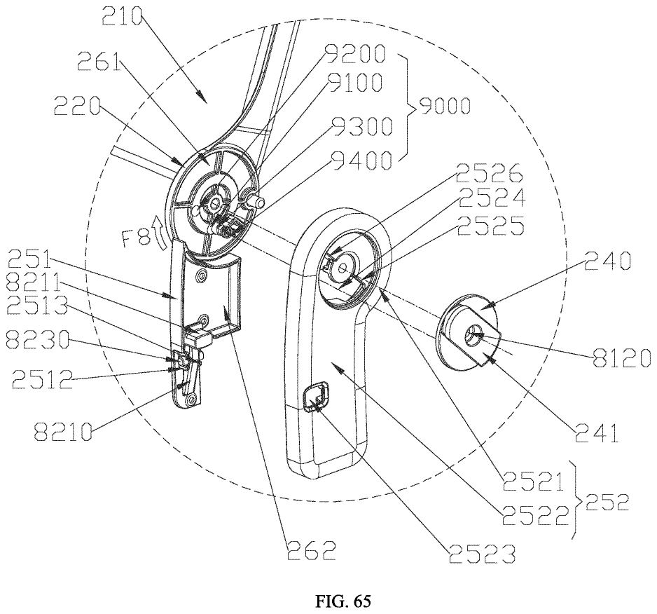

As shown in FIG. 65, the first positioning mechanism 9000 includes a first positioning portion, a second positioning portion, a third positioning portion, and a fifth reset member 9400. In this embodiment, the first positioning portion and the second positioning portion are a first positioning recess 9100 and a second positioning recess 9200 that are spaced apart on the backrest assembly 200. The third positioning portion is a first positioning protrusion 9300 movably disposed on the fixed base 240. In another embodiment, the fixed base 240 can also be integrally formed with the first armrest rod 320 or the second armrest rod 330, and the third positioning portion is movably disposed on the armrest assembly 300.

When the armrest assembly 300 is in the unfolded state, the first positioning protrusion 9300 can be inserted into the first positioning recess 9100 to fix the armrest assembly 300 in the first position relative to the backrest assembly 200. When the armrest assembly 300 is in the folded state, the first positioning protrusion 9300 can be inserted into the second positioning recess 9200 to fix the armrest assembly 300 in the second position relative to the backrest assembly 200.

In this embodiment, as shown in FIG. 65, the first positioning recess 9100 and the second positioning recess 9200 are hemispherical holes and are disposed on a side of the mounting base 220 facing the first housing portion 2521 of the fourth housing 252. The first positioning recess 9100 and the second positioning recess 9200 are offset from a pivot shaft of the fixed base 240, that is, offset from the first central shaft.

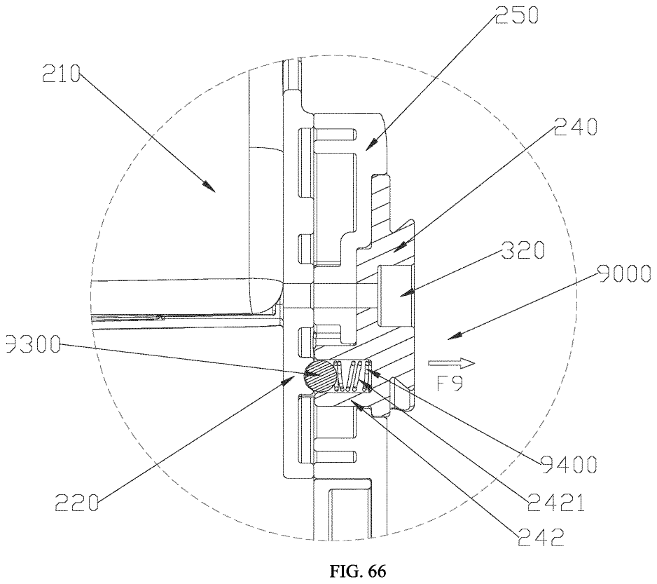

As shown in FIG. 66, a mounting boss 242 is disposed on the side of the fixed base 240 facing the connecting base 250. The mounting boss 242 is offset from the pivot shaft of the fixed base 240, that is, offset from the first central shaft. The mounting boss 242 is provided with an accommodating groove 2421. An opening of the accommodating groove 2421 faces the mounting base 220. The accommodating groove 2421 extends in a direction parallel to axes of rotation of the fixed base 240 and the mounting base 220, or in a direction parallel to the first central shaft. In this embodiment, the first positioning protrusion 9300 is a ball and is movably disposed in the accommodating groove 2421. However, in other embodiments, the first positioning protrusion 9300 may also be a pin with an arc surface or an inclined surface.

The first positioning protrusion 9300 has a locked position and an unlocked position. The first positioning protrusion 9300 is more adjacent to the backrest body 210 when being in the locked position than when being in the unlocked position. When the first positioning protrusion 9300 is in the locked position, the first positioning protrusion 9300 can be inserted into the first positioning recess 9100 or the second positioning recess 9200. When the first positioning protrusion 9300 is in the unlocked position, the first positioning protrusion 9300 is separated from the first positioning recess 9100 or the second positioning recess 9200. The fifth reset member 9400 is disposed in the accommodating groove 2421, and two ends of the fifth reset member 9400 abut against a bottom of the accommodating groove 2421 and the first positioning protrusion 9300, respectively. In this way, the fifth reset member 9400 biases the first positioning protrusion 9300 to move in a direction approaching the mounting base 220, that is, in a direction approaching the first positioning recess 9100 or the second positioning recess 9200. In this embodiment, the fifth reset member 9400 is a spring.

In this embodiment, as shown in FIG. 65, the fourth housing 252 is further provided with a mounting opening 2524 in communication with the fourth accommodation cavity 261. The mounting opening 2524 is generally arc-shaped, and the mounting boss 242 can extend into the fourth accommodation cavity 261 through the mounting opening 2524. When the fixed base 240 rotates relative to the first housing portion 2521, the mounting boss 242 can move along the arc-shaped mounting opening 2524, and the first positioning protrusion 9300 can be inserted into the first positioning recess 9100 or the second positioning recess 9200 accordingly.

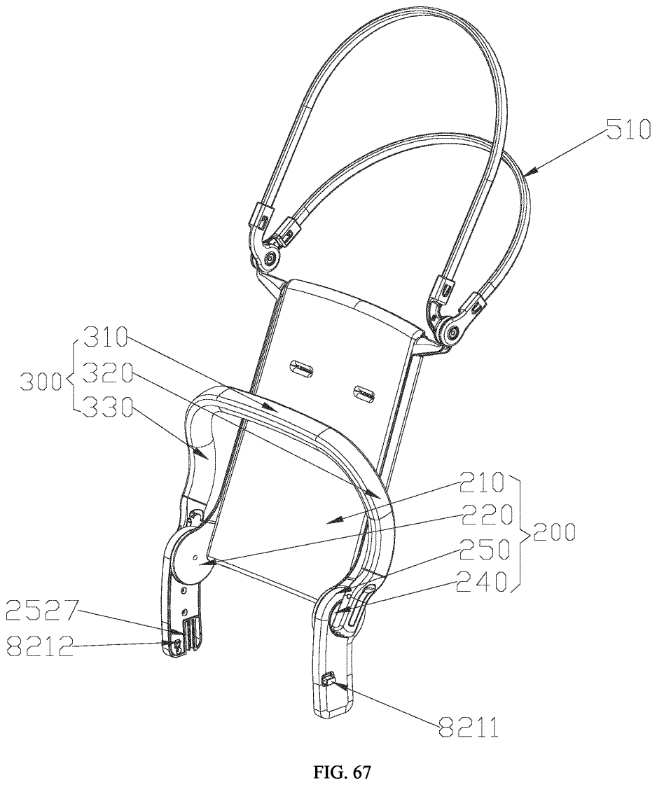

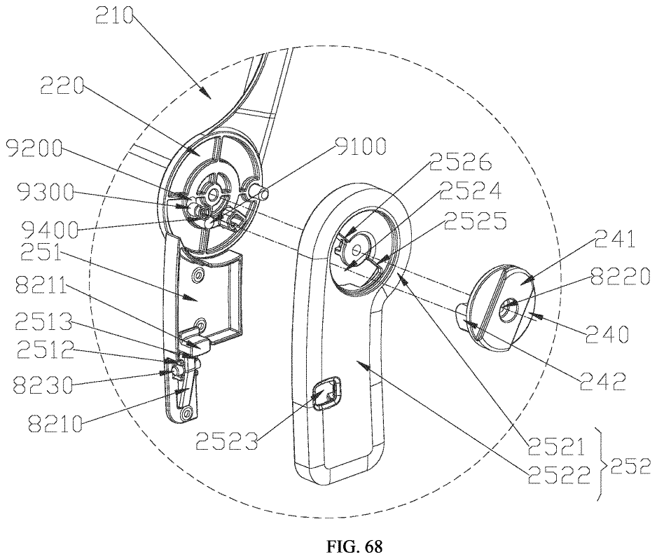

In this way, as shown in FIGS. 64 and 65, when the frame 100 is in the unfolded state, the first positioning protrusion 9300 is engaged into the first positioning recess 9100, and the armrest assembly 300 is in the unfolded state relative to the frame 100 (or backrest assembly 200). As shown in FIGS. 67 and 68, a certain external force can be applied to the armrest assembly 300. For example, the armrest body 310 can be pushed in a direction approaching the backrest body 210. In this case, the armrest assembly 300 drives the fixed base 240 to rotate relative to the fourth housing 252. Meanwhile, the fixed base 240 also drives the first positioning protrusion 9300 to be separated from the first positioning recess 9100 and move to the second positioning recess 9200 in a direction F8 shown in FIG. 65.

Referring to FIGS. 66 and 68, when the first positioning protrusion 9300 moves in the direction F8, the first positioning protrusion 9300 also moves in a direction F9 shown in FIG. 66 to switch from the locked position to the unlocked position. That is, the first positioning protrusion 9300 moves out from the first positioning recess 9100, but still abuts against a surface of the mounting base 220, so that the fifth reset member 9400 is compressed. When the first positioning protrusion 9300 moves with the fixed base 240 to the second positioning recess 9200, the first positioning protrusion 9300 moves in a reverse direction of the direction F9 under the elastic force of the fifth reset member 9400 to switch from the unlocked position to the locked position, and is then inserted into the second positioning recess 9200. At this time, the armrest assembly 300 is locked in the folded state as shown in FIG. 67. In this way, when the frame 100 is folded, there is no need to remove the armrest assembly 300 first. The armrest assembly 300 can be folded approaching the backrest body 210, thereby reducing the folded volume of the child carrier, making it convenient for storage, and the structure is simple and easy to implement.

The first positioning protrusion 9300 in this embodiment is implemented as the ball, and the first positioning recess 9100 and the second positioning recess 9200 are implemented as the hemispherical grooves that can be fitted with the ball, so that the ball can rotate smoothly in the hemispherical grooves. As such, when the armrest assembly 300 is rotated, the first positioning protrusion 9300 can relatively smoothly rotate out of or into the first positioning recess 9100 or the second positioning recess 9200, which can facilitate the free switching of the first positioning protrusion 9300 between the locked position and the unlocked position. In this way, while realizing the positioning function of the first positioning mechanism 9000, the armrest assembly 300 can easily rotate when subjected to external force.

As shown in FIG. 65, the mounting opening 2524 includes a first edge 2525 and a second edge 2526. When the first positioning protrusion 9300 is inserted into the first positioning recess 9100, the mounting boss 242 abuts against the first edge 2525. As shown in FIG. 68, when the first positioning protrusion 9300 is inserted into the second positioning recess 9200, the mounting boss 242 abuts against the second edge 2526. In this way, by adjusting the position and size of the mounting opening 2524, the rotation angle of the armrest assembly 300 can be limited.

In other embodiments, the first positioning recess 9100 and the second positioning recess 9200 may not necessarily be hemispherical grooves, they can be partial hemispherical grooves that can be fitted with the ball. In other embodiments, at least one third positioning recess (not shown in figures) into which the first positioning protrusion 9300 can be inserted can also be disposed between the first positioning recess 9100 and the second positioning recess 9200, so that the armrest assembly 300 can be fixed at multiple inclination angles relative to the backrest assembly 200 according to the actual needs. In other embodiments, the first positioning protrusion 9300 may not necessarily be a ball, and it can also be a pin-shaped structure or an ellipsoid structure. Shapes of the first positioning recess 9100 and the second positioning recess 9200 can also be changed as the shape of the first positioning protrusion 9300 changes, as long as the fitting between the first positioning protrusion 9300 and the first positioning recess 9100 and between the first positioning protrusion 9300 and the second positioning recess 9200 can be easily achieved, and which is not limited in this application.

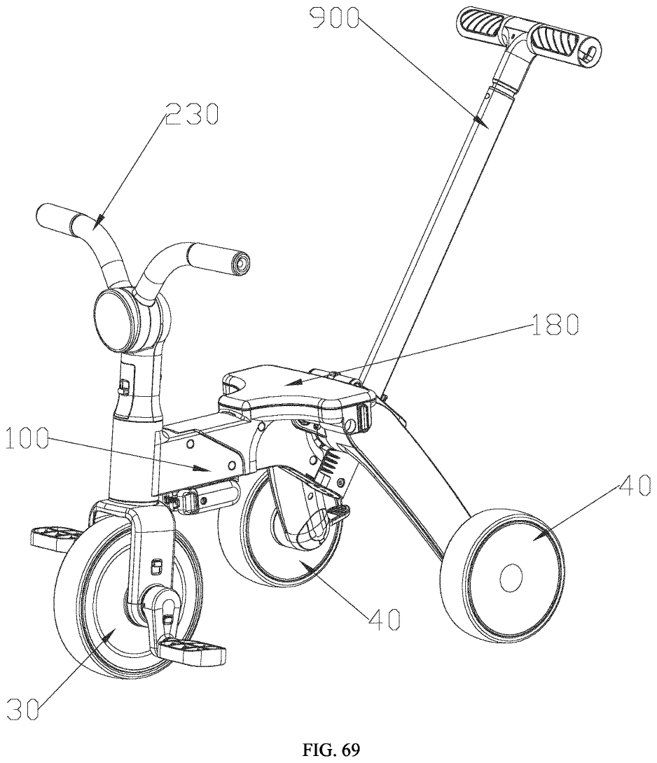

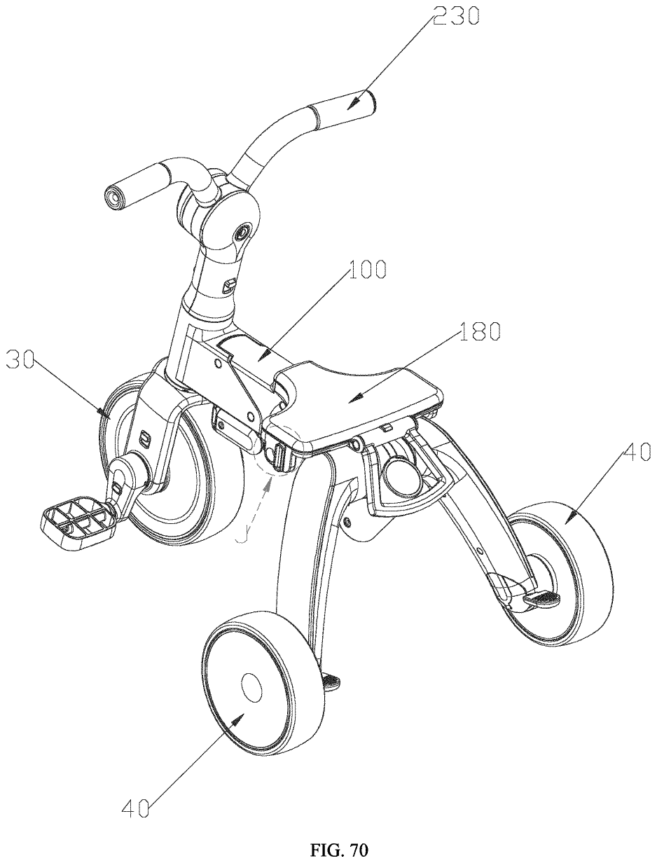

Further, as shown in FIG. 69, the backrest assembly 200 for supporting the child's back and the armrest assembly 300 for protecting the child can be removed as needed. As shown in FIG. 70, when the child can ride the child carrier independently, a pushing assembly 900 described later can be further removed. Details of the configuration of the pushing assembly 900 will be described later.

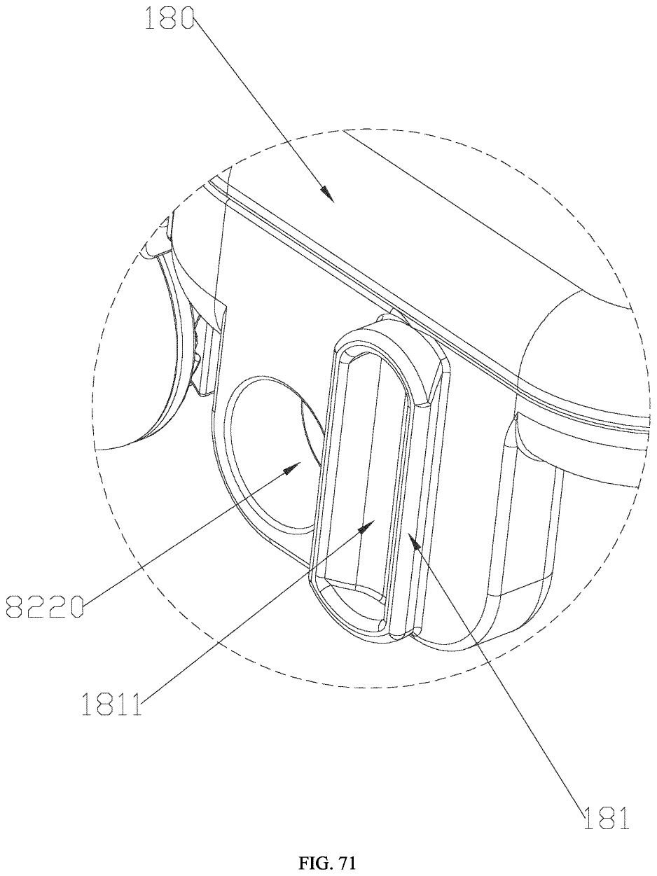

In this embodiment, as shown in FIGS. 71 to 73, the child carrier further includes a second locking mechanism 8200. The backrest assembly 200 is removably connected to the seat assembly 180 through the second locking mechanism 8200. In this embodiment, the second locking mechanisms 8200 are disposed on each of the left and right sides of the backrest assembly 200, so that the backrest assembly 200 is removably connected to the seat assembly 180 on the left and right sides. The structure and connection relationship of the second locking mechanism 8200 will be described in detail below, by taking one of the second locking mechanisms 8200 as an example.

The second locking mechanism 8200 includes a first locking element disposed on the connecting base 250 and a second locking element disposed on the seat assembly 180. The first locking element can be locked with or unlocked from the second locking element. In this embodiment, as shown in FIGS. 71 to 73, the first locking element is a fourth locking member 8210 movably disposed on the connecting base 250, and the second locking element is a fourth locking hole 8220 disposed on one side of the seat assembly 180. The fourth locking member 8210 can be locked into or unlocked from the fourth locking hole 8220.

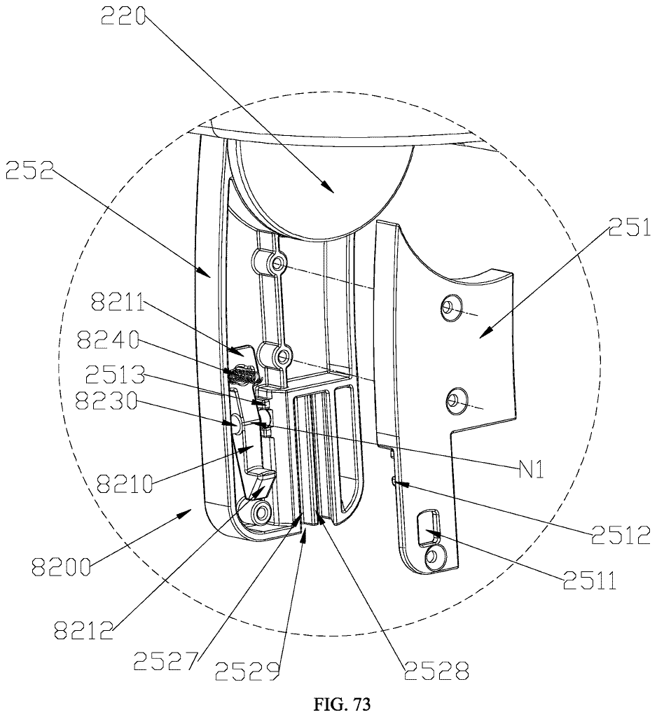

As shown in FIG. 73, the fourth locking member 8210 is a locking button, and the fourth locking member 8210 and the connecting base 250 are pivotally connected to each other at a second pivot point N1. The fourth locking member 8210 can rotate relative to the third housing 251 or the fourth housing 252 about the second pivot point N1. In this embodiment, a first pivot base 2512, and a second pivot base 2513 which is located approximately in the middle of the fifth accommodation cavity 262 are disposed between the third housing 251 and the fourth housing 252. The fourth locking member 8210 can rotatably disposed on the pivot pin 8230. The first pivot base 2512 and the second pivot base 2513 can be located on the third housing 251 or the fourth housing 252, as long as the fourth locking member 8210 can rotate. Both ends of the pivot pin 8230 are fixed to the first pivot base 2512 (as shown in FIG. 68) and the second pivot base 2513, respectively. The fourth locking member 8210 includes a second operating end 8211 and a second locking end 8212. The second pivot point N1 is disposed between the second operating end 8211 and the second locking end 8212.

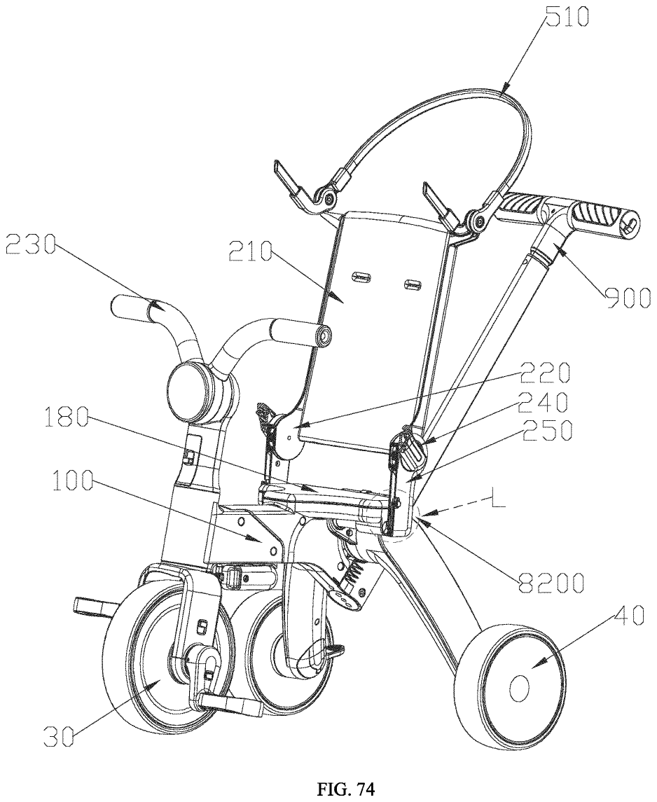

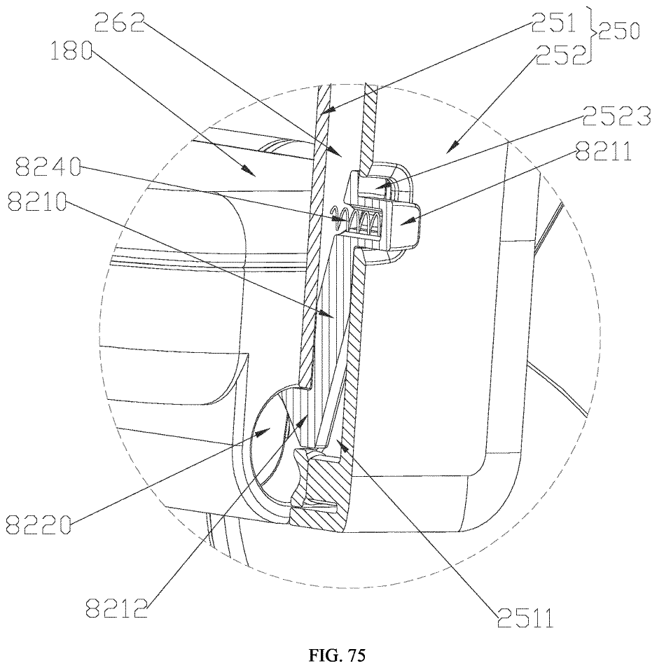

As shown in FIGS. 74 and 75, the second operating end 8211 at least partially extends out of the fifth accommodation cavity 262 through a second operating hole 2523 on the fourth housing 252. That is, the second operating end 8211 at least partially extends out of a surface (for example, an outer surface) of the fourth housing 252 away from the fifth accommodation cavity 262 through the second operating hole 2523, so that the user can press the second operating end 8211. The fourth housing 252 is further provided with a through hole 2511. The second locking end 8212 can extend through the through hole 2511 and be inserted into the fourth locking hole 8220, so as to enable the engagement between the connecting base 250 and the seat assembly 180, that is, the fixations between the backrest assembly 200 and the armrest assembly 300, and between the backrest assembly 200 and the seat assembly 180 (i.e., the frame 100).

Further, as shown in FIG. 75, the second locking mechanism 8200 further includes an eighth reset member 8240. The eighth reset member 8240 is disposed between the second operating end 8211 and the third housing 251. The eighth reset member 8240 biases the second operating end 8211 to move in a direction of driving the second locking end 8212 to be locked and fitted into the fourth locking hole 8220.

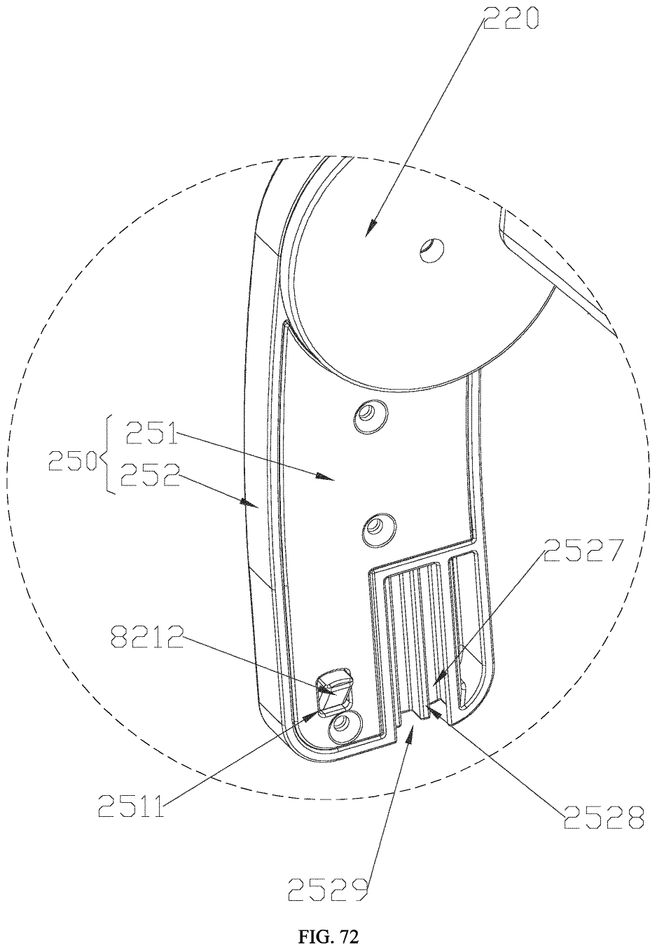

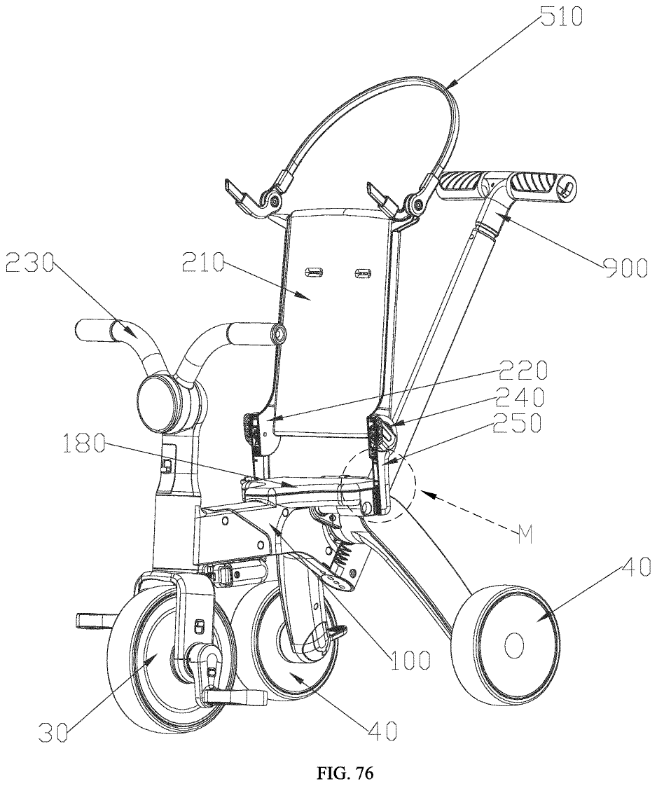

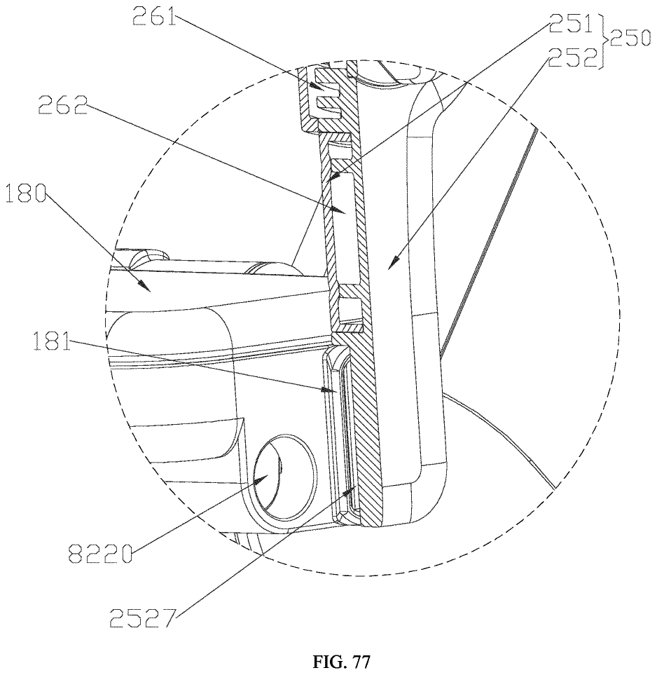

Further, as shown in FIGS. 76 and 77, a guide boss 181 is further disposed on a side of the seat assembly 180. Referring to FIGS. 70 and 71, a guide hole 1811 is disposed on the guide boss 181. The connecting base 250 is provided with a guide groove 2527. The guide boss 181 can be inserted and fitted into the guide groove 2527. Specifically, referring to FIG. 72, the guide groove 2527 is disposed on the side of the second housing portion 2522 facing the seat assembly 180. The third housing 251 only covers the part of the second housing portion 2522 except the guide groove 2527. A guide rib 2528 is disposed on the bottom of the guide groove 2527. In this embodiment, one guide rib 2528 is provided. In other embodiments, more than one guide rib 2528 can also be provided. An insertion opening 2529 is disposed on a sidewall of the guide groove 2527. In this embodiment, the insertion opening 2529 is disposed at the base of the guide groove 2527. In other embodiments, the guide boss 181 can also be disposed on the connecting base 250, and the guide groove 2527 can be disposed on the seat assembly 180, and which is not limited thereto.

In this way, when it is necessary to mount the backrest assembly 200 on the seat assembly 180, the connecting base 250 is inserted into the side surface of the seat assembly 180 from top to bottom. In this way, the guide boss 181 is inserted into the guide groove 2527 through the insertion opening 2529. At this time, the guide rib 2528 is located in the guide hole 1811, thereby mounting the backrest assembly 200 on the seat assembly 180 more accurately. In addition, the second locking end 8212 of the fourth locking member 8210 is inserted into the fourth locking hole 8220, so that the backrest assembly 200 is locked and fixed on the seat assembly 180 through the second locking mechanism 8200. When it is necessary to remove the backrest assembly 200 from the seat assembly 180, it only needs to press the second operating end 8211 of the fourth locking member 8210 to rotate the second operating end 8211 around the second pivot point N1, so as to drive the second locking end 8212 to move away from the seat assembly 180 and to be disengaged from the fourth locking hole 8220, thereby enabling the unlocking of the second locking mechanism 8200. At this time, the backrest assembly 200 can be pulled upward, so that the guide boss 181 moves out of the guide groove 2527 through the insertion opening 2529, and the backrest assembly 200 can be removed.

The child carrier including the armrest assembly 300 has at least the following technical effects.

In the child carrier including the above-mentioned armrest assembly 300, when the frame 100 is in the unfolded state, the armrest assembly 300 can be fixed in the first position relative to the frame 100 through the first positioning mechanism 9000. When the frame 100 is in the folded state, the armrest assembly 300 can be fixed in the second position relative to the frame 100 through the first positioning mechanism 9000. In this way, by reasonably setting the first position and the second position, the armrest assembly 300 can be unfolded for use when the frame 100 is unfolded, and the armrest assembly 300 can be folded when the frame 100 is folded, so as to reduce the overall volume of the child carrier, which is easy to use and simple in structure. In addition, when the overall frame 100 is folded, there is no need to remove the armrest assembly 300 first, which is easy to operate.

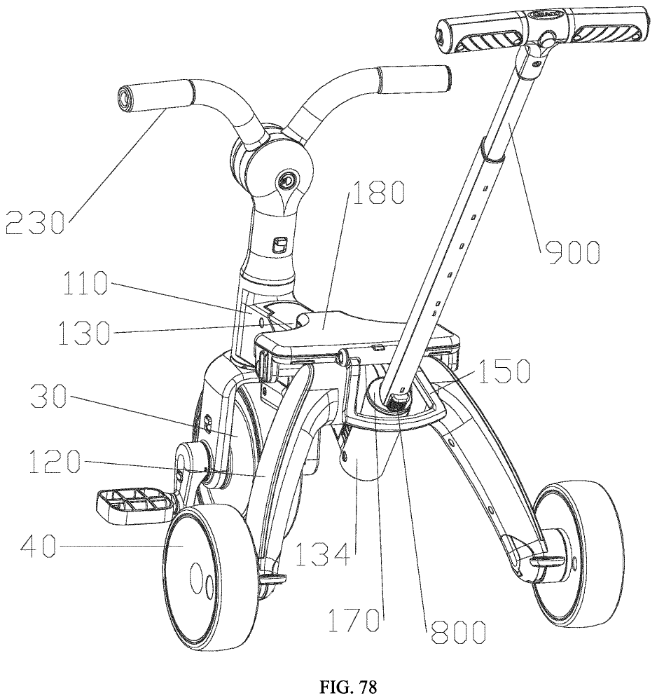

In an embodiment, as shown in FIGS. 51 and 78, the child carrier further includes a first fixing mechanism 800 and the pushing assembly 900. The pushing assembly 900 is removably disposed on the frame 100 and is located behind the backrest assembly 200. A pushing rod mounting base 170 is disposed on the rotating base 134 of the frame 100. The pushing assembly 900 is removably connected to the pushing rod mounting base 170 through the first fixing mechanism 800. When the pushing assembly 900 is connected to the frame 100, the pushing assembly 900 does not interfere with the rotation of the driving handle 152. That is, even if the pushing assembly 900 is not removed, the rotation of the driving handle 152 is not affected by the pushing assembly 900.

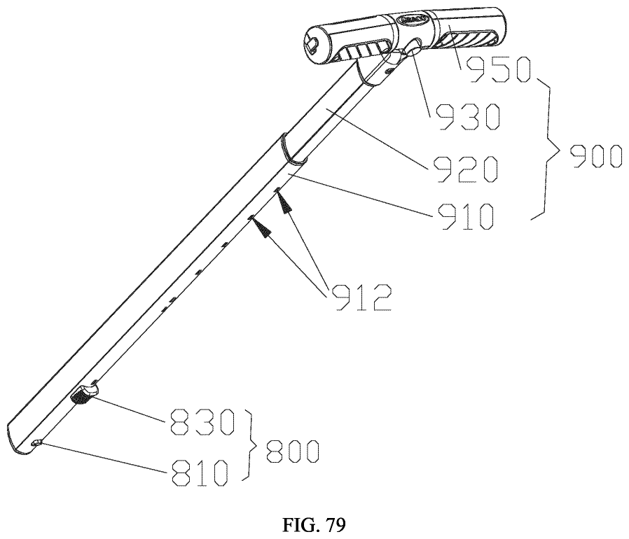

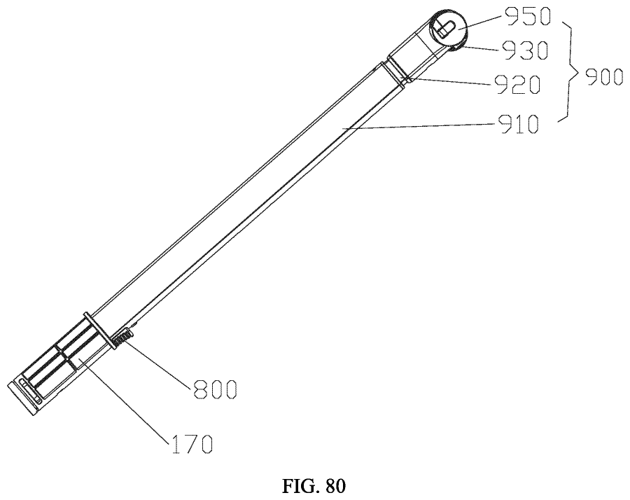

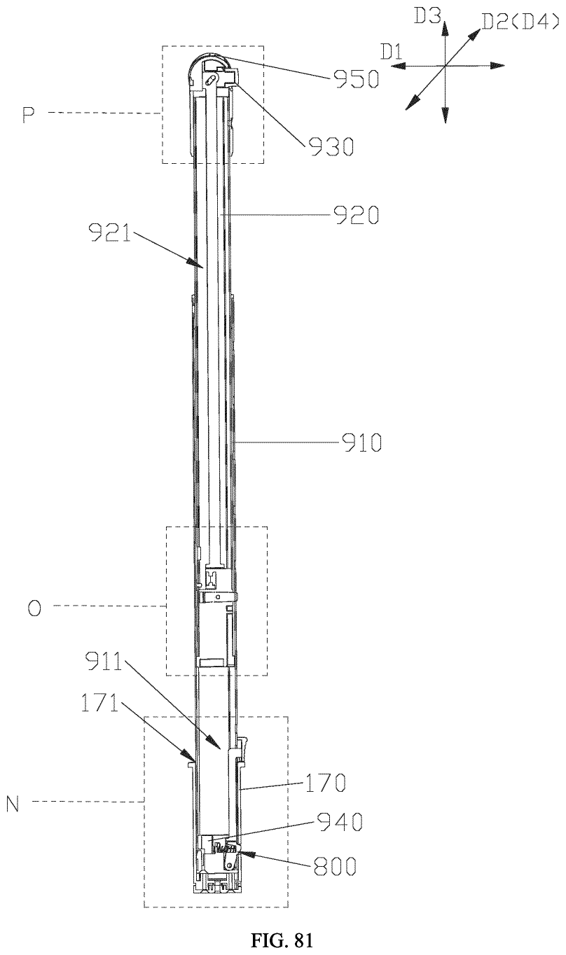

As shown in FIGS. 79 to 82, the first fixing mechanism 800 includes a first locking member 810, a first driving member 820, a first operating member 830, and a third reset member 840. The first locking member 810 is connected to the first operating member 830 through the first driving member 820. The first locking member 810 is movably connected to the pushing assembly 900. Specifically, in this embodiment, the pushing assembly 900 is provided with a second receiving cavity 911. The second receiving cavity 911 extends substantially parallel to an extending direction of the pushing assembly 900. A first via hole 913 is disposed on a sidewall of the second receiving cavity 911. The first locking member 810 is disposed in the second receiving cavity 911 and is pivotally connected to the pushing assembly 900. In other embodiments, the first locking member 810 may not be pivotally connected to the pushing assembly 900. The first locking member 810 has a first locked position and a first unlocked position. When the first locking member 810 is in the first locked position, the first locking member 810 is engaged with the pushing rod mounting base 170. When the first locking member 810 is in the first unlocked position, the first locking member 810 is disengaged from the pushing rod mounting base 170. Specifically, the first locking member 810 is provided with a first locking protrusion 811, the pushing rod mounting base 170 is provided with a first mounting groove 171. A groove wall of the first mounting groove 171 is provided with a first locking hole 172. When the first locking member 810 is in the first locked position, the first locking protrusion 811 extends through the first via hole 913 and is engaged with the first locking hole 172. When the first locking member 810 moves or rotates to the first unlocked position, the first locking protrusion 811 exits the first locking hole 172 and is disengaged from the first locking hole 172.

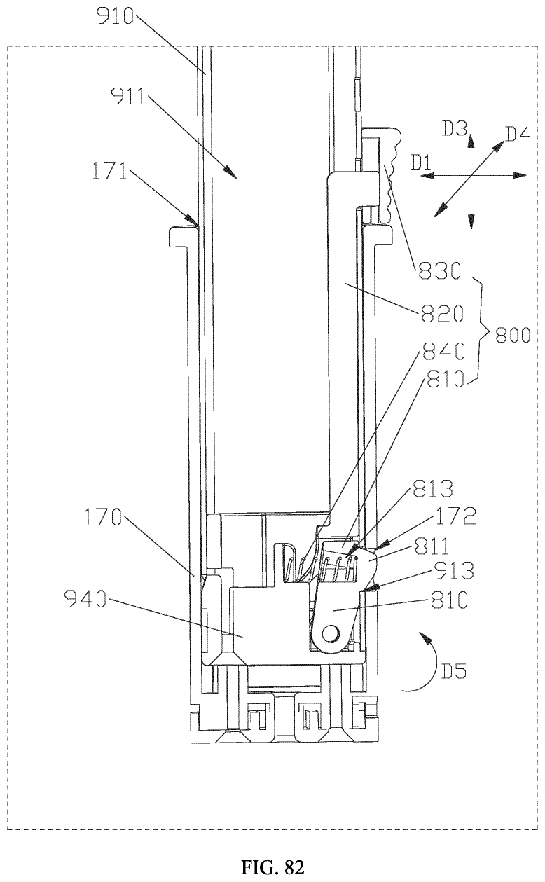

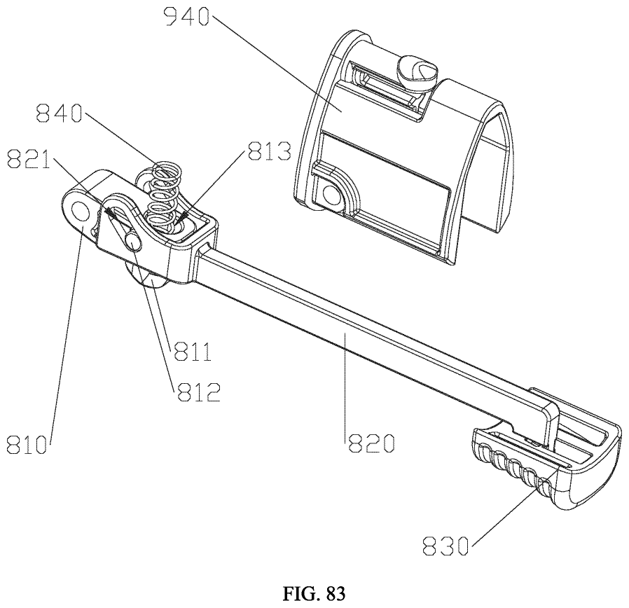

Continuing to refer to FIGS. 82 and 83, the first driving member 820 is movably disposed in the second receiving cavity 911. A first driving groove 821 is disposed at one end of the first driving member 820. An extending direction of the first driving groove 821 intersects and is not perpendicular to a moving direction of the first operating member 830. The first locking member 810 includes a first driving pin 812. The first driving pin 812 is inserted into the first driving groove 821 and can move along the first driving groove 821. Another end of the first driving member 820 away from the first driving groove is connected to the first operating member 830. When the first operating member 830 is moved in the extending direction of the pushing assembly 900, the first operating member 830 drives the first driving member 820 to move in the same direction, so that the first driving pin 812 moves along the first driving groove 821, which in turn drives the first locking member 810 to rotate to enable the first locking member 810 to be switched between the first locked position and the first unlocked position. In other embodiments, the first driving member 820 may be omitted. For example, the first locking member 810 can be directly connected to the first operating member 830, and the first locking member 810 can be driven to be switched between the first locked position and the first unlocked position by pressing or pushing the first operating member 830.

Referring to FIG. 82, the first operating member 830 is movably disposed on the pushing assembly 900, and can move in the extending direction of the pushing assembly 900. Specifically, in this embodiment, the first operating member 830 at least partially extends out of an outer peripheral surface of the pushing assembly 900 to facilitate user operation. In other embodiments, the first operating member 830 may not extend out of the outer peripheral surface of the pushing assembly 900. For example, the first operating member 830 may be located in the second receiving cavity 911 of the pushing assembly 900. The pushing assembly 900 is provided with an operation opening (not shown in figures) in communication with the second receiving cavity 911. The user can push and pull the first operating member 830 by inserting his fingers into the second receiving cavity 911 through the operation opening. In short, the first operating member 830 may be configured as need, as long as the first operating member 830 can be operated. The third reset member 840 may be an elastic member, such as a spring or an elastic piece. In this embodiment, the third reset member 840 is a spring. The third reset member 840 is disposed in the second receiving cavity 911. A first end of the third reset member 840 abuts against the pushing assembly 900, and a second end of the third reset member 840 abuts against the first locking member 810. The third reset member 840 biases first locking member 810 to move toward the first locked position. Specifically, the pushing assembly 900 further includes an abutting member 960. The first end of the third reset member abuts against the abutting member 960. In order to prevent the third reset member 840 from being offset from the first locking member 810 during the force application, the first locking member 810 is provided with a second groove 813. The third reset member 840 is at least partially located in the second groove 813, and the second end of the third reset member 840 abuts against the bottom of the second groove 813.

The process by which the pushing assembly 900 is removed will be described below in detail.

As shown in FIGS. 82 and 83, when the pushing assembly 900 needs to be removed from the frame 100, the first operating member 830 is moved in the direction D3, so that the first operating member 830 drives the first driving member 820 to move in the direction D3. At the same time, the first driving member 820 drives the first locking member 810 to rotate in the direction D5 through the cooperation of the first driving groove 821 and the first driving pin 812. The third reset member 840 is compressed, so that the first locking protrusion 811 of the first locking member 810 retracts from the first locking hole 172, the first fixing mechanism 800 is unlocked, and the pushing assembly 900 can be removed from the first mounting groove 171.

Reversely, when the pushing assembly 900 needs to be remounted on the frame 100, the end of the pushing assembly 900 connected to the first locking member 810 is inserted into the first mounting groove 171. When the first locking member 810 moves to face the first locking hole 172, under the elastic force of the third reset member 840, the first locking protrusion 811 is re-engaged into the first locking hole 172, so that the pushing assembly 900 is remounted on the frame 100.

As shown in FIG. 79, the pushing assembly 900 includes a first connecting rod 910, a second connecting rod 920, and a length adjustment mechanism 930. The second connecting rod 920 is at least partially inserted into the first connecting rod 910, and can move relative to the first connecting rod 910 in the extending direction of the first connecting rod 910. The length adjustment mechanism 930 has a locked state and an unlocked state. When the length adjustment mechanism 930 is in the unlocked state, the second connecting rod 920 moves relative to the first connecting rod 910 to extend or contract the pushing assembly 900. When the length adjustment mechanism 930 is in the locked state, the second connecting rod 920 and the first connecting rod 910 are fixed relative to each other, that is, the length of the pushing assembly 900 is fixed.

Referring to FIG. 82, the first connecting rod 910 is inserted into the first mounting groove 171 of the pushing rod mounting base 170. At least one end of the first connecting rod 910 is hollow. In this embodiment, the entire first connecting rod 910 is a hollow rod, and the second receiving cavity 911 is formed inside and extends through two ends of the first connecting rod 910.

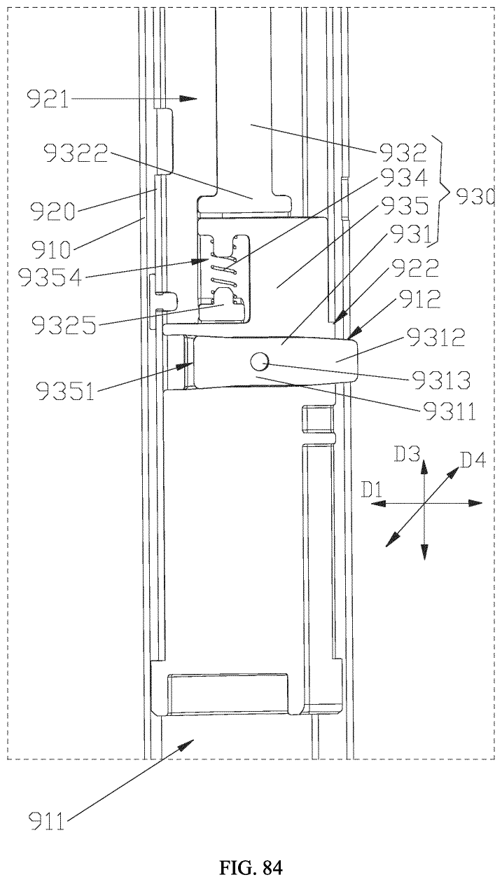

Further, the pushing assembly 900 may further include a locking mounting base 940. The locking mounting base 940 is disposed at an end of the first connecting rod 910, and at least a part of the locking mounting base 940 extends into the second receiving cavity 911. The first locking member 810 is pivotally connected to the locking mounting base 940. Referring to FIGS. 79 to 81, another end of the first connecting rod 910 is connected to the second connecting rod 920. Specifically, one end of the second connecting rod 920 is inserted into the second receiving cavity 911, and another end of the second connecting rod 920 is provided with a push handle 950. Further, referring to FIG. 84, the second connecting rod 920 is provided with a third receiving cavity 921 extending substantially parallel to its extending direction. The second connecting rod 920 is provided with a second via hole 922. The second via hole 922 extends through a sidewall of the third receiving cavity 921.

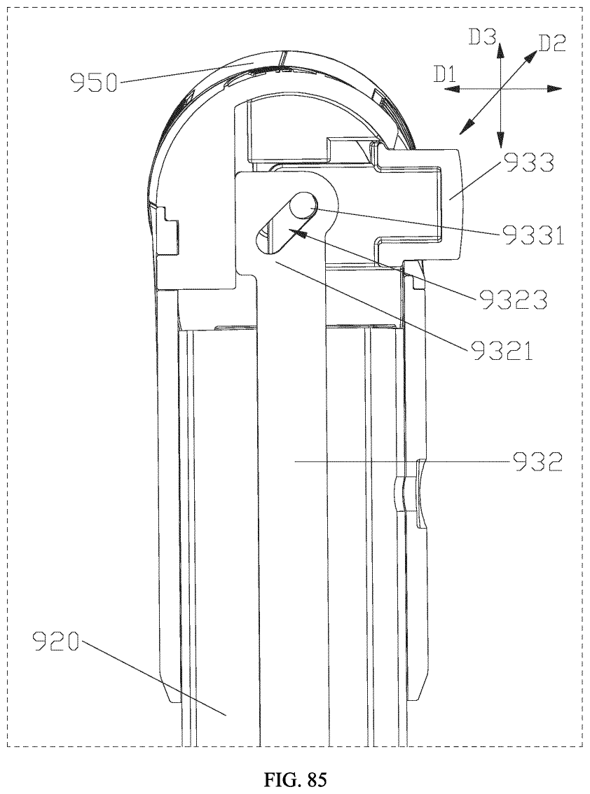

Specifically, as shown in FIGS. 84 and 85, the length adjustment mechanism 930 includes a second locking member 931, a second driving member 932, a second operating member 933, a fourth reset member 934, and a guide base 935. The second locking member 931 is connected to the second operating member 933 through the second driving member 932. The second locking member 931 includes a second movable connecting portion 9311 and a second locking portion 9312. The second movable connecting portion 9311 is disposed in the third receiving cavity 921 and is movably connected to the second driving member 932. The first connecting rod 910 is provided with at least two second locking holes 912. The second locking member 931 has a second locked position and a second unlocked position. When the second locking member 931 is in the second locked position, the second locking portion 9312 can extend through the second via hole 922 and be engaged with any one of the second locking holes 912. When the second locking portion 9312 is in the second unlocked position, the second locking member 931 is disengaged from the second locking hole 912. In this embodiment, the second locking member 931 is integrally formed. In other embodiments, the second locking member 931 may also be formed by connecting the second movable connecting portion 9311 and the second locking portion 9312 that are independent of each other by welding, soldering, etc.

Specifically, as shown in FIGS. 84 and 85, the second driving member 932 includes an operating connecting portion 9321 and a driving connecting portion 9322. The operating connecting portion 9321 is movably connected to the second operating member 933. Specifically, one of the operating connecting portion 9321 and the second operating member 933 may be provided with a second driving groove 9323, and another of the operating connecting portion 9321 and the second operating member 933 may be provided with a second driving pin 9331. An extending direction D2 of the second driving groove 9323 intersects and is not perpendicular to a moving direction D1 of the second operating member 933. The extending direction D2 of the second driving groove 9323 intersects and is not perpendicular to a moving direction D3 of the second driving member 932. The second driving pin 9331 is inserted into the second driving groove 9323 and can move along the second driving groove 9323.

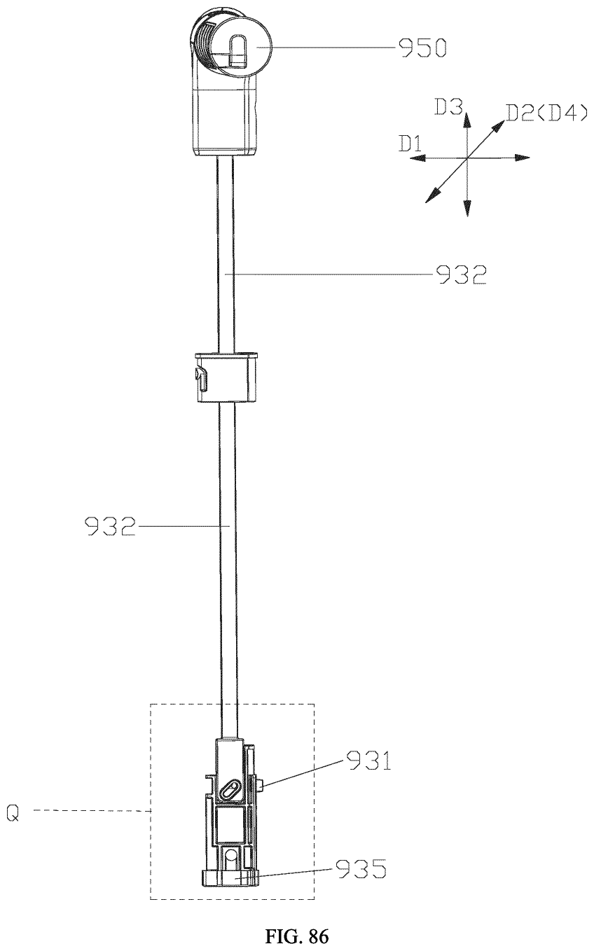

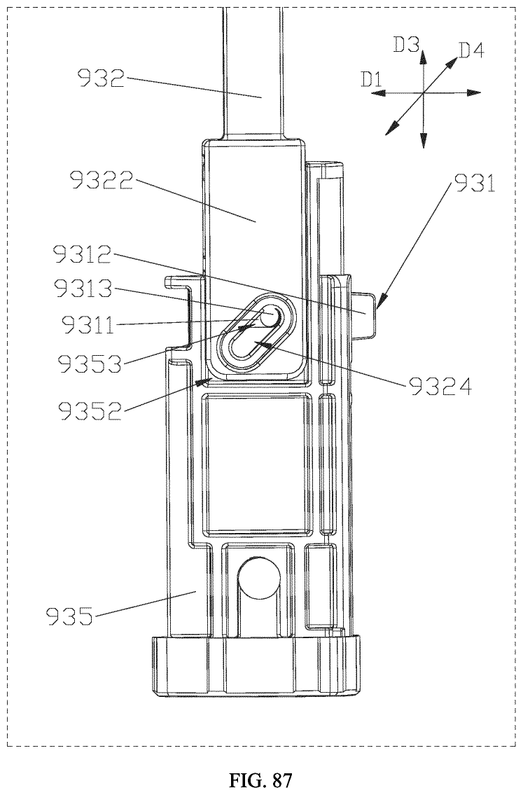

As shown in FIGS. 86 and 87, the driving connecting portion 9322 is movably connected to the second movable connecting portion 9311 of the second locking member 931. One of the driving connecting portion 9322 and the second locking portion 931 is provided with a third driving groove 9324, and another of the driving connecting portion 9322 and the second locking portion 931 is provided with a third driving pin 9313. An extending direction D4 of the third driving groove 9324 intersects and is not perpendicular to the moving direction D1 of the second operating member 933. The extending direction D4 of the third driving groove 9324 intersects and is not perpendicular to the moving direction D3 of the second driving member 932. The third driving pin 9313 is inserted into the third driving groove 9324 and can move along the third driving groove 9324. In this embodiment, the extending direction D2 of the second driving groove 9323 and the extending direction D4 of the third driving groove 9324 are parallel to each other and are in the same direction. In other embodiments, the extending direction D2 of the second driving groove 9323 and the extending direction D4 of the third driving groove 9324 may not be parallel to each other, and may be two different directions.

Specifically, in this embodiment, the operating connecting portion 9321 is provided with the second driving groove 9323, the second operating member 933 is provided with the second driving pin 9331, the driving connecting portion 9322 is provided with the third driving groove 9324, and the second locking member 931 is provided with the third drive pin 9313. Driven by the second driving groove 9323 and the third driving groove 9324, the second locking member 931 can be moved in a direction substantially parallel to the moving direction of the second operating member 933, or can also be moved in a direction at an arbitrary angle to the moving direction of the second operating member 933. In other words, the moving direction of the second locking member 931 may not be limited by the moving direction and mounting position of the second operating member 933. By adjusting the extending directions of the second driving groove 9323 and the third driving groove 9324, the second operating member 933 can drive the second locking member 931 to move in a predetermined direction, so that the second operating member 933 can be disposed at a more user-friendly position.

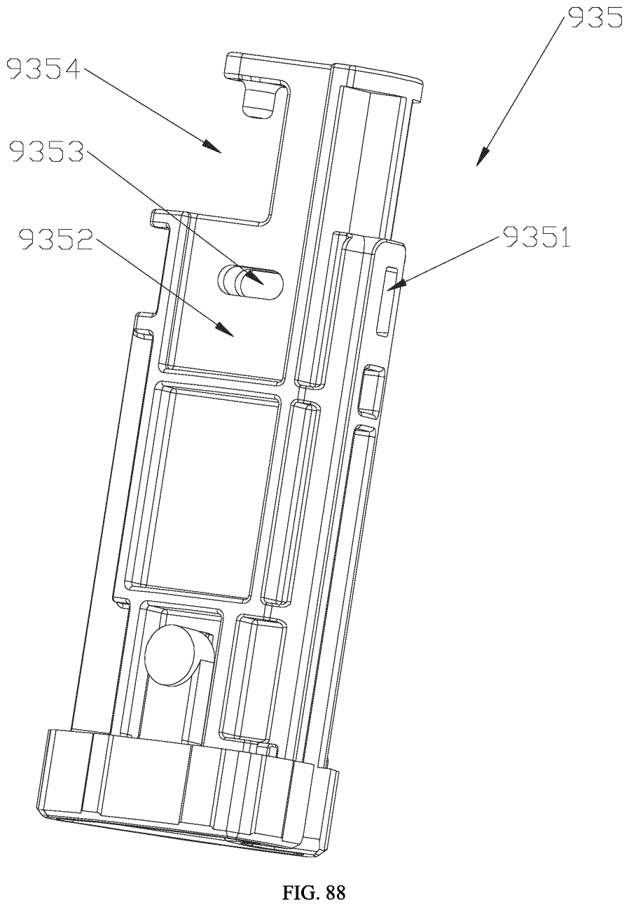

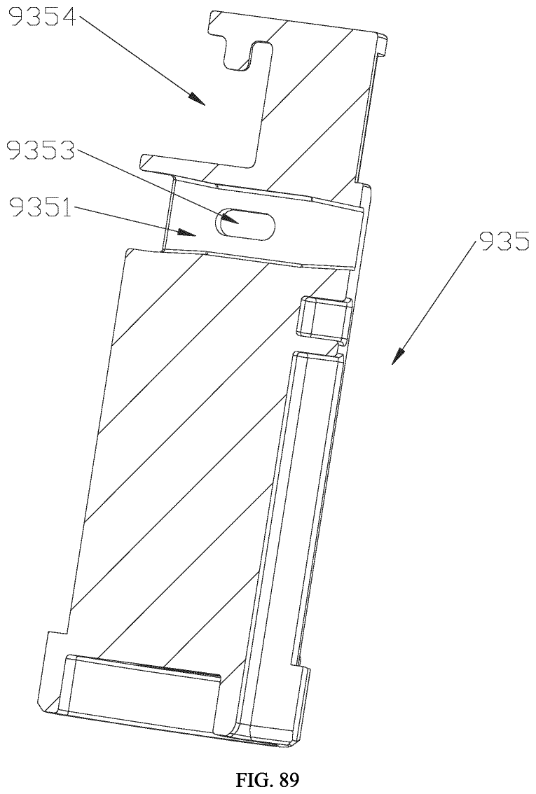

Referring to FIG. 84, and 87 to 89, the guide base 935 is disposed in the third receiving cavity 921. The guide base 935 includes a first receiving groove 9351, a second receiving groove 9352, and an elongated hole 9353 extending through the first receiving groove 9351 and the second receiving groove 9352. An extending direction of the first receiving groove 9351 and an extending direction of the elongated hole 9353 respectively intersect an extending direction of the second receiving groove 9352. For example, the extending direction of the elongated hole 9353 and the extending direction of the first receiving groove 9351 are parallel to each other, and both the direction D1. The extending direction of the second receiving groove 9352 is the direction D3, which is perpendicular to the extending direction of the first receiving groove 9351 and the extending directions of the elongated holes 9353. The second locking member 931 is movably disposed in the first receiving groove 9351 and can move along the first receiving groove 9351. The second locking member 931 can be limited to move in the predetermined direction D1 through the first receiving groove 9351. The second driving member 932 is movably disposed in the second receiving groove 9352 and can move along the second receiving groove 9352. The second driving member 932 can be limited to move in the predetermined direction D3 through the second receiving groove 9352. In this embodiment, referring to FIGS. 88 and 89, the first receiving groove 9351 transversely extends through the guide base 935. The second receiving groove 9352 is disposed on the outer peripheral surface of the guide base 935. The elongated hole 9353 extends through the outer peripheral surface of the guide base 935 and is in communication with the first receiving groove 9351 and the second receiving groove 9352. The third driving pin 9313 extends through the elongated hole 9353 to connect the second locking member 931 and the second driving member 932. In another embodiment, the first receiving groove 9351 and the second receiving groove 9352 may be disposed on opposite side surfaces of the guide base 935, respectively.

As shown in FIG. 84, the fourth reset member 934 is disposed between the second driving member 932 and the guide base 935. The fourth reset member 934 biases the second driving member 932 to move in a direction driving the second locking member 931 to move to the second locked position, that is, in a direction reversed to the direction D3. The fourth reset member 934 may be an elastic member, such as a spring or an elastic piece. In this embodiment, the fourth returning member 934 is a spring. Specifically, the guide base 935 is provided with a third receiving groove 9354. The second driving member 932 includes an abutting portion 9325. The abutting portion 9325 at least partially extends into the third receiving groove 9354. One end of the fourth reset member 934 abuts against the abutting portion 9325, and another end of the fourth reset member 934 abuts against a groove wall of the third receiving groove 9354.

The length adjustment process of the pushing assembly 900 in this embodiment will be described in detail below.

As shown in FIG. 85, when it is necessary to adjust the length of the pushing assembly 900, the second operating member 933 is pressed in the direction D1, and then the second operating member 933 drives the second driving member 932 to move in the direction D3 through the cooperation of the second driving groove 9323 and the second driving pin 9331, and the fourth reset member 934 is compressed. As shown in FIGS. 86 and 87, then the second driving member 932 drives the second locking member 931 to move in the direction D1 through the cooperation of the third driving groove 9324 and the third driving pin 9313. When the second locking member 931 moves to the second locking portion 9312 and is disengaged from a certain second locking hole 912, the length adjustment mechanism 930 is unlocked, so that the second connecting rod 920 can move relative to the first connecting rod 910. In this case, the second connecting rod 920 is moved relative to the first connecting rod 910 to adjust the overall length of the pushing assembly 900.

When the second connecting rod 920 is required to move to be opposite to another second locking hole 912, the pressing force on the second operating member 933 may be removed, and the second driving member 932 moves in the direction reversed to the direction D3 under the action of elastic force of the fourth reset member 934. At the same time, the second driving member 932 drives the second locking member 931 to move in the direction reversed to the direction D1 to re-insert the second locking portion 9312 into the other second locking hole 912 through the cooperation of the third driving groove 9324 and the third driving pin 9313, so that the second connecting rod 920 and the first connecting rod 910 are locked again. At the same time, the second driving member 932 also drives the second operating member 933 to move and reset in the reversed direction of the direction D1 through the cooperation of the second driving groove 9323 and the second driving pin 9331.

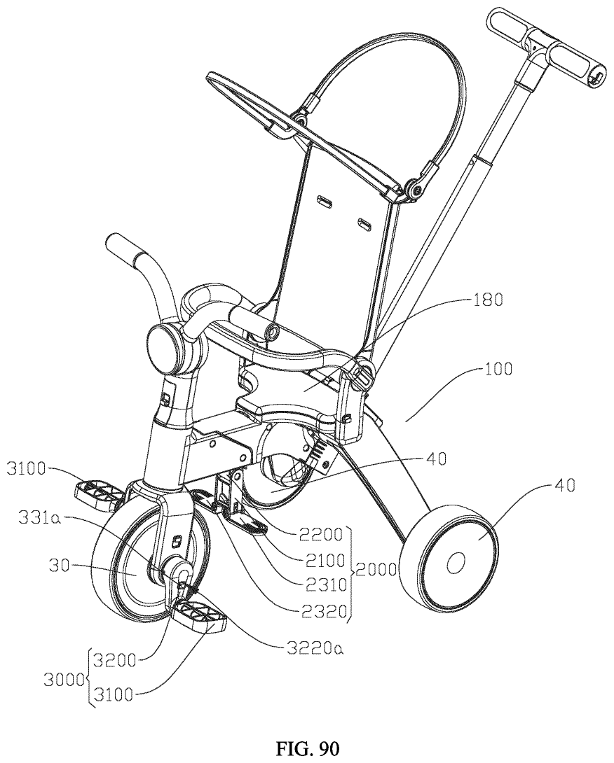

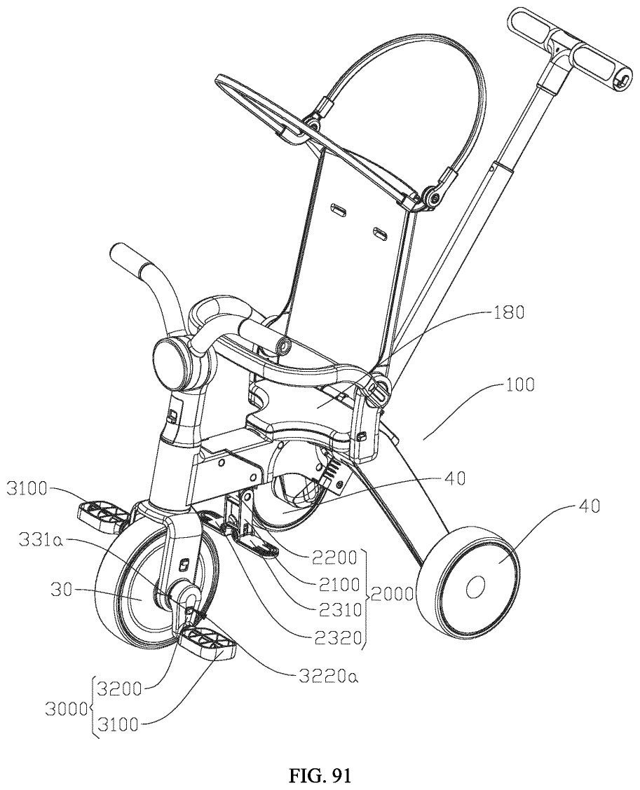

In an embodiment, as shown in FIG. 90, the child carrier further includes a footrest device 2000 and a pedal device 3000. The above-mentioned front wheel 30 and the rear wheels 40 may form a wheel assembly 20. In this way, the seat assembly 180 is disposed approximately in the middle of the frame 100. The footrest device 2000 is connected to the frame 100 and located below the frame 100, and is located between the wheel assembly 20 and the seat assembly 180. The footrest device 2000 has a use state (as shown in FIG. 90) and a non-use state (as shown in FIG. 91) relative to the frame 100. During the travelling of the child carrier, the footrest device 2000 can be maintained in the use state relative to the frame 100. In this case, the footrest device 2000 can be configured to carry the child's feet, so that the child can place both feet on the footrest device 2000, in order to get adequate rest, so that the child will not get tired easily due to hanging the feet in the air for a long time or riding for a long time. In addition, in this embodiment, the pedal device 3000 is drivingly connected to the front wheel 30, so that the front wheel 30 can be rotated by stepping on the pedal component 3100, enabling the child carrier as a whole to move forward.

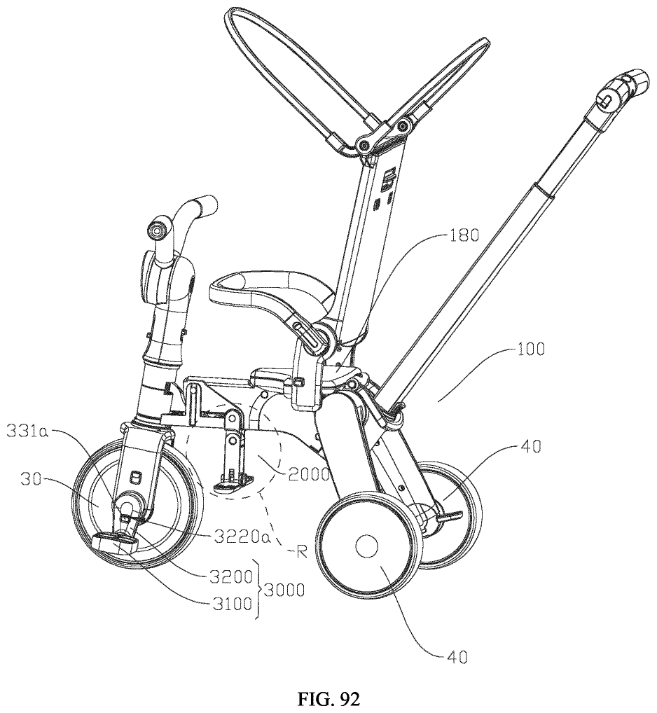

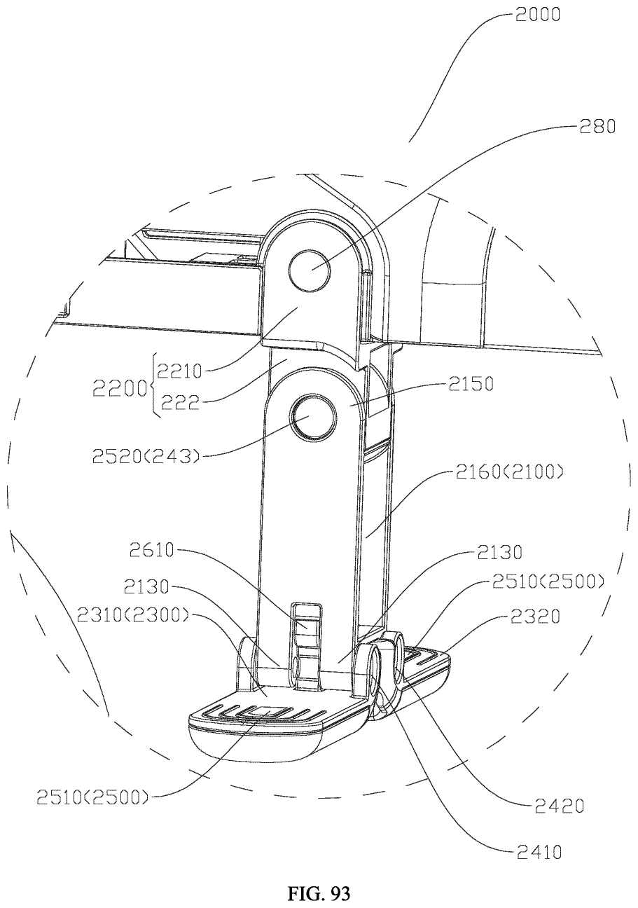

Specifically, the footrest device 2000 may be in various forms. For example, in a first example, as shown in FIGS. 92 and 93, the footrest device 2000 includes a footrest component 2300, a support member 2100, and a connecting member 2200. When the footrest device 2000 is in the use state, the support member 2100 is in a first rotation position, and the footrest component 2300 is in an unfolded state. When the footrest device 2000 is in the non-use state, the support member 2100 is in a second rotation position, and the footrest component 2300 is in a folded state.

In this example, the footrest component 2300 includes a first footrest 2310 and a second footrest 2320. The first footrest 2310 and the second footrest 2320 are pivotally connected to one end of the support member 2100 through a third pivot shaft 2410 and a fourth pivot shaft 2420. Another end of the support member 2100 is pivotally connected to the connecting member 2200 through a rotating shaft 243. An end of the connecting member 2200 away from the support member 2100 is fixed to the frame 100.

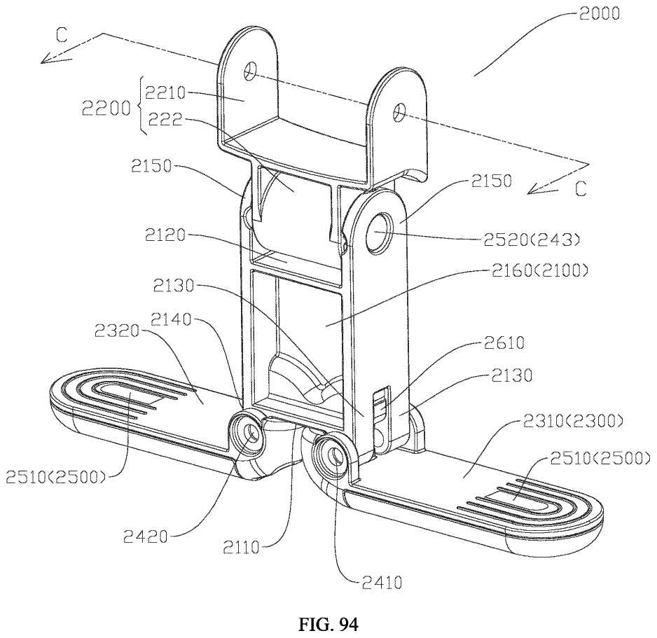

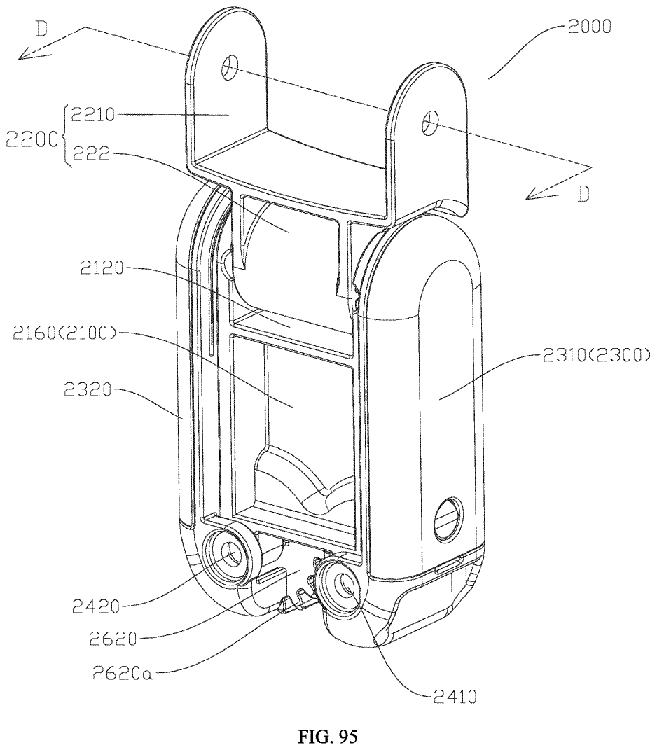

Specifically, as shown in FIGS. 94 to 96, the support member 2100 includes a support body 2160. The support body 2160 has a substantially rectangular structure. The rectangular structure includes a first end surface 2110 and a second end surface 2120 at both ends. Two third connecting portions 2130 and two fourth connecting portions 2140 protrude from the first end surface 2110. The first footrest 2310 is pivoted to the two third connecting portions 2130 through the third pivot shaft 2410, and the second footrest 2320 is pivoted to the two fourth connecting portions 2140 through the fourth pivoting shaft 2420. Both the first footrest 2310 and the second footrest 2320 have an unfolded state and a folded state relative to the support member 2100. When the first footrest 2310 or the second footrest 2320 is in the unfolded state, as shown in FIG. 94, the first footrest 2310 or the second footrest 2320 can be configured to carry the child's feet. When the first footrest 2310 or the second footrest 2320 is in the folded state, as shown in FIG. 95, the first footrest 2310 or the second footrest 2320 moves toward the support member 2100 and is folded.

Further, as shown in FIGS. 94 and 95, the footrest device 2000 further includes a fixing component 2500. In this embodiment, the fixing component 2500 is disposed between the first footrest 2310 and the support member 2100, and between the second footrest 2320 and the support member 2100. When the first footrest 2310 (or the second footrest 2320) is in the folded state, the first footrest 2310 (or the second footrest 2320) can be fixed to the corresponding side of the support member 2100 through the fixing component 2500.

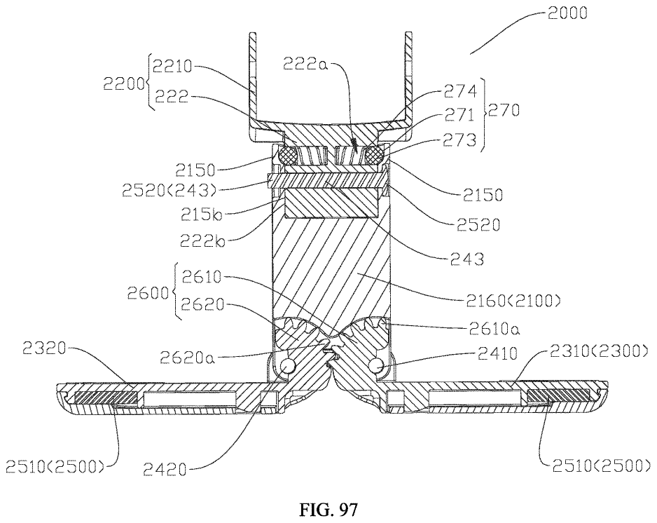

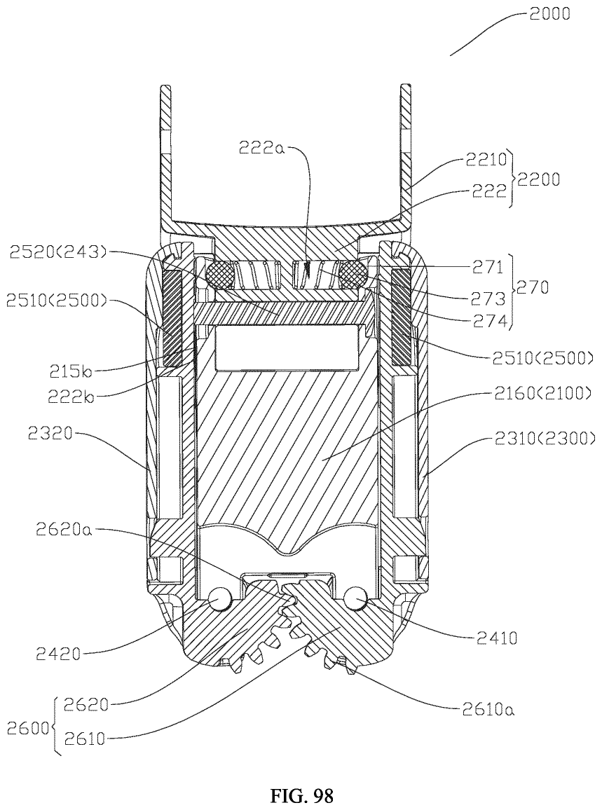

The fixing component 2500 located between the first footrest 2310 and the support 2100 is taken as an example for illustration. As shown in FIGS. 94, 97 and 98, the fixing component 2500 includes a first magnetic member 2510 disposed on the first footrest 2310 and a second magnetic member 2520 disposed on the support member 2100. When the first footrest 2310 is in the folded state, the first magnetic member 2510 and the second magnetic member 2520 can attract each other. In this example, the first magnetic member 2510 may be a permanent magnet embedded in the first footrest 2310. The second magnetic member 2520 may be integrally formed with the rotating shaft 243. Specifically, the rotating shaft 243 can be made of ferromagnetic material, such as iron, cobalt, or nickel. Two ends of the rotating shaft 243 extend out of both sides of the support member 2100 to form the two second magnetic member 2520. As shown in FIG. 98, when the first footrest 2310 and the second footrest 2320 are in the folded state, the first magnetic members 2510 of the first footrest 2310 and the second footrest 2320 can attract the two magnetic members 2520 respectively, so that the first footrest 2310 and the second footrest 2320 can be fixed in the folded state. When it is necessary to switch the first footrest 2310 (or the second footrest 2320) from the folded state to the unfolded state as shown in FIG. 97, it is sufficient to apply a certain force to the first footrest 2310 (or the second footrest 2320) to overcome the magnetic attraction force between the first magnetic member 2510 and the second magnetic member 2520. In this way, the rotating shaft 243 not only can be pivotally connected to the support member 2100 and the connecting member 2200, but also can attract and fix the first footrest 2310 and the second footrest 2320 without disposing an additional second magnetic member 2520. Therefore, the mounting process of the footrest device 2000 can be simplified. In other examples, the second magnetic member 2520 may also be a component that is additionally disposed on the support member 2100 and has ferromagnetic properties or a polarity opposite to that of the first magnetic member 2510.

Further, as shown in FIGS. 97 and 98, a second synchronization mechanism 2600 is disposed between the first footrest 2310 and the second footrest 2320. The second synchronization mechanism 2600 can enable the first footrest 2310 and the second footrest 2320 to rotate synchronously. In this example, the second synchronization mechanism 2600 includes a third driving member 2610 and a fourth driving member 2620. Specifically, one end of the first footrest 2310 and the third driving member 2610 are pivotally connected to the third connecting portion 2130 through the third pivot shaft 2410. The one end of the first footrest 2310 and the third driving member 2610 are both fixed to the third pivot shaft 2410. As shown in FIG. 94, the third pivot shaft 2410 is rotatably connected to the third connecting portion 2130. Similarly, one end of the second footrest 2320 and the fourth driving member 2620 are pivotally connected to the fourth connecting portion 2140 through the fourth pivot shaft 2420. The one end of the second footrest 2320 and the fourth driving member 2620 are both fixed to the fourth pivot shaft 2420. As shown in FIG. 94, the fourth pivot shaft 2420 is rotatably connected to the fourth connecting portion 2140.

As shown in FIGS. 97 and 98, in this example, the third driving member 2610 includes a first gear tooth portion 2610a, and the fourth driving member 2620 includes a second gear tooth portion 2620a. The first gear tooth portion 2610a and the second gear tooth portion 2620a are engaged with each other. In this way, when one (for example, the first footrest 2310) of the first footrest 2310 and the second footrest 2320 rotates relative to the support member 2100, the first gear tooth portion 2610a is engaged with the second gear tooth portion 2620a, to drive the other (for example, the second footrest 2320) of the first footrest 2310 and the second footrest 2320 to rotate synchronously, thereby making it convenient for the user to unfold or fold the first footrest 2310 and the second footrest 2320 at the same time. That is, driven by the third driving member 2610 and the fourth driving member 2620, the first footrest 2310 and the second footrest 2320 can be driven to rotate in opposite directions synchronously.

In this example, the third driving member 2610 and the fourth driving member 2620 are both quarter gears. In this way, the rotation angle of the first footrest 2310 and the second footrest 2320 relative to the support member 2100 can be limited, so that the first footrest 2310 and the second footrest 2320 are always pivoted between the unfolded state and the folded state. In other examples, the third driving member 2610 and the fourth driving member 2620 may also be one-third gears, one-fifth gears, etc. as needed, and which is not limited in this application.

In other examples, the third driving member 2610 and the fourth driving member 2620 can also be directly fixed to the one end of the first footrest 2310 and the one end of the second footrest 2320, respectively. In this way, the third pivot shaft 2410 can also be rotatably connected to the one end of the first footrest 2310, and fixedly connected to the third connecting portion 2130. The fourth pivot shaft 2420 can also be rotatably connected to the one end of the second footrest 2320, and fixedly connected to the fourth connecting portion 2140.

Specifically, as shown in FIGS. 94 to 96, the connecting member 2200 includes a fixing portion 2210 and a second pivot portion 222 connected to each other. The fixing portion 2210 has a substantially U-shaped structure. Two ends of the fixing portion 2210 are fixedly connected to both sides of the frame 100 through fasteners 280 (as shown in FIG. 93). The fasteners 280 may be rivets, screws, etc. The second pivot portion 222 has a substantially cylindrical structure and is pivotally connected to the support member 2100 through the rotating shaft 243.

Specifically, as shown in FIGS. 97 to 99, two first pivot portions 2150 extend out of two opposite sides of the second end surface 2120 of the support body 2160, respectively. Each of the two first pivot portions 2150 has a pivot hole 215a. The rotating shaft 243 extends through the pivot hole 215a on one side, the second pivot portion 222, and the pivot hole 215a on the other side in sequence, thereby enabling the pivot connection between the support member 2100 and the connecting member 2200. In this example, the rotating shaft 243 is fixedly connected to the two first pivot portions 2150, and the second pivot portion 222 is rotatable relative to the rotating shaft 243. In other examples, the rotating shaft 243 can also be fixedly connected to the second pivot portion 222, and the two first pivot portions 2150 are rotatable relative to the rotating shaft 243. In this example, the third pivot shaft 2410 and the fourth pivot shaft 2420 are both perpendicular to the rotating shaft 243. In other examples, an angle between the third pivot shaft 2410 and the rotating shaft 243 and an angle between the fourth pivot shaft 2420 and the rotating shaft 243 may also be greater than 90 degrees or less than 90 degrees. In other words, the extending directions of the third pivot shaft 2410 (or the fourth pivot shaft 2420) and the rotating shaft 243 are not parallel to each other.

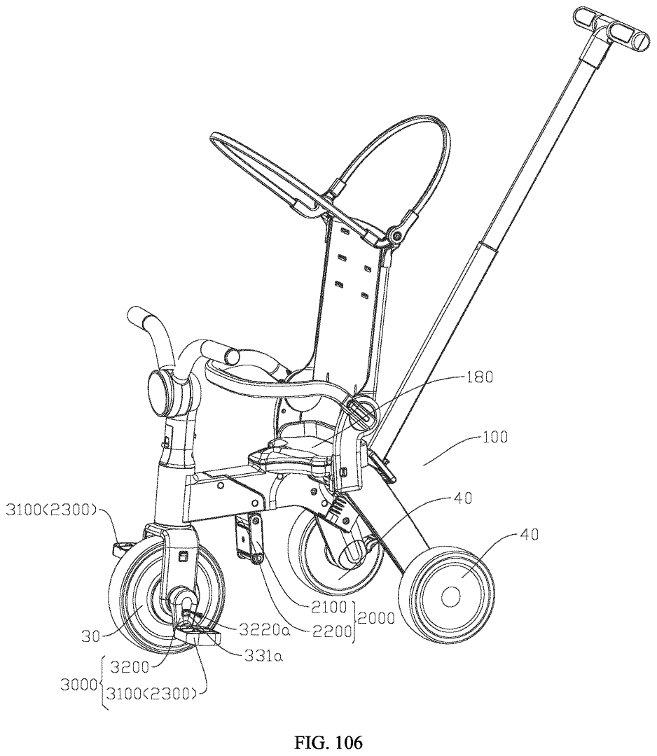

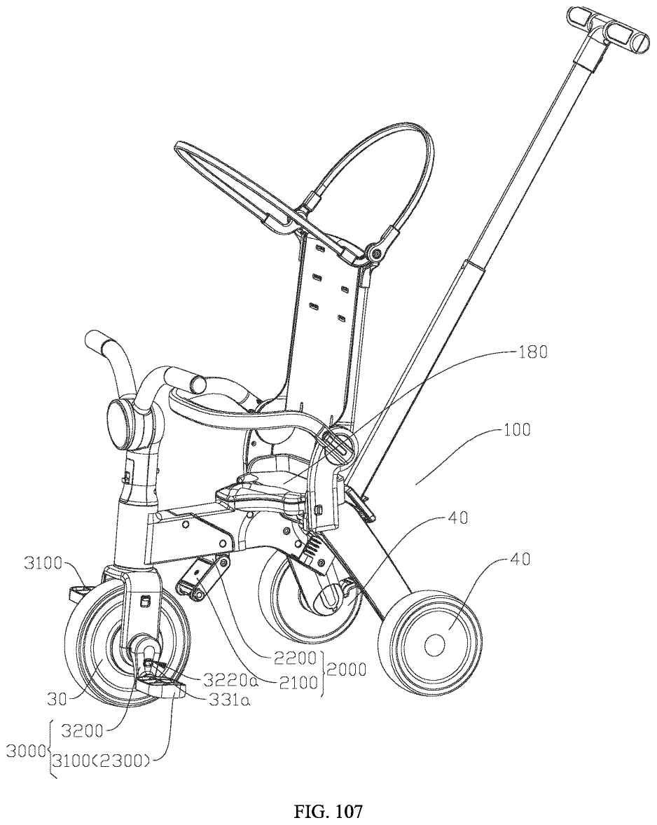

Further, as shown in FIGS. 97 to 99, the footrest device 2000 further includes a second positioning mechanism 270. The second positioning mechanism 270 is disposed between the support member 2100 and the connecting member 2200. The second positioning mechanism 270 is used to fix the support member 2100 relative to the connecting member 2200 in the first rotation position as shown in FIG. 106, or in the second rotation position as shown in FIG. 107. In this example, two second positioning mechanisms 270 are provided, and are respectively configured to achieve positioning and fixation between both sides of the second pivot portion 222 and the two first pivot portions 2150, so that the support member 2100 can be better positioned and not easily displaced relative to the connecting member 2200. In other examples, the second positioning mechanism 270 may be disposed only between one side of the second pivot portion 222 and the corresponding first pivot portion 2150.

Specifically, as shown in FIGS. 97 to 99, one of the second positioning mechanisms 270 is taken as an example for illustration. The second positioning mechanism 270 includes a third positioning recess 271, a fourth positioning recess 272, a second positioning protrusion 273, and a positioning reset member 274. The third positioning recess 271 and the fourth positioning recess 272 are spaced apart on a first side surface 215b of the first pivot portion 2150. The third positioning recess 271 and the fourth positioning recess 272 are spaced apart in the circumferential direction around the pivot hole 215a. The second positioning protrusion 273 is movably disposed on the second pivot portion 222. The second positioning protrusion 273 can move to extend out of a second side surface 222b of the second pivot portion 222. The first side surface 215b abuts against the second side surface 222b. As shown in FIG. 98, the second positioning protrusion 273 is movably disposed in the second pivot portion 222 and is spaced apart from the rotating shaft 243. In this example, the second positioning protrusion 273 can move in a direction substantially parallel to the rotating shaft 243. The second positioning protrusion 273 has a first moving position and a second moving position. There is a symmetry plane between the two first pivot portions 2150, and the two first pivot portions 2150 are mirror symmetrical with respect to the symmetry plane. The second positioning protrusion 27 is further away from the symmetry plane when being in the first moving position than when being in the second moving position. When the second positioning protrusion 273 is in the first moving position, the second positioning protrusion 273 can be engaged into the third positioning recess 271 or the fourth positioning recess 272. When the second positioning protrusion 273 is in the second moving position, the second positioning protrusion 273 can be disengaged from the third positioning recess 271 or the fourth positioning recess 272, and abut against the first side surface 215b. In this example, the second positioning protrusion 273 is a ball, and the third positioning recess 271 and the fourth positioning recess 272 are first and second positioning grooves that can be fitted with the second positioning protrusion 273, respectively. In this example, both the first positioning groove and the second positioning groove are partial spherical grooves. Utilizing the smooth rotation characteristics of the ball, when the support member 2100 rotates around the connecting member 2200, the ball can move between the first positioning groove and the second positioning groove more smoothly. In other examples, the second positioning protrusion 273 may also have a pin-shaped structure or a tapered structure.

Further, as shown in FIGS. 97 to 99, the positioning reset member 274 is disposed between the second positioning protrusion 273 and the support member 2100. The positioning reset member 274 biases the second positioning protrusion 273 to move toward the first moving position. Specifically, a second mounting groove 222a extending in a direction parallel to the rotating shaft 243 can be disposed in the second pivot portion 222. The positioning reset member 274 and at least a part of the second positioning protrusion 273 are disposed in the second mounting groove 222a. Both ends of the positioning and reset member 274 abut against the bottom of the second mounting groove 222a and the second positioning protrusion 273 respectively. When the support member 2100 rotates to the first rotation position or the second rotation position relative to the connecting member 2200, the positioning reset member 274 enables at least a part of the second positioning protrusion 273 to be pushed out of the second mounting groove 222a through an opening of the second mounting groove 222a, and to be engaged with the third positioning recess 271 or the fourth positioning recess 272, to fix the support member 2100 in the first rotation position or the second rotation position relative to the connecting member 2200. Optionally, the positioning reset member 274 is a spring.

In other examples, the second positioning mechanism 270 may also be in other forms. For example, a fourth positioning portion and a fifth positioning portion may be disposed on the connecting member 2200, a sixth positioning portion may be disposed on the support member 2100, and the fourth positioning portion and the fifth positioning portion has magnetic properties opposite to that of the sixth positioning portion. In this way, when the support member 2100 is in the first rotation position, the sixth positioning portion and the fourth positioning portion are magnetically locked; and when the support member 2100 is in the second rotation position, the sixth positioning portion and the fifth positioning portion are magnetically locked. In short, the second positioning mechanism 270 can be in various forms, which is not limited thereto, as long as the positioning between the support member 2100 and the connecting member 2200 can be achieved. In addition, the fourth positioning portion and the fifth positioning portion may be disposed on the support member 2100, and the sixth positioning portion may be disposed on the connecting member 2200, and so on.

In other words, the second positioning mechanism 270 may include the fourth, fifth and sixth positioning portions. The fourth positioning portion and the fifth positioning portion may be disposed on one of the support member 2100 and the connecting member 2200, and the sixth positioning portion may be disposed on another of the support member 2100 and the connecting member 2200. In this way, when the support member 2100 is in the first rotation position, the sixth positioning portion and the fourth positioning portion are locked to each other. When the support member 2100 is in the second rotation position, the sixth positioning portion and the fifth positioning portion are locked to each other.

In this way, as shown in FIG. 94, the footrest device 2000 is in the unfolded state. When the footrest device 2000 is not needed or the child carrier needs to be folded as a whole, the first footrest 2310 (or the second footrest 2320) in the unfolded state can be rotated toward the support member 2100 to the folded state. During this process, through the mutual engagement of the third driving member 2610 and the fourth driving member 2620, the distal end (that is, the end of the second footrest 2320 not connected to the support member 2100) of the second footrest 2320 (or the first footrest 2310) in the unfolded state can also be driven to rotate simultaneously toward the support member 2100 to the folded state.

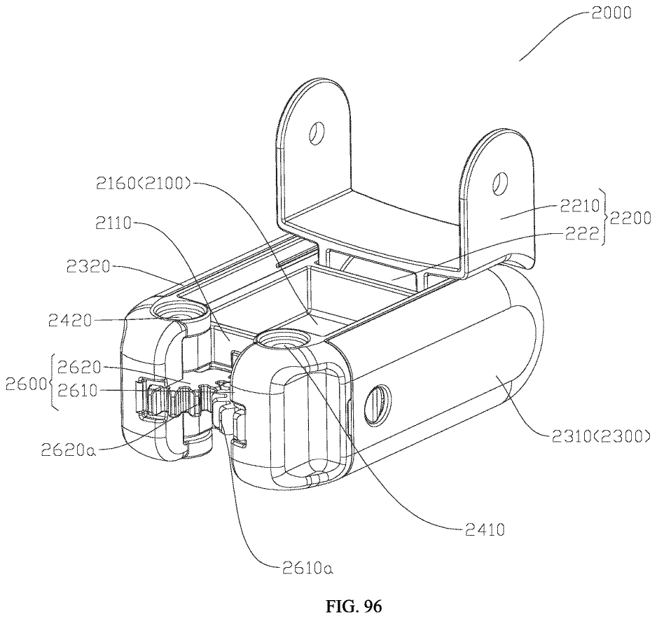

As shown in FIG. 98, the first footrest 2310 and the second footrest 2320 can be fixed to two sides of the support member 2100 through the fixing component 2500 (for example, through the attraction between the first magnetic member 2510 and the second magnetic member 2520). In addition, as shown in FIG. 96, the support member 2100 in the first rotation position can be rotated around the rotating shaft 243 to the second rotation position, so that the footrest device 2000 is switched to the folded state.

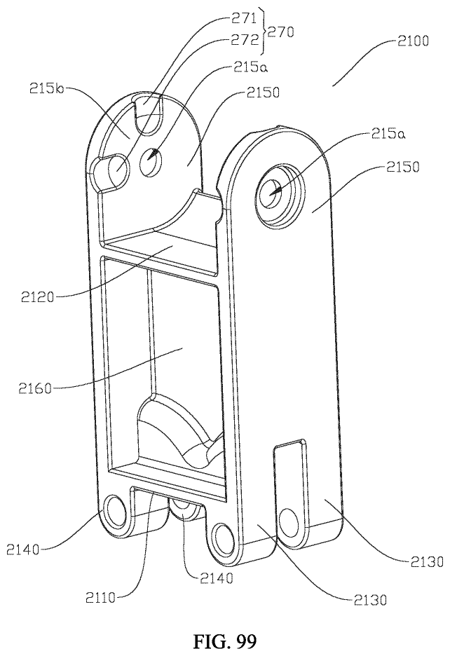

As shown in FIGS. 97 to 99, during the rotation of the support member 2100, the second positioning protrusion 273 originally engaged into the third positioning recess 271 moves out of the third positioning recess 271 as the support member 2100 rotates, and moves to the first side surface 215b (as shown in FIG. 99) of the first pivot portion 2150 between the third positioning recess 271 and the fourth positioning recess 272. The first side surface 215b pushes the second positioning protrusion 273, so that the second positioning protrusion 273 moves from the first moving position to the second moving position, causing the positioning reset member 274 to be compressed. When the support member 2100 continues to rotate to the second rotation position, the second positioning protrusion 273 faces the fourth positioning recess 272. In this case, the second positioning protrusion 273, which is not subjected to the pushing force of the first side surface 215b, moves to the first moving position again and is engaged with the fourth positioning recess 272 under the action of the elastic restoring force of the positioning reset member 274. In this way, the folding of the footrest device 2000 is completed.

In other examples, during the process of folding the footrest device 2000, the support member 2100 can also be rotated to the second rotation position relative to the connecting member 2200, and then the first footrest 2310 and the second footrest 2320 can be rotated to the folded state relative to the support member 2100. Alternatively, according to the user's personal needs, the support member 2100 can only be rotated to the second rotation position relative to the connecting member 2200, or the first footrest 2310 and the second footrest 2320 can only be rotated to the folded state relative to the support member 2100, and which is not limited in this application. The unfolding process of the footrest device 2000 is the reverse of the above-mentioned folding process, and which will not be described in detail herein.

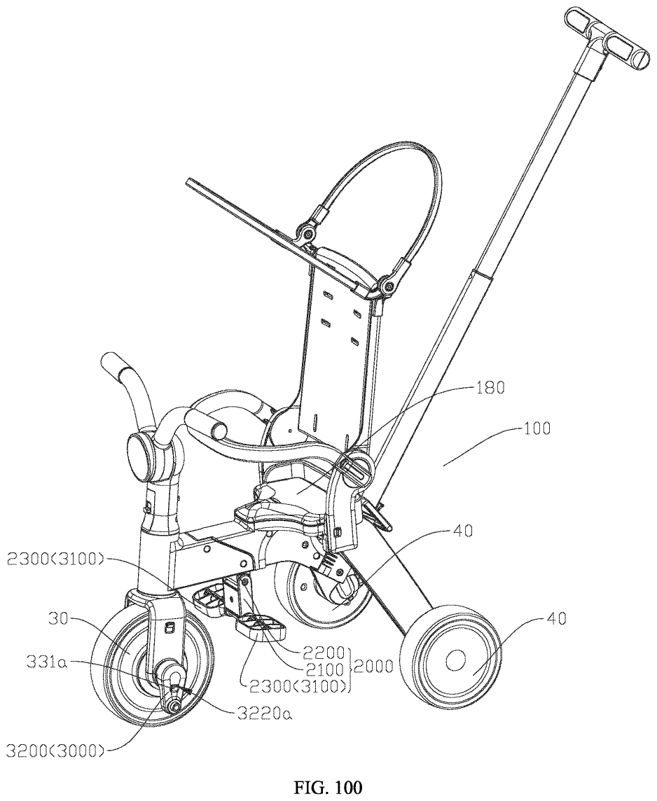

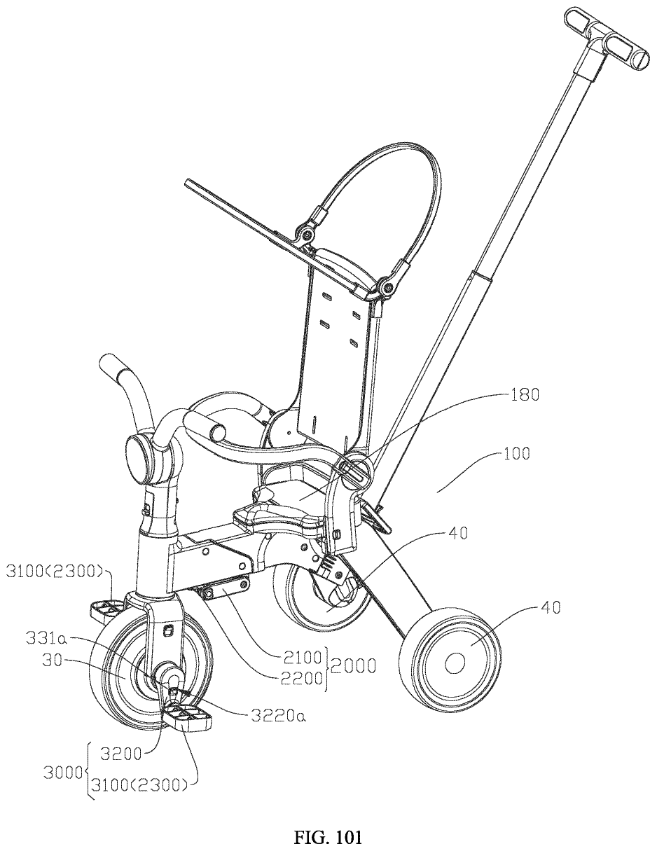

In a second example, as shown in FIGS. 100 and 101, the footrest device 2000 includes the footrest component 2300, the support member 2100 and the connecting member 2200. The support member 2100 and the connecting member 2200 in this example have substantially the same configuration as those in the first example, and are mainly different from those in the first example in the footrest component 2300 and the connection method between the footrest component 2300 and the support member 2100. In this example, the footrest component 2300 and a pedal component 3100 of the pedal device 3000 are actually the same component. The footrest component 2300 is removably connected to the support member 2100. When the footrest device 2000 is in the use state, the support member 2100 is in the first rotation position, and the footrest component 2300 is mounted on the support member 2100. When the footrest device 2000 is in the non-use state, the support member 2100 is in the second rotation position, and the footrest component 2300 is removed from the support member 2100.

Specifically, when the footrest device 2000 is in the use state, as shown in FIG. 100, the footrest component 2300 can be mounted on the support member 2100 while the support member 2100 is in the first rotation position, so that the child can place the feet on the footrest component 2300 to rest. When the footrest device 2000 is in the non-use state, as shown in FIG. 101, the footrest component 2300 can be removed from the support member 2100, and the support member 2100 can be rotated to the second rotation position. The removed footrest component 2300 can be mounted on the wheel assembly 20 as the pedal component 3100 for children to ride on. In this example, the footrest component 2300 and the pedal component 3100 are actually the same component. The footrest component 2300 can rest the child's feet when in the use state, and can also serve as the pedal component 3100 for riding when in the non-use state. In this way, one component has double use, so that there is no need to provide an additional pedal component 3100 (or footrest component 2300), it is convenient to use, and it is beneficial to reduce the number of components of the child carrier and reducing production costs.

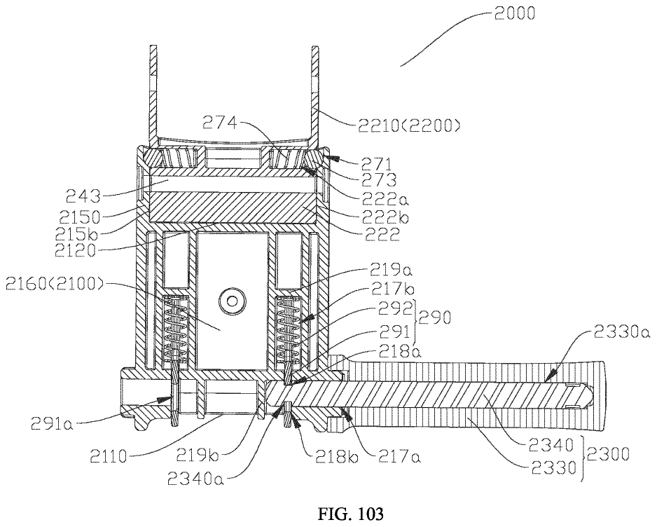

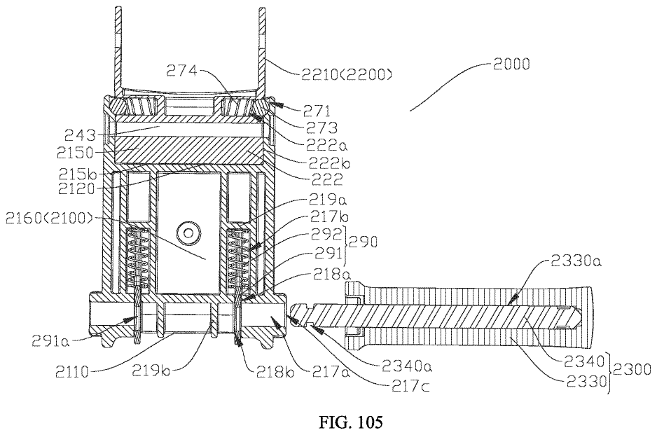

Further, as shown in FIGS. 103 to 105, the footrest device 2000 further includes a second fixing mechanism 290. The footrest component 2300 is removably connected to the support member 2100 through a second fixing mechanism 290. In this example, two footrest components 2300 and two second fixing mechanisms 290 are provided. The two footrest components 2300 are removably connected to the left and right sides of the support member 2100 through the two second fixing mechanisms 290, respectively. The configuration and related connection relationships of the footrest components 2300 will be described in detail below, by taking one of the footrest components 2300 and the corresponding second fixing mechanism 290 as an example.

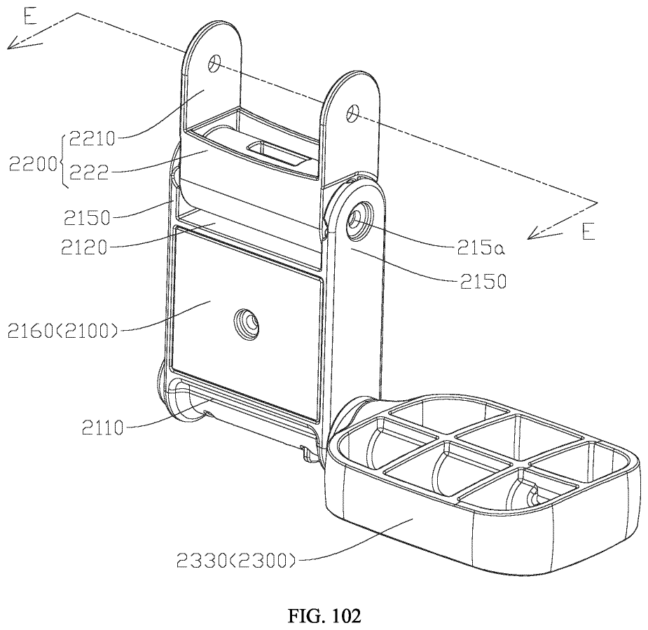

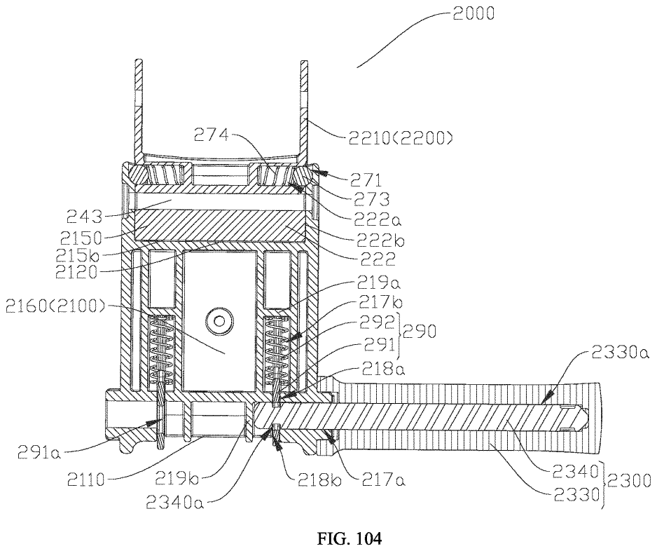

FIG. 102 shows a schematic perspective view of the connecting member 2200, the support member 2100 and one of the footrest components 2300. FIGS. 103 and 104 are cross-sectional views of the structure shown in FIG. 102 taken along a line D-D. A fifth locking member 291 (details of which will be described later) of the second fixing mechanism 290 shown in FIG. 103 is in a first locked position, and the fifth locking member 291 (details of which will be described later) of the second fixing mechanism 290 shown in FIG. 104 is in a first unlocked position. Specifically, the pedal component 2300 includes a footrest body 2330 and a first pin shaft 2340. The footrest body 2330 can be configured to support child's feet. The footrest body 2330 has a substantially rectangular structure. A first insertion groove 2330a is disposed at a substantially axial portion of the footrest body 2330 in an axial direction of the footrest body 2330. An end of the fifth locking member 291 is inserted into the first insertion groove 2330a, so that the footrest body 2330 can rotate around the first pin shaft 2340, and when the footrest component 2300 is used as the pedal component 3100, the child can easily adjust the pedaling direction. A fourth locking groove 2340a is disposed on a portion of the first pin shaft 2340 located outside the first insertion groove 2330a in the circumferential direction.

Specifically, as shown in FIGS. 102 to 104, the second fixing mechanism 290 includes a fifth locking portion 291 and a locking reset member 292. The fifth locking member 291 has a substantially sheet-like structure. A fifth locking hole 291a is disposed in a substantially middle portion of the fifth locking member 291. A radial size of the fifth locking hole 291a is larger than a radial size of the first pin shaft 2340. The fifth locking member 291 is movably disposed in the support member 2100. The fifth locking member 291 is switchable between a first locked position and a first unlocked position. Specifically, a sixth accommodation cavity 217a and a seventh accommodation cavity 217b are disposed in the support member 2100. A third via hole 218a and a fourth via hole 218b are disposed opposite each other on a cavity wall of the sixth accommodation cavity 217a. The sixth accommodation cavity 217a is in communication with the seventh accommodation cavity 217b through the third via hole 218a. The sixth accommodation cavity 217a is in communication with the outside of the support member 2100 through the fourth via hole 218b. A first end of the fifth locking member 291 is located in the seventh accommodation cavity 217b, and a second end of the fifth locking member 291 is inserted into the sixth accommodation cavity 217a through the third via hole 218a. In this example, the second end of the fifth locking member 291 can extend through the fourth via hole 218b and extend out of the support member 2100. In other examples, the second end of the fifth locking member 291 may not extend out of the support member 2100. A portion of the fifth locking member 291 with the fifth locking hole 291a is generally located in the sixth accommodation cavity 217a.

Further, as shown in FIGS. 103 to 105, the locking reset member 292 is disposed between the fifth locking member 291 and the support member 2100. The locking reset member 292 is configured to bias the fifth locking member 291 to move to the first locked position. Specifically, the locking reset member 292 is disposed in the accommodation cavity 217b. One end of the locking reset piece 292 abuts against the fifth locking member 291, and another end of the locking reset piece 292 abuts against a first cavity wall 219a of the seventh accommodation cavity 217b. The first cavity wall 219a is disposed opposite to the third via hole 218a.

As shown in FIGS. 103 to 105, the end of the first pin shaft 2340 with the fourth locking groove 2340a can be inserted into the sixth accommodation cavity 217a in the support member 2100 and extend through the fifth locking hole 291a. When the fifth locking member 291 is in the first locked position, a hole wall of the fifth locking hole 291a is inserted into the fourth locking groove 2340a. In this example, the support member 2100 is provided with an insertion opening 217c in communication with the sixth accommodation cavity 217a. The end of the first pin shaft 2340 with the fourth locking groove 2340a is inserted into the sixth accommodation cavity 217a through the insertion opening 217c, and abuts against a second cavity wall 219b of the sixth accommodation cavity 217a. The second cavity wall 219b is disposed opposite to the insertion opening 217c. In this way, an insertion position of the first pin shaft 2340 in the support member 2100 can be limited. After the first pin shaft 2340 is inserted in position, the first pin shaft 2340 extends through the fifth locking hole 291a, and a position of the fourth locking groove 2340a of the first pin shaft 2340 corresponds to the fifth locking member 291. In this case, if the fifth locking member 291 is in the first locked position, as shown in FIG. 103, a hole wall of the fifth locking hole 291a is inserted into the fourth locking groove 2340a, and the footrest component 2300 is mounted and fixed on the support member 2100. If the fifth locking member 291 is in the first unlocked position, as shown in FIG. 104, the hole wall of the fifth locking hole 291a is separated from the fourth locking groove 2340a, and the footrest component 2300 can be removed from the support member 2100.

Further, the second end of the fifth locking member 291 is located outside the support member 2100, so that the portion of the fifth locking member 291 that extends out of the support member 2100 can be operated to move from the first locked position to the first unlocked position. Alternatively, when the end of the first pin shaft 2340 with the fourth locking groove 2340a is inserted into the support member 2100, the first pin shaft 2340 can move the fifth locking member 291, so that the fifth locking member 291 overcomes the elastic force of the locking reset member 292 and moves from the first locked position to the first unlocked position.

Further, an extending direction of the first pin shaft 2340 intersects the moving direction of the fifth locking member 291, that is, an angle is formed between the extending direction of the first pin shaft 2340 and the moving direction of the fifth locking member 291. In this example, the extending direction of the first pin shaft 2340 is substantially perpendicular to the moving direction of the fifth locking member 291.

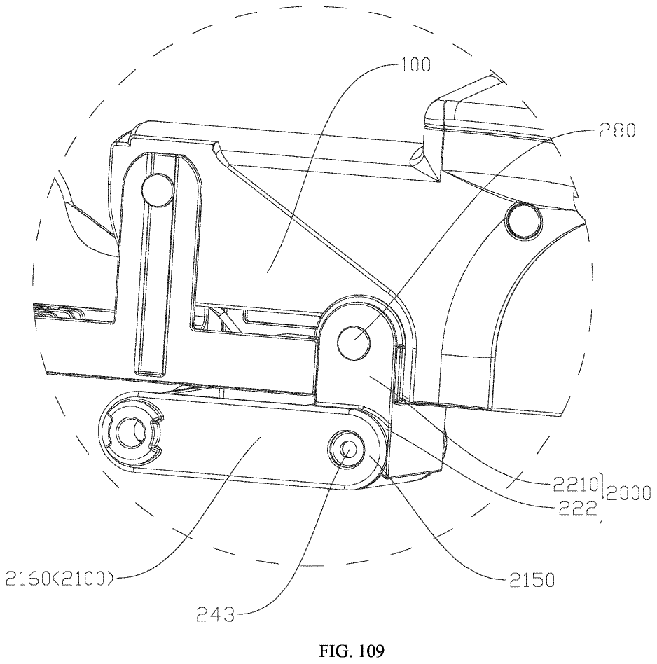

In this example, since the two footrest components 2300 are removably connected to the two sides of the support member 2100 respectively, compared with the first example, the support member 2100 in this example does not need to be provided with the second synchronization mechanism 2600 and the fixing component 2500, and the footrest device 2000 do not need to be provided with the third pivot shaft 2410 and the fourth pivot shaft 2420. In addition, as shown in FIGS. 106 to 109, the support member 2100 and the connecting member 2200 in this example have the same configurations as those in the first example, and the support member 2100 can be fixed between at least two rotation positions relative to the connecting member 2200 by the second positioning mechanism 270 as in the first example.

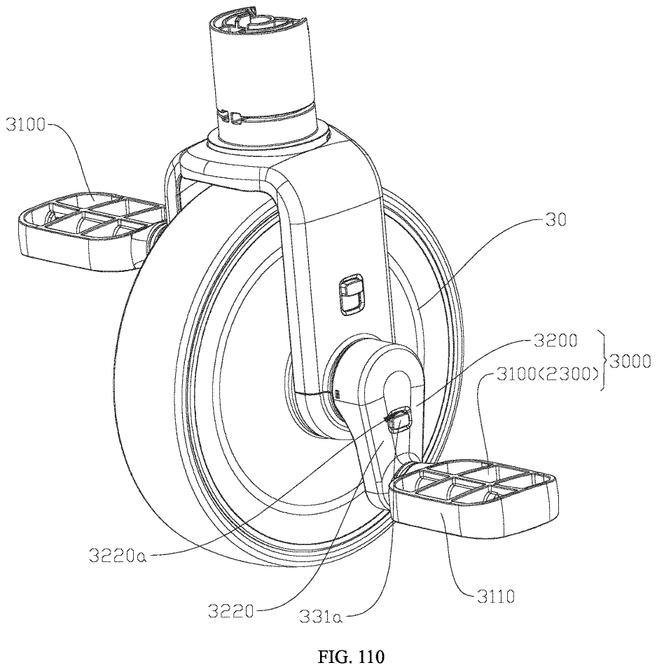

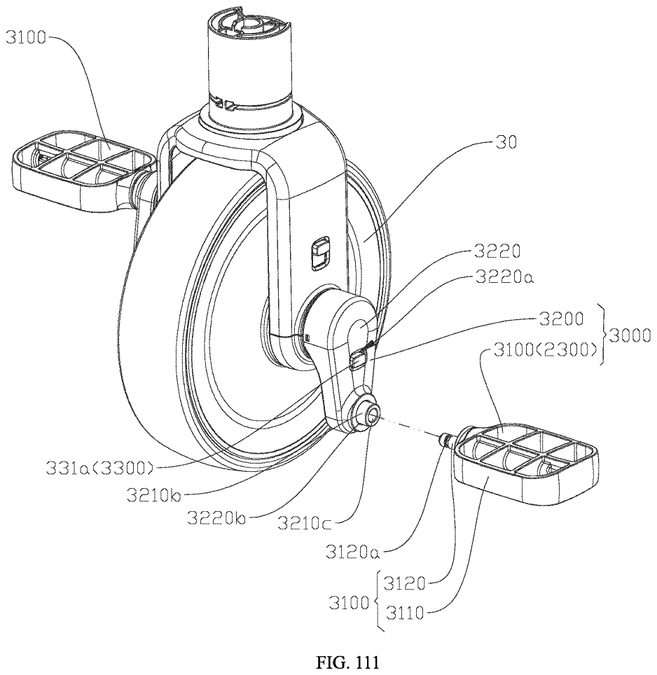

Further, as shown in FIGS. 110 and 111, the pedal device 3000 includes the pedal component 3100, a pedal base 3200, and a third fixing mechanism 3300. The pedal base 3200 of this embodiment can be connected to the wheel assembly 20, but which is not limited thereto in the present application. The pedal component 3100 is removably connected to the pedal base 3200 through a third fixing mechanism 3300. In other embodiments, the pedal device 3000 can also be directly disposed on the frame 100.

In the child carrier of the aforementioned examples, when the footrest device 2000 in the first example is employed, the pedal component 3100 and the footrest component 2300 are two independent components; and when the footrest device 2000 in the second example is employed, the pedal component 3100 and the footrest component 2300 are the same component. However, no matter what kind of footrest device 2000 is employed, the pedal component 3100 can have the same configuration.

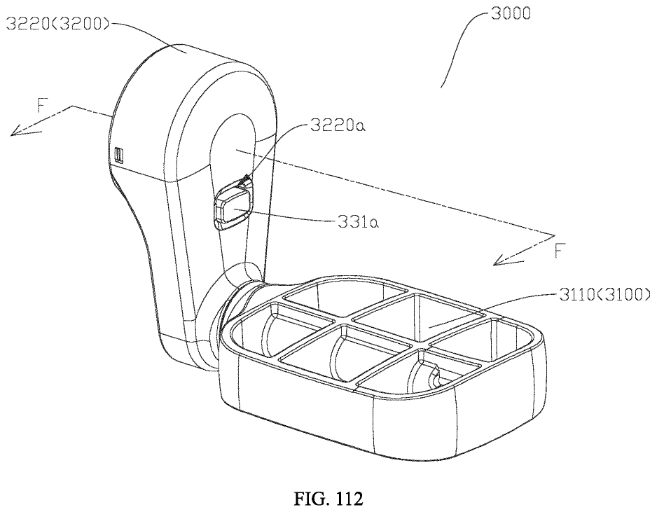

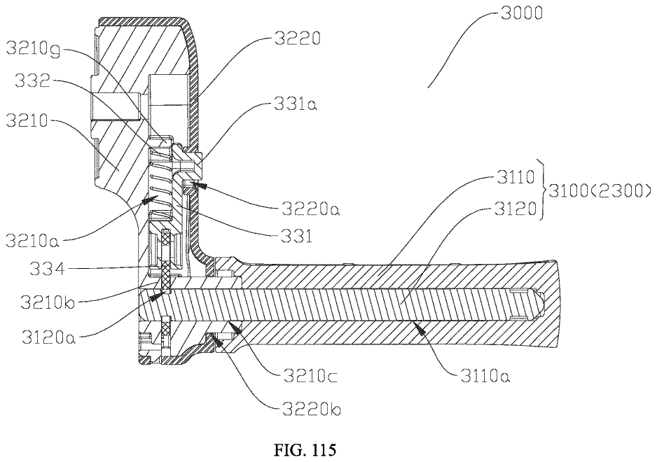

Specifically, as shown in FIGS. 111 and 112, the pedal component 3100 includes a pedal body 3110 and a second pin shaft 3120. The pedal body 3110 can be pedaled by the child riding the child carrier. The pedal body 3110 has a roughly rectangular structure. A second insertion groove 3110a (see FIGS. 114 and 115) is disposed at a substantially axial portion of the pedal body 3110 in an axial direction of the pedal body 3110. The second pin shaft 3120 is partially inserted into the second insertion groove 3110a, so that the pedal body 3110 can rotate around the second pin shaft 3120 to facilitate children to adjust the pedaling direction.

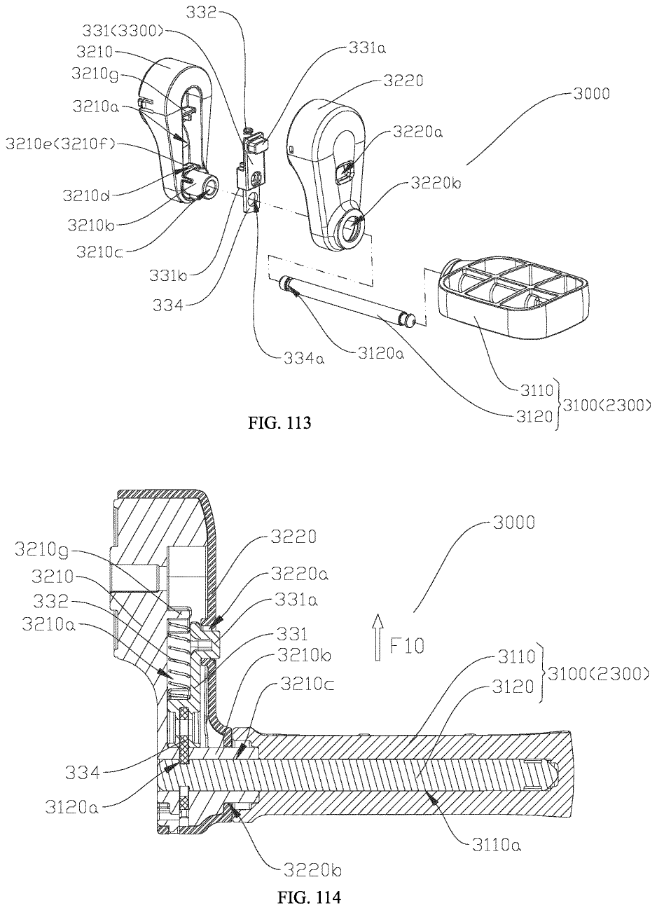

Specifically, as shown in FIGS. 112 and 113, the pedal base 3200 includes a fifth housing 3210 and a sixth housing 3220. The fifth housing 3210 and the sixth housing 3220 are fastened to each other to form a third mounting cavity (not shown in figures) for receiving the third fixing mechanism 3300. The wheel assembly 20 is connected to the side of the fifth housing 3210 away from the sixth housing 3220. A surface of the fifth housing 3210 facing the sixth housing 3220 is provided with a fourth receiving groove 3210a and a receiving boss 3210b. The receiving boss 3210b has a cylindrical structure. A fourth receiving cavity 3210c extends through the receiving boss 3210b in an axial direction of the second pin shaft 3120. A first groove wall 3210f of the fourth receiving groove 3210a is provided with a strip-shaped insertion hole 3210d. The fourth receiving groove 3210a is in communication with the fourth receiving cavity 3210c through the insertion hole 3210d. The sixth housing 3220 includes a third operating hole 3220a and a mounting hole 3220b that are arranged at an interval. When the sixth housing 3220 and the fifth housing 3210 are fastened to each other, the receiving boss 3210b extends through the mounting hole 3220b and extends out of from an outer surface of the sixth housing 3220. The sixth housing 3220 and a second groove wall 3210g of the fourth receiving groove 3210a, and a cavity wall of the fourth receiving cavity 3210c together form a fourth mounting cavity. The second groove wall 3210g is disposed opposite to the first groove wall 3210f.

Specifically, as shown in FIGS. 113 and 114, the third fixing mechanism 3300 includes a sixth locking member 334, a third operating member 331, and an operating reset member 332.

In this embodiment, as shown in FIGS. 113 to 115, a portion of the second pin shaft 3120 located outside the second insertion groove 3110a is provided with a fifth locking groove 3120a in a circumferential direction. The sixth locking member 334 is movably disposed on the pedal base 3200. In this embodiment, the sixth locking member 334 has a substantially sheet-shaped structure. A sixth locking hole 334a extends through the sixth locking member 334. A radial size of the sixth locking hole 334a is greater than a radial size of the second pin shaft 3120.

The third operating member 331 is a quick release button, one end of the third operating member 331 is fixedly connected to the sixth locking member 334, and another end of the third operating member 331 is provided with an operating portion 331a. In this embodiment, at least a part of the third operating member 331, and the sixth locking member 334 are movably disposed in the fourth mounting cavity. Specifically, at least a part of the third operating member 331 is movably disposed in the fourth receiving groove 3210a. One end of the sixth locking member 334 is connected to the third operating member 331, and another end is inserted into the fourth receiving cavity 3210c through the insertion hole 3210d. The operating portion 331a extends out of an outer surface of the sixth housing 3220 through the third operating hole 3220a to facilitate user operation. The operating reset member 332 is also disposed in the fourth receiving groove 3210a. One end of the operating reset member 332 is connected to or abuts against the third operating member 331, and the other end of the operating reset member 332 abuts against the second groove wall 3210g of the fourth receiving groove 3210a. In this embodiment, the operating reset member 332 is located on a side of the third operating member 331 away from the sixth locking member 334. Optionally, the operating reset member 332 is a spring.

Further, the sixth locking member 334 can be operated to move between a first acting position (as shown in FIG. 114) and a second acting position (as shown in FIG. 115). In this embodiment, the second acting position is located in a direction F10 of the first acting position. In other words, the second acting position is located above the first acting position. One end of the second pin shaft 3120 having the fifth locking groove 3120a extends into the fourth receiving cavity 3210c, that is, extends into the fourth mounting cavity, and extends through the sixth locking hole 334a. When the pedal component 3100 is mounted in place, a hole wall of the sixth locking hole 334a exactly faces the fifth locking groove 3120a on the second pin shaft 3120.

As shown in FIG. 114, when the sixth locking member 334 is in the first acting position, the upper side of the hole wall of the sixth locking hole 334a is inserted into the fifth locking groove 3120a, and the operating reset member 332 biases the third operating member 331 to enable the third operating member 331 to drive the sixth locking member 334 to move toward the first acting position. In this way, the sixth locking member 334 is maintained in the first acting position, and the pedal component 3100 is fixedly connected to the pedal base 3200. When the pedal component 3100 is required to be removed from the pedal base 3200, the operating portion 331a can be pushed in the direction F10, so that the third operating member 331 drives the sixth locking portion 334 to move to the second acting position along the direction F10, and the operating reset member 332 is compressed, and the hole wall of the sixth locking hole 334a is separated from the fifth locking groove 3120a. In this way, the pedal component 3100 is unlocked from the pedal base 3200, and the pedal component 3100 can be removed from the pedal base 3200. It should be noted that since the radial size of the sixth locking hole 334a is greater than the radial size of the second pin shaft 3120, the lower side of the hole wall of the sixth locking hole 334a is not engaged with the fifth locking groove 3120a. The process of mounting the pedal component 3100 on the pedal base 3200 is the reverse of the above-mentioned removing process, and therefore which will not be repeatedly described again.

Further, as shown in FIG. 113, a fourth limiting portion 3210e is disposed in the fourth mounting cavity, and a fifth limiting portion 331b is disposed on the third operating member 331. When the sixth locking member 334 is in the first acting position, the fourth limiting portion 3210e abuts against the fifth limiting portion 331b. In this embodiment, a fourth limiting portion 3210e is disposed on the first groove wall 3210f of the fourth receiving groove 3210a, and the fifth limiting portion 331b is the lower end surface of the third operating member 331. The configuration of the fourth limiting portion 3210e and the fifth limiting portion 331b can limit the movement range of the sixth locking member 334, so that the sixth locking member 334 does not move excessively in the reversed direction of F10. In addition, the third operating hole 3220a on the sixth housing 3220 can also be sized to limit the movement range of the third operating member 331 and the sixth locking member 334 in the direction F10 and the reversed direction of F10, thereby limiting the sixth locking member 334 to move between the first acting position and the second acting position, to avoid excessive movement of the sixth locking member 334.

In this embodiment, two pedal devices 3000 are provided. The two pedal devices 3000 are connected to both sides of the front wheel 30 respectively, so that the child can easily ride the child carrier by placing the feet on the pedal bodies 3110 of the pedal devices 3000 on both sides respectively. In other embodiments, more than two pedal devices 3000 may be provided. For example, two pedal components 3100 with different heights or sizes may be disposed on both sides of the front wheel 30 respectively to facilitate riding by children of different ages or sizes.

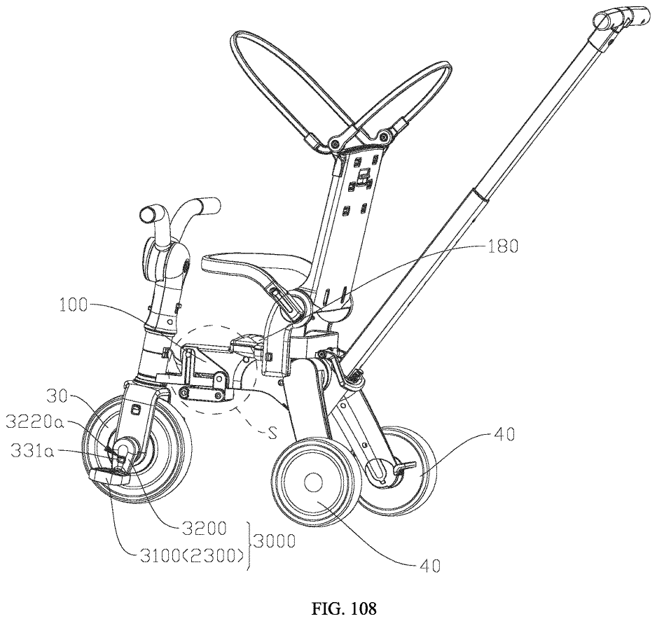

In the above-mentioned footrest device 2000, when the footrest device 2000 is in the use state, the support member 2100 rotates to the first rotation position away from the frame 100 (as shown in FIG. 106), and the footrest component 2300 is in the unfolded state or is mounted on the support member 2100, so that the child can place the feet on the footrest component 2300 to rest, and the child will not be too tired due to hanging the feet in the air for a long time or riding for a long time. When the frame 100 is folded or the footrest device 2000 is in the non-use state, the support member 2100 can be rotated to the second rotation position close to the frame 100 (as shown in FIG. 108), and the footrest component 2300 is in the folded state, or can be removed from the support member 2100, so that the pedal component 2300 may not interfere with the child's riding process, and the overall child carrier may be more tidy, anesthetic, and easy to use. When the footrest component 2300 is in the folded state, the space occupied by the footrest device 2000 can also be reduced. The child carrier including the above-mentioned footrest device 2000 enables the child's feet to be more fully rested, and provides a better user experience.

In an aspect of the present application, a child carrier is provided, which includes a front wheel, a rear wheel, and a frame having an unfolded state and a folded state. The frame includes a first frame, a second frame, and a linkage mechanism. The first frame is connected to the front wheel. The second frame is connected to the rear wheel. The second frame is provided with a first movable connecting portion. The linkage mechanism includes a first connecting frame, a second connecting frame, and a rotating base rotatably connected to the second frame.

In an embodiment, the child carrier further includes a handlebar assembly. The handlebar assembly includes: at least two handlebars with a plurality of use heights; and a first synchronization mechanism located between the at least two handlebars. The at least two handlebars are configured to be synchronously switched between different use heights through the first synchronization mechanism.

In an embodiment, the at least two handlebars each include a first handlebar and a second handlebar. The first handlebar includes a first connecting section and a first holding portion. The second handlebar includes a second connecting section and a second holding portion. The first connecting section and the second connecting section are rotatably connected to each other. The first synchronization mechanism is disposed between the first connecting section and the second connecting section. The first synchronization mechanism enables the first connecting section and the second connecting section to rotate in opposite directions synchronously, so as to synchronously adjust the use heights of the first holding portion and the second holding portion.

In an embodiment, the first synchronization mechanism includes a first driving element and a second driving element. The first driving element and the second driving element are drivingly connected. The first driving element is drivingly connected to the first handlebar. The second driving element is drivingly connected to the second handlebar.

In an embodiment, the first handlebar is a L-shaped rod or an arc-shaped rod. The first connecting section and the first holding portion are respectively located at two ends of the first handlebar. The second handlebar is a L-shaped rod or an arc-shaped rod. The second connecting section and the second holding portion are respectively located at two ends of the second handlebar.

In an embodiment, the at least two handlebars each include a first handlebar and a second handlebar. The first handlebar includes a first fitting ring. The first fitting ring is provided with a first internal gear portion in a circumferential direction. The second handlebar includes a second fitting ring. The second fitting ring is provided with a second internal gear portion in a circumferential direction. The first synchronization mechanism includes a first external gear and a second external gear. The first external gear is engaged with the first internal gear portion, and the second external gear is engaged with the second internal gear portion.

In an embodiment, the first fitting ring and the second fitting ring are overlapped to form a receiving cavity. The first external gear and the second external gear are disposed in the receiving cavity.

In an embodiment, the handlebar assembly further includes a support base. The support base is connected to the frame. The support base includes a mounting member. The mounting member is provided with a first pivot shaft and a second pivot shaft that are arranged at an interval. The first external gear and the second external gear are pivotally connected to the first pivot shaft and the second pivot shaft, respectively. The first fitting ring and the second fitting ring are rotatable relative to the mounting member.

In an embodiment, the first handlebar is a L-shaped rod or an arc-shaped rod. The first handlebar further includes a first holding portion. The first fitting ring and the first holding portion are respectively located on two ends of the first handlebar. The second handlebar is a L-shaped rod or an arc-shaped rod. The second handlebar further includes a second holding portion. The second fitting ring and the second holding portion are respectively located at two ends of the second handlebar.

In an embodiment, the handlebar assembly further includes a locking mechanism. When the locking mechanism is in a locked state, the at least two handlebars are locked at any of the use heights. When the locking mechanism is in an unlocked state, the at least two handlebars are operable to be switched to another one of the use heights.

In an embodiment, the at least two handlebars include a first handlebar and a second handlebar. The locking mechanism includes a pushing button. The pushing button is movable between a first position and a second position. One of the first handlebar and the pushing button is provided with a first locking groove, and another of the first handlebar and the pushing button is provided with a first locking portion. One of the second handlebar and the pushing button is provided with a second locking groove, and another of the second handlebar and the pushing button is provided with a second locking portion. When the pushing button is in the first position, the first locking portion and the second locking portion are engaged with the first locking groove and the second locking groove, respectively. When the pushing button is in the second position, the first locking portion and the second locking portion are disengaged from the first locking groove and the second locking groove respectively.

In an embodiment, one of the second handlebar and the pushing button is further provided with a third locking groove, and another of the second handlebar and the pushing button is further provided with a third locking portion. When the pushing button is in the first position, the third locking portion is engaged with the third locking groove. When the pushing button is in the second position, the third locking portion is disengaged from the third locking groove.

In an embodiment, the pushing button includes an unlocking operating member. The unlocking operating member is operable to move the pushing button to the second position.

In an embodiment, the locking mechanism further includes a pushing button reset member. The pushing button reset member biases the pushing button to move toward the first position.

In an embodiment, the first handlebar includes a first fitting ring. The first fitting ring is provided with a first internal gear portion in a circumferential direction. The second handlebar includes a second fitting ring. The second fitting ring is provided with a second internal gear portion in a circumferential direction. The first synchronization mechanism includes a first external gear and a second external gear. The first external gear is engaged with the first internal gear portion, and the second external gear is engaged with the second internal gear portion. The first locking groove is disposed on the first fitting ring. The second locking groove is disposed on the second fitting ring. The first locking portion and the second locking portion are disposed on the pushing button.

In an embodiment, one of the second handlebar and the pushing button is further provided with a third locking groove, and another of the second handlebar and the pushing button is further provided with a third locking portion. When the pushing button is in the first position, the third locking portion is engaged with the third locking groove. When the pushing button is in the second position, the third locking portion is disengaged from the third locking groove. The third locking groove is disposed on the first fitting ring, and the third locking groove is provided opposite to the first locking groove. The third locking portion is disposed on the pushing button.

In an embodiment, the pushing button includes a second pushing rod and a locking rod. An angle is formed between the second pushing rod and the locking rod. The locking rod is a L-shaped rod and includes a first rod and a second rod arranged at an angle. One end of the first rod away from the second rod is connected to the second pushing rod. The second pushing rod is provided with an engaging end. When the pushing button is in the first position, the first fitting ring and the second fitting ring is located between the second rod and the engaging end. The second rod forms the first locking portion, and the engaging end forms the second locking portion.

In an embodiment, the handlebar assembly further includes a support base connected to the frame. At least a part of the first handlebar and at least a part of the second handlebar are disposed in the support base, and rotatable relative to the support base. The pushing button is movably disposed in the support base.

In an embodiment, the support base is provided with a first operating hole. The pushing button is provided with an unlocking operating member. At least a part of the unlocking operating member is capable of extending out of a surface of the support base through the first operating hole to be operated.

In an embodiment, the child carrier further includes: a backrest assembly; an armrest assembly connected to the backrest assembly and having an unfolded state and a folded state relative to the backrest assembly; and a first positioning mechanism disposed between the backrest assembly and the armrest assembly. When the armrest assembly is in the unfolded state, the first positioning mechanism enables the armrest assembly to be fixed in a first position relative to the backrest assembly. When the armrest assembly is in the folded state, the first positioning mechanism enables the armrest assembly to be fixed in a second position relative to the backrest assembly.

In an embodiment, the first positioning mechanism includes: a first positioning portion and a second positioning portion that are disposed on one of the backrest assembly and the armrest assembly; and a third positioning portion disposed on another of the backrest assembly and the armrest assembly. When the armrest assembly is in the unfolded state, the third positioning portion is capable of being locked with the first positioning portion to fix the armrest assembly in the first position relative to the backrest assembly. When the assembly is in the folded state, the third positioning portion is capable of being locked with the second positioning portion to fix the armrest assembly in the second position relative to the backrest assembly.

In an embodiment, the armrest assembly is operable to switch the third positioning portion from a locking fit with the first positioning portion to another locking fit with the second positioning portion. Or, the armrest assembly is operable to switch the third positioning portion from a locking fit with the second positioning portion to another locking fit with the first positioning portion.

In an embodiment, the first positioning mechanism includes: a first positioning recess and a second positioning recess that are spaced apart on the backrest assembly; and a first positioning protrusion movably disposed on the armrest assembly. When the armrest assembly is in the unfolded state, the first positioning protrusion is capable of being inserted into the first positioning recess to fix the armrest assembly in the first position relative to the backrest assembly. When the assembly is in the folded state, the first positioning protrusion is capable of being inserted into the second positioning recess to fix the armrest assembly in the second position relative to the backrest assembly.

In an embodiment, the first positioning protrusion is a ball, and the first positioning recess and the second positioning recess are partially spherical holes capable of being fitted with the ball.

In an embodiment, the first positioning mechanism further includes a fifth reset member. The fifth reset member is disposed between the first positioning protrusion and the armrest assembly. The first positioning protrusion has a locked position. When the first positioning protrusion is in the locked position, the first positioning protrusion is capable of being inserted into the first positioning recess or the second positioning recess. The fifth reset member biased the first positioning protrusion to move toward the locked position.

In an embodiment, the armrest assembly and the backrest assembly are rotatably connected to each other.

In an embodiment, the backrest assembly includes a mounting base and a fixed base. The armrest assembly is fixedly connected to the fixed base. The fixed base is rotatably connected to the mounting base. The first positioning mechanism includes a first positioning recess, a second positioning recess and a first positioning protrusion. The first positioning recess and the second positioning recess are spaced apart on the mounting base. The first positioning protrusion is movably disposed on the mounting base. When the armrest assembly is in the unfolded state, the first positioning protrusion is capable of being inserted into the first positioning recess to fix the armrest assembly in the first position relative to the backrest assembly. When the armrest assembly is in the folded state, the first positioning protrusion is capable of being inserted into the second positioning recess to fix the armrest assembly in the second position relative to the backrest assembly.

In an embodiment, the fixed base is provided with an accommodating groove. The accommodating groove extends in a direction of rotating shafts of the fixed base and the mounting base. The first positioning protrusion is movably disposed in the accommodating groove.

In an embodiment, the first positioning mechanism further includes a fifth reset member. The fifth reset member is disposed in the accommodating groove. Two ends of the fifth reset member abut against the first positioning protrusion and a bottom of the accommodating groove respectively.

In an embodiment, the backrest assembly further includes a connecting base. The mounting base is rotatably connected to the connecting base. The fixed base is rotatably connected to the mounting base.

In an embodiment, the connecting base includes a third housing and a fourth housing that are fixedly connected to each other. The mounting base is rotatably connected to the fourth housing. The mounting base, the third housing, and the fourth housing enclose a fourth accommodation cavity. The first positioning recess and the second positioning recess are both disposed on a side of the mounting base facing the fourth housing.

In an embodiment, the connecting base includes a third housing and a fourth housing that are fixedly connected to each other. The mounting base is rotatably connected to the fourth housing. The third housing and the third housing enclose a fourth accommodation cavity. A mounting opening extends through the fourth housing. The fixed base is provided with a mounting boss. The mounting boss is provided with an accommodating groove. The first positioning protrusion is movably disposed in the accommodating groove and is movable to be partially outside the accommodating groove. The mounting boss extends into the fourth accommodation cavity through the mounting opening.

In an embodiment, when the armrest assembly is in an intermediate state between the unfolded state and the folded state, the first positioning mechanism enables the armrest assembly to be fixed in a third position relative to the backrest assembly.

In an embodiment, the backrest assembly includes a backrest body and a fixed base. The fixed base is fixedly connected to the armrest assembly. The fixed base is rotatably connected to the backrest body. The armrest body is removably connected to the fixed base.

In an embodiment, the fixed base is provided with an engaging portion. The armrest body is provided with a positioning groove capable of being engaged with the engaging portion.

In an embodiment, the child carrier further includes a first locking mechanism. The first locking mechanism includes a third locking member and a third locking hole. The third locking member is movably disposed on one of the armrest body and the fixed base, and the third locking hole is disposed on another of the armrest body and the fixed base. The third locking member is lockable into the third locking hole.

In an embodiment, the child carrier further includes a first locking mechanism. The first locking mechanism includes a third locking member, and a third locking hole located on the fixed base. The third locking member is pivotally connected to the armrest body at a first pivot point. The third locking member is provided with a first operating end and a first locking end. The first pivot point is disposed between the first operating end and the first locking end. The first locking end is capable of being inserted into the third locking hole. The first operating end is operable to separate the first locking end from the third locking hole.

In an embodiment, the first locking mechanism further includes a sixth reset member. The sixth reset member is disposed between the first operating end and the armrest body. The sixth reset member biases the first locking end to rotate in a direction in which the first locking end is inserted into the third locking hole.

In an embodiment, the armrest assembly includes an armrest body, a first armrest rod, and a second armrest rod. The first armrest rod and the second armrest rod are connected to two ends of the armrest body respectively, and connected to two sides of the backrest assembly respectively. The first positioning mechanism is disposed between the first armrest rod and the backrest assembly and between the second armrest rod and the backrest assembly.

In an embodiment, the child carrier further includes a frame and an adjustment mechanism. The backrest assembly is connected to the frame. The adjustment mechanism is disposed between the frame and the backrest assembly. The adjustment mechanism selectively limits or enables a relative rotation of the backrest assembly and the frame.

In an embodiment, the adjustment mechanism includes: a second locking component having a locked state in which the relative rotation of the backrest assembly and the frame is limited, and an unlocked state in which the relative rotation of the backrest assembly and the frame is non-limited; and an operating component connected to the second locking component and operable to switch the second locking component between the locked state and the unlocked state.

In an embodiment, the backrest assembly further includes a mounting base. The mounting base is fixedly connected to the frame. The second locking component includes a limiting hole disposed on the mounting base, and a limiting pin movably disposed on the backrest assembly. The limiting pin is capable of being inserted into the limiting hole.

In an embodiment, at least two limiting holes are provided. The limiting pins is capable of being inserted to different limiting holes to fix the backrest assembly at different relative angles relative to the frame.

In an embodiment, the operating component includes: an unlocking member; and a second pulling member, two ends of the second pulling member being connected to the unlocking member and the second locking component respectively. The unlocking member is operable to drive the second locking component to be switched from the locked state to the unlocked state through the second pulling member.

In an embodiment, the operating component further includes a seventh reset member. The seventh reset member biases the second pulling member to move in a direction of driving the second locking component to be switched to the locked state.

In an embodiment, the child carrier further includes a frame. The backrest assembly is removably connected to the frame.

In an embodiment, the backrest assembly further includes a connecting base. The backrest assembly is removably connected to the frame through the connecting base.

In an embodiment, the child carrier further includes a second locking mechanism. The second locking mechanism includes a first locking element and a second locking element. The first locking element is disposed on the connecting base. The second locking element is disposed on the frame. The first locking element is capable of being locked with or unlocked from the second locking element.

In an embodiment, the child carrier further includes a second locking mechanism. The second locking mechanism includes a fourth locking member and a fourth locking hole. The fourth locking member is movably disposed on the connecting base. The fourth locking hole is disposed on the frame. The fourth locking member is capable of being locked with or unlocked from the fourth locking hole.

In an embodiment, the fourth locking member is pivotally connected to the connecting base at a second pivot point. The fourth locking member includes a second operating end and a second locking end. The second pivot point is disposed between the second operating end and the second locking end. The second locking end is capable of being inserted to the fourth locking hole. The second operating end is operable to separate the second locking end from the fourth locking hole.

In an embodiment, the connecting base includes a third housing and a fourth housing. The third housing and the fourth housing cooperatively enclose a fifth accommodation cavity. The fourth locking member is located in the fifth accommodation cavity. The third housing is provided with a through hole. The second locking end is capable of extending the through hole and be inserted into the fourth locking hole. The fourth housing is provided with a second operating hole. The second operating end at least partially extends out of an outer surface of the fourth housing through the second operating hole.

In an embodiment, the second locking mechanism further includes an eighth reset member. The eighth reset member is disposed between the second operating end and the connecting base. The eighth reset member biases the second operating end to move in a direction of driving the second locking end to be locked into the fourth locking hole.

In an embodiment, one of the frame and the backrest assembly is provided with a guide boss, and another of the frame and the backrest assembly is provided with a guide groove. The guide boss is capable of being inserted into the guide groove.

In an embodiment, a sidewall of the guide groove is provided with an insertion opening. The guide boss is capable of being inserted into the guide groove through the insertion opening.

In an embodiment, the guide boss is provided with a guide hole. A bottom of the guide groove is provided with a guide rib. When the guide boss is inserted into the guide groove, the guide rib is inserted into the guide hole.

In an embodiment, the frame includes a seat assembly. Two sides of the backrest assembly are removably connected to two sides of the seat assembly respectively.

In an embodiment, the child carrier further includes a footrest device. The footrest device includes: a support member configured to be connected to the frame; and a footrest component configured to be pivotally or removably connected to the support member. The support member is switchable between a first rotation position and a second rotation position. When the support member is switched from the first rotation position to the second rotation position, the support member is folded in a direction approaching the frame. The footrest component is configured to, when being pivotally connected to the support member, be switchable between an unfolded state and a folded state. When the footrest component in the unfolded state, the footrest component is configured to carry child's feet. When the footrest component is in the folded state, the footrest component is folded approaching the support member. The footrest device has a use state and a non-use state. When the footrest device is in the use state, the support member is in the first rotation position, and the footrest component is in the unfolded state or is mounted on the on the support member. When the footrest device is in the non-use state, the support member is in the second rotation position, and the footrest component is in the folded state or is removed from the support member.

In an embodiment, the footrest component is capable of being connected to a pedal base of the child carrier to serve as a pedal component for children to drive the child carrier to move.

In an embodiment, the footrest component includes: a footrest body configured for carrying the child's feet; and a first pin shaft connected to the footrest body, an end of the first pin shaft being provided with a fourth locking groove in a circumferential direction. The footrest device further includes a second fixing mechanism. The second fixing mechanism includes: a fifth locking member movably disposed on the support member, and switchable between a first locked position and a first unlocked position, the fifth locking member being provided with a fifth locking hole, a radial size of the fifth locking hole being greater than a radial size of the first pin shaft; and a locking reset member disposed between the fifth locking member and the support member. The locking reset member biases the fifth locking member to move to the first locked position. The end of the first pin shaft provided with the fourth locking groove is capable of being inserted into the support member and extending through the fifth locking hole. When the fifth locking member is located in the first locked position, a hole wall of the fifth locking hole is inserted into the fourth locking groove.

In an embodiment, at least a part of the fifth locking member extends out of the support member. The part of the fifth locking member extending out of the support member is operable to move from the first locked position to the first unlocked position. Or, when the end of the first pin shaft provided with the fourth locking groove is inserted into the support member, the first pin shaft is capable of driving the fifth locking member to move from the first locked position to the first unlocked position.

In an embodiment, the first pin shaft is partially inserted into the footrest component. The end of the first pin shaft provided with the fourth locking groove extends out of the footrest component. An extending direction of the first pin shaft intersects a moving direction of the fifth locking member.

In an embodiment, the footrest device further includes a connecting member. The connecting member is fixedly connected to the frame. The support member is pivotally connected to the connecting member.

In an embodiment, the footrest device further includes a second positioning mechanism. The second positioning mechanism includes a fourth positioning portion, a fifth positioning portion, and a sixth positioning portion. The fourth positioning portion and the fifth positioning portion are disposed on one of the support member and the connecting member, the sixth positioning portion is disposed on another of the support member and the connecting member. When the support member is in the first rotation position, the sixth positioning portion and the fourth positioning portion are locked to each other. When the support member is in the second rotation position, the sixth positioning portion and the fifth positioning portion are locked to each other.

In an embodiment, the footrest device further includes a second positioning mechanism. The second positioning mechanism includes a third positioning recess, a fourth positioning recess, and a second positioning protrusion. The third positioning recess and the and the fourth positioning recess are disposed on one of the support member and the connecting member, and the second positioning protrusion is movably disposed on another of the support member and the connecting member. The second positioning protrusion has a first moving position and a second moving position. When the second positioning protrusion is in the first moving position, the second positioning protrusion is capable of being engaged into the third positioning recess or the fourth positioning recess. When the second positioning protrusion is in the second moving position, the second positioning protrusion is capable of being disengaged from the third positioning recess or the fourth positioning recess.

In an embodiment, the third positioning recess and the fourth positioning recess are a first positioning groove and a second positioning groove respectively, and the second positioning protrusion is a ball.

In an embodiment, the second positioning mechanism further includes a positioning reset member. The positioning reset member is disposed between the second positioning protrusion and the support member. The positioning reset member biases the second positioning protrusion to move toward the first moving position.

In an embodiment, the support member includes: a support body configured to be connected to the footrest component; and a first pivot portion protruding from the support body. The first pivot portion includes a first side surface provided with the third positioning recess and the fourth positioning recess. The connecting member includes a second pivot portion pivotally connected to the first pivot portion through a rotating shaft. The second pivot portion includes a second side surface facing the first side surface. The second side surface is provided with a second mounting groove. The second positioning protrusion is movably disposed in the second mounting groove. When the second positioning protrusion is in the first moving position, at least a part of the second positioning protrusion is capable of extending out of the second mounting groove to be engaged with the third positioning recess or the fourth positioning recess. When the second positioning protrusion is in the second moving position, the second positioning protrusion is capable of retracting into the second mounting groove to be disengaged from the third positioning recess or the fourth positioning recess.

In an embodiment, the third positioning recess and the fourth positioning recess are disposed around the rotating shaft; an extending direction of the second mounting groove is substantially parallel to a length direction of the rotating shaft.

In an embodiment, the support member includes two first pivot portions disposed opposite to each other. The two first pivot portions are pivotally connected to two sides of the second pivot portion through the rotating shaft, respectively. The second mounting groove is disposed on each of two second side surfaces of the second pivot portion opposite to the two first pivot portions. Two second positioning mechanisms are provided. Each of the two second positioning mechanisms is disposed between the second pivot portion and corresponding one of the two first pivot portions.

In an embodiment, the footrest device further includes a second positioning mechanism. The second positioning mechanism includes a fourth positioning portion, a fifth positioning portion, and a sixth positioning portion. The fourth positioning portion and the fifth positioning portion are disposed on one of the support member and the connecting member, the sixth positioning portion is disposed on another of the support member and the connecting member. The fourth positioning portion and the fifth positioning portion are configured to be magnetically locked with the sixth positioning portion.

In an embodiment, the footrest component at least includes a first footrest and a second footrest. The first footrest and the second footrest are respectively pivotally connected to opposite sides of the support member.

In an embodiment, the footrest device further includes a second synchronization mechanism. The second synchronization mechanism includes a third driving member and a fourth driving member. The third driving member is connected to the first footrest. The fourth driving member is connected to the second footrest. The third driving member is drivingly connected to the fourth driving member.

In an embodiment, the footrest device further includes a second synchronization mechanism. The second synchronization mechanism includes a third driving member and a fourth driving member. The third driving member is connected to the first footrest. The fourth driving member is connected to the second footrest. The third driving member includes a first gear tooth portion, and the fourth driving member includes a second gear tooth portion. The first gear tooth portion and the second gear teeth are capable of being engaged with each other.

In an embodiment, the footrest device further includes a third pivot shaft and a fourth pivot shaft. The third driving member and the first footrest are both fixedly connected to the third pivot shaft. The third pivot shaft is rotatably connected to the support member. The fourth driving member and the second footrest are both fixedly connected to the third pivot shaft. The fourth pivot shaft is rotatably connected to the support member.

In an embodiment, the footrest component is pivotally connected to the support member. The footrest device further includes a fixing component. The fixing component includes: a first magnetic member disposed on the footrest component; and a second magnetic member disposed on the support member. When the footrest component is in the folded state, the first magnetic member and the second magnetic member are attracted to each other.

In an embodiment, the footrest component is pivotally connected to the support member. The footrest device further includes a fixing component. The fixing component includes: a permanent magnet disposed on the footrest component; and a rotating shaft. The support member is pivotally connected to the frame through the rotating shaft, and the rotating shaft is made of ferromagnetic material. When the footrest component is in the folded state, the permanent magnet is attracted to the rotating shaft.

In an embodiment, the footrest component and the support member are pivotally connected to each other through a third pivot shaft. The support member and the connecting member are pivotally connected to each other through a rotating shaft. The rotating shaft is spaced apart from the third pivot shaft, and is not parallel to the third pivot shaft.

In an embodiment, the child carrier further includes a pedal device. The pedal device includes: a pedal component; a pedal base connected to a wheel assembly; and a third fixing mechanism. The pedal component is removably connected to the pedal base through the third fixing mechanism.

In an embodiment, the pedal component and the footrest component are the same component.

In an embodiment, the pedal component is provided with a fifth locking groove. The third fixing mechanism includes a sixth locking member movably disposed on the pedal base. The sixth locking member has a first acting position and a second acting position. When the sixth locking member is in the first acting position, the sixth locking member is capable of being inserted into the fifth locking groove to fixedly connect the pedal component to the pedal base. When the sixth locking member is in the second acting position, the sixth locking member is separated from the fifth locking groove, and the pedal component is capable of being separated from the pedal base.

In an embodiment, the pedal component includes a pedal body and a second pin shaft that are connected to each other. The second pin shaft is provided with a fifth locking groove. The third fixing mechanism includes a sixth locking member movably disposed on the pedal base. The sixth locking member is provided with a sixth locking hole. A radial size of the sixth locking hole is greater than a radial size of the second pin shaft. The second pin shaft extends through the sixth locking hole. A position of the fifth locking groove corresponds to the sixth locking hole. The sixth locking member has a first acting position and a second acting position. When the sixth locking member is in the first acting position, a part of a hole wall of the sixth locking hole is inserted into the fifth locking groove. When the sixth locking member is in the second acting position, the part of the hole wall of the sixth locking hole is separated from the fifth locking groove.

In an embodiment, the third fixing mechanism further includes: a third operating member fixedly connected to the sixth locking member, and the third operating member being operated to enable the sixth locking member to move from the first acting position to the second acting position; and an operating reset member disposed between the third operating member and the pedal base. The operating reset member biases the third operating member to drive the sixth locking member to move to the first acting position.

In an embodiment, the child carrier further includes a wheel assembly. The wheel assembly is rotatably connected to the frame. The pedal base includes: a fifth housing connected to the wheel assembly, the fifth housing being provided with a fourth receiving groove and a receiving boss, the receiving boss being provided with a fourth receiving cavity extending therethrough, a first groove wall of the fourth receiving groove being provided with an insertion hole, the fourth receiving groove being in communication with the fourth receiving cavity through the insertion hole; and a sixth housing provided with a third operating hole and a mounting hole that are spaced apart. The fifth housing and the sixth housing are connected to each other to form a mounting cavity. The fourth receiving groove and the receiving boss are located in the mounting cavity. The receiving boss extends through the mounting hole and extends out of an outer surface of the sixth housing. At least a part of the second pin shaft is inserted into the fourth receiving cavity. The sixth locking member and at least a part of the third operating member are movably disposed in the mounting cavity. At least a part of the sixth locking member is inserted into the fourth receiving cavity through the insertion hole so as to be inserted into or separated from the fifth locking groove of the second pin shaft. At least a part of the third operating member extends out of the mounting cavity through the third operating hole.

In an embodiment, both ends of the operating reset member abut against the third operating member and a second groove wall of the fourth receiving groove respectively. The second groove wall is disposed opposite to the first groove wall.

In an embodiment, the first groove wall forms a fourth limiting portion, and the third operating member is provided with a fifth limiting portion. When the sixth locking member is in the first acting position, the fourth limiting portion abuts against the fifth limiting portion.

In an embodiment, at least two pedal devices are provided. The at least two pedal devices are drivingly connected to both sides of the wheel assembly respectively.

In an embodiment, the child carrier further includes a footrest device. The footrest device includes: a footrest body configured for being connected to the frame. The footrest body has an unfolded state and a folded state. When the footrest body is in the unfolded state, the footrest body is configured to carry child's feet.

In an embodiment, the footrest device further includes: a support member configured to be connected to the frame. The footrest body is rotatably connected to the support member. The footrest body has an unfolded state and a folded state relative to the support member. When the footrest body is in the unfolded state, the footrest body is configured to carry the child's feet. When the footrest body is in the folded state, the footrest body is folded approaching the support member.

In an embodiment, the footrest device further includes: a support member configured to be connected to the frame. The footrest body includes a first footrest and a second footrest. The first footrest and the second footrest are rotatably connected to opposite sides of the support member respectively. The first footrest and the second footrest each have an unfolded state and a folded state relative to the support member. When the first footrest or the second footrest is in the unfolded state, the first footrest or the second footrest is configured to carry the child's feet. When the first footrest or the second footrest is in the folded state, the first footrest or the second footrest is folded approaching the support member.

In an embodiment, the footrest device further includes a second synchronization mechanism. The second synchronization mechanism is disposed between the first footrest and the second footrest. The second synchronization mechanism enables a synchronous rotation of the first footrest and the second footrest.

In an embodiment, the footrest device further includes a second synchronization mechanism. The second synchronization mechanism includes a third driving member and a fourth driving member. The third driving member is connected to the first footrest. The fourth driving member is connected to the second footrest. The third driving member is drivingly connected to the fourth driving member.

In an embodiment, the footrest device further includes a second synchronization mechanism. The second synchronization mechanism includes a third driving member and a fourth driving member, to respectively drive the first footrest and the second footrest to rotate in opposite directions synchronously. The third driving member includes a first gear tooth portion, and the fourth driving member includes a second gear tooth portion. The first gear tooth portion and the second gear tooth portion are engaged with each other.

In an embodiment, the footrest device further includes a second synchronization mechanism, a third pivot shaft, and a fourth pivot shaft. The second synchronization mechanism includes a third driving member and a fourth driving member. The third driving member and the first footrest are rotatably connected to the support member through a third pivot shaft. The fourth driving member and the second footrest are rotatably connected to the support member through a fourth pivot shaft.

In an embodiment, the footrest device further includes: a fixing component disposed between the footrest body and the support member. When the footrest body is in the folded state, the footrest body is capable of being fixed to a side of the support member through the fixing component.

In an embodiment, the footrest device further includes a fixing component. The fixing component includes a first magnetic member disposed on the footrest body and a second magnetic member disposed on the support member. When the footrest body is in the folded state, the first magnetic member and the second magnetic member attract each other.

In an embodiment, the footrest device further includes a fixing component. The fixing component includes a permanent magnet disposed on the footrest body and a rotating shaft disposed on the support member. The support member is rotatably connected to the frame through the rotating shaft. The rotating shaft is made of ferromagnetic material. When the footrest body is in the folded state, the permanent magnet is attracted to the rotating shaft.

In an embodiment, the footrest device further includes: a support member configured to be connected to the frame, the footrest body being rotatably connected to the support member; and a connecting member configured to be connected to the frame. The support member is rotatably connected to the connecting member. The support member has a first rotation position and a second rotation position relative to the connecting member. When the support member is in the first rotation position and the footrest body is in the unfolded state, the footrest body is configured to carry the child's feet. When the support member is in the second rotation position, the support member is folded approaching the frame.

In an embodiment, the footrest body and the support member are pivotally connected to each other through a third pivot shaft, and the support member and the connecting member are pivotally connected to each other through a rotating shaft. The rotating shaft is spaced apart from the third pivot shaft, and is not parallel to the third pivot shaft.

In an embodiment, the rotating shaft is perpendicular to the third pivot shaft.

In an embodiment, the footrest device further includes a second positioning mechanism. The second positioning mechanism is disposed between the support member and the connecting member. The second positioning mechanism is configured to enable the support member to be fixed in the first rotation position or the second rotation position relative to the connecting member.

In an embodiment, the footrest device further includes a second positioning mechanism. The second positioning mechanism includes a fourth positioning portion, a fifth positioning portion, and a sixth positioning portion. The fourth positioning portion and the fifth positioning portion are disposed on one of the support member and the connecting member, and the sixth positioning portion is disposed on another of the support member and the connecting member. When the support member is in the first rotation position, the sixth positioning portion and the fourth positioning portion are locked to each other. When the support member is in the second rotation position, the sixth positioning portion and the fifth positioning portion are locked to each other.

In an embodiment, the footrest device further includes a second positioning mechanism. The second positioning mechanism includes a third positioning recess, a fourth positioning recess, and a second positioning protrusion. The third positioning recess and the and the fourth positioning recess are disposed on one of the support member and the connecting member, and the second positioning protrusion is movably disposed on another of the support member and the connecting member. The second positioning protrusion has a first moving position and a second moving position. When the second positioning protrusion is in the first moving position, the second positioning protrusion is capable of being engaged into the third positioning recess or the fourth positioning recess. When the second positioning protrusion is in the second moving position, the second positioning protrusion is capable of being disengaged from the third positioning recess or the fourth positioning recess.

In an embodiment, the third positioning recess and the fourth positioning recess are a first positioning groove and a second positioning groove respectively, and the second positioning protrusion is a ball.

In an embodiment, the second positioning mechanism further includes a positioning reset member. The positioning reset member is disposed between the second positioning protrusion and the support member. The positioning reset member biases the second positioning protrusions to move toward the first moving position.

In an embodiment, the footrest device further includes a second positioning mechanism. The second positioning mechanism includes a fourth positioning portion, a fifth positioning portion, and a sixth positioning portion. The fourth positioning portion and the fifth positioning portion are disposed on one of the support member and the connecting member, and the sixth positioning portion is disposed on another of the support member and the connecting member. The fourth positioning portion and the fifth positioning portion are configured to be magnetically locked with the sixth positioning portion.

In an embodiment, the footrest device further includes a support member rotatably connected to the frame. The footrest body is connected to the support member. The support member has a first rotation position and a second rotation position. When the support member is in the first rotational position and the footrest body is in the unfolded state, the footrest body is configured to carry the child's feet. When the support member is in the second rotational position, the support member is folded approaching the frame.

In an embodiment, the footrest device further includes a support member and a connecting member. The connecting member is connected to the frame, the support member is rotatably connected to the connecting member, and the support member has a first rotation position and a second rotation position relative to the connecting member. When the support member is in the first rotation position, the footrest body is configured to carry the child's feet. When the support member is in the second rotation position, the footrest body is folded approaching the frame.

In an embodiment, the child carrier further includes a pedal device. The pedal device includes: a pedal base; a pedal component removably connected to the pedal base; and a third fixing mechanism. The pedal component is removably connected to the pedal base through the third fixing mechanism.

In an embodiment, the third fixing mechanism includes a first locking portion and a second locking portion. The first locking portion is disposed on one of the pedal component and the pedal base, and the second locking portion is movably disposed on another of the pedal component and the pedal base. When the first locking portion and the second locking portion are locked to each other, the pedal component and the pedal base are fixedly connected to each other. When the first locking portion and the second locking portion are unlocked from each other, the pedal component is removable from the pedal base.

In an embodiment, the third fixing mechanism includes a fifth locking groove disposed on the pedal component and a sixth locking member movably disposed on the pedal base. The sixth locking member has a first acting position and a second acting position. When the sixth locking member is in the first acting position, the sixth locking member is capable of being inserted into the fifth locking groove to fixedly connect the pedal component to the pedal base. When the sixth locking member is in the second acting position, the sixth locking member is capable of separated from the fifth locking groove, and the pedal component is capable of being separated from the pedal base.

In an embodiment, the pedal component includes a pedal body and a second pin shaft. The pedal body is provided with a second insertion groove. The second pin shaft is partially inserted into the second insertion groove. A portion of the second pin shaft located outside the second insertion groove is provided with a fifth locking groove. The third fixing mechanism includes a sixth locking member movably disposed on the pedal base. The sixth locking member is provided with a sixth locking hole. A radial size of the sixth locking hole is greater than a radial size of the second pin shaft. The second pin shaft extends through the sixth locking hole, and a position of the fifth locking groove corresponds to the sixth locking hole. When the sixth locking member is in the first acting position, a part of a hole wall of the sixth locking hole is inserted into the fifth locking groove. When the sixth locking member is in the second acting position, the part of the hole wall of the sixth locking hole is separated from the fifth locking groove.

In an embodiment, the third fixing mechanism further includes a third operating member. The third operating member is connected to the sixth locking member. The third operating member is operated to enable the sixth locking member to be switched between the first acting position and the second acting position.

In an embodiment, the third fixing mechanism further includes an operating reset member. The operating reset member is disposed between the third operating member and the pedal base. The operating reset member biases the sixth locking member to move toward the first acting position.

In an embodiment, the pedal base includes a mounting cavity. The third fixing mechanism and at least a part of the pedal component are located in the mounting cavity.

In an embodiment, the pedal component includes a second pin shaft and a pedal body. The pedal body is provided with a second insertion groove. The second pin shaft is partially inserted into the second insertion groove. The third fixing mechanism includes: a fifth locking groove located at a portion of the second pin shaft located outside the second insertion groove; a third operating member; and a sixth locking member connected to the third operating member and having a first acting position and a second acting position. The third operating member and the sixth locking member are movably disposed in the mounting cavity. A portion of the second pin shaft provided with the fifth locking groove is inserted into the mounting cavity. When the sixth locking member is in the first acting position, the sixth locking member is capable of being inserted into the fifth locking groove to fixedly connect the pedal component to the pedal base. When the locking member is in the second acting position, the sixth locking member is separated from the fifth locking groove, and the pedal component is capable of being separated from the pedal base.

In an embodiment, the sixth locking member is provided with a sixth locking hole. A radial size of the sixth locking hole is greater than a radial size of the second pin shaft. The second pin shaft extends through the sixth locking hole. When the sixth locking member is in the first acting position, a part of a hole wall of the sixth locking hole is inserted into the fifth locking groove. When the sixth locking member is in the second acting position, the part of the hole wall of the sixth locking hole is separated from the fifth locking groove.

In an embodiment, a fourth limiting portion is disposed in the mounting cavity, and a fifth limiting portion is disposed on the third operating member. When the sixth locking member is in the first acting position, the fourth limiting portion abuts against the fifth limiting portion.

In an embodiment, the third operating member is provided with an operating portion, and the pedal base is provided with a third operating hole in communication with the mounting cavity. The operating portion is capable of extending out of an outer surface of the pedal base through the third operating hole to be operated.

In an embodiment, the pedal device further includes an operating reset member. Two ends of the operating reset member abut against the third operating member and a cavity wall of the mounting cavity respectively. The operating reset member biases the sixth locking member to move toward the first acting position.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be subjected to the appended claims.

1. A child carrier, comprising:
a front wheel;
a rear wheel; and
a frame having an unfolded state and a folded state, the frame comprising:
a first frame connected to the front wheel;
a second frame connected to the rear wheel and comprising a first movable connecting portion; and
a linkage mechanism comprising a first connecting frame, a second connecting frame, and a rotating base rotatably connected to the second frame,
wherein the first connecting frame is rotatably connected to the first frame through a first rotating shaft, the first connecting frame comprises a third rotating shaft, the first movable connecting portion is rotatably connected to the third rotating shaft, such that a relative rotation of the first movable connecting portion and the first connecting frame drives the second frame to rotate relative to the rotating base;
wherein the second connecting frame is connected to the rotating base, and is rotatably connected to the first frame through a second rotating shaft;
wherein, when the frame is switched from the unfolded state to the folded state, the linkage mechanism rotates relative to the first frame and the second frame, such that the first frame and the second frame move to approach each other.

2. The child carrier according to claim 1, wherein the first movable connecting portion is provided with a first through hole; a plane where an opening of the first through hole is located forms an angle with respect to the third rotating shaft; the third rotating shaft extends through the first through hole; and the third rotating shaft rotates to drive the first movable connecting portion to move along the third rotating shaft.

3. The child carrier according to claim 2, wherein the first movable connecting portion is provided with a universal ball; the universal ball is provided with a second through hole; the third rotating shaft extends through the second through hole; a hole wall of the first through hole forms a ball base configured to receive at least a part of the universal ball; and the ball base is capable of rotating along a surface of the universal ball.

4. The child carrier according to claim 1, wherein the second frame is rotatably connected to the rotating base through a fourth rotating shaft;
an extending direction of the fourth rotating shaft intersects and is not perpendicular to an extending direction of the third rotating shaft.

5. The child carrier according to claim 4, wherein the second frame comprises a first wedge-shaped end surface; the rotating base comprises a second wedge-shaped end surface; and wherein, when the second frame rotates relative to the rotating base around the fourth rotating shaft, the first wedge-shaped end surface rotates relative to the second wedge-shaped end surface, and is in contact with the second wedge-shaped end surface;
wherein the fourth rotating shaft is perpendicular to the first wedge-shaped end surface and the second wedge-shaped end surface.

6. The child carrier according to claim 1, wherein the linkage mechanism further comprises a linking rod; wherein the linking rod comprises:
a first linking end rotatably connected to the first frame and the second connecting frame through the second rotating shaft; and a second linking end connected to the rotating base.

7. The child carrier according to claim 1, wherein the frame further comprises a first locking component comprising:
a locking pin connected to the first connecting frame; and
a locking hook pivotally connected to the second connecting frame and comprising an engaging hook, wherein the engaging hook is capable of being engaged with the locking pin to limit a relative rotation of the first frame and the second frame.

8. (canceled)

9. The child carrier according to claim 7, wherein the first locking component further comprises a first reset member; and the first reset member biases the locking hook to rotate to be engaged with the locking pin.

10. The child carrier according to claim 7, wherein the frame further comprises an unlocking component configured to drive the locking hook to rotate to be disengaged from the locking pin;
wherein the unlocking component comprises a first pushing rod movably disposed on the first connecting frame; and the first pushing rod is operable to push the locking hook to rotate, so as to disengage the locking hook from the locking pin.

11. The child carrier according to claim 10, wherein the unlocking component further comprises a driving handle rotatably connected to the first connecting frame and abutting against the first pushing rod; wherein the driving handle comprises a cam portion; and the driving handle rotates to drive the first pushing rod to move through the cam portion.

12. The child carrier according to claim 10, wherein the first pushing rod includes a pushing rod body and a pushing portion fixed on the pushing rod body; the unlocking component further comprises a second reset member disposed between the first connecting frame and the first pushing rod; and the second reset member biases the pushing portion to move in a direction away from the locking hook.

13. The child carrier according to claim 1, further comprising a handlebar assembly comprising a handlebar and a locking mechanism; wherein the locking mechanism has a locked state and an unlocked state, wherein, when the locking mechanism is in the locked state, the handlebar is limited in a predetermined position; wherein, when the locking mechanism is in the unlocked state, the handlebar is non-limited in the predetermined position; and wherein, when the frame is folded, the locking mechanism is capable of being driven to be switched from the locked state to the unlocked state.

14. The child carrier according to claim 13, further comprising a first pulling member; wherein the handlebar assembly is connected to the first frame; one end of the first pulling member is connected to the locking mechanism, another end of the first pulling member is connected to the linkage mechanism, and wherein, when the frame is switched from the unfolded state to the folded state, the linkage mechanism is capable of driving the locking mechanism to switch from the locked state to the unlocked state.

15. The child carrier according to claim 1, further comprising a seat assembly fixed to the linkage mechanism and a backrest assembly;
wherein the frame further comprises a connecting base; the backrest assembly is rotatably connected to the connecting base; and the seat assembly is removably connected to the connecting base.

16. The child carrier according to claim 1, further comprising a backrest assembly removably connected to the linkage mechanism, wherein, when the frame is switched from the unfolded state to the folded state, the linkage mechanism drives the backrest assembly to be folded.

17. The child carrier according to claim 1, further comprising a pushing assembly and a first fixing mechanism, wherein the pushing assembly is removably connected to the linkage mechanism through the first fixing mechanism.

18. The child carrier according to claim 17, wherein the first fixing mechanism comprises a first locking member movably connected to the pushing assembly; the first locking member has a first locked position and a first unlocked position; wherein, when the first locking member is in the first locked position, the first locking member is engaged with the frame; and wherein, when the first locking member is in the first unlocked position, the first locking member is disengaged from the frame, and the first locking member is operable to drive the first locking member to be switched between the first locked position and the first unlocked position.

19-22. (canceled)

23. The child carrier according to claim 18, wherein the first fixing mechanism further comprises a third reset member disposed between the pushing assembly and the first locking member; and the third reset member biases first locking member to move toward the first locked position.

24-25. (canceled)

26. The child carrier according to claim 17, wherein the pushing assembly comprises a first connecting rod connected to the frame, a second connecting rod removably connected to the first connecting rod, and a length adjustment mechanism;
wherein the length adjustment mechanism has a locked state and an unlocked state; wherein, when the length adjustment mechanism is in the unlocked state, the second connecting rod is capable of moving in an extending direction of the first connecting rod to extend or contract the pushing assembly; and wherein, when the length adjustment mechanism is in the locked state, the second connecting rod and the first connecting rod are fixed relative to each other.

27. The child carrier according to claim 26, wherein the length adjustment mechanism comprises a second locking member having a second locked position and a second unlocked position; wherein the second locking member is operable to be switched between the second locked position and the second unlocked position; the first connecting rod is provided with at least two second locking holes; the second locking member is movably disposed on the second connecting rod; wherein, when the second locking member is in the second locked position, the second locking member is capable of being engaged in any one of the second locking holes; and wherein, when the second locking portion is in the second unlocked position, the second locking member is disengaged from the second locking hole.

28-98. (canceled)
